(19) United States
(12) Patent Application Publication
(10) Pub. No.: US 2011/0111700 A1
(43) Pub. Date: May 12, 2011

(54) WIRELESS CONTROL SYSTEM USING VARIABLE POWER DUAL MODULATION TRANSCEIVERS

(76) Inventor: Jamie Hackett, Ottawa (CA)

(21) Appl. No.: 12/990,488

(22) PCT Filed: Apr. 29, 2009
(86) PCT No.: PCT/CA2009/000543

§ 371 Date: Jan. 13, 2011

Related U.S. Application Data
(60) Provisional application No. 61/048,834, filed on Apr. 29, 2008.

(51) Int. Cl. H04B 5/02

(52) U.S. Cl. 455/41.2

(57) ABSTRACT

A wireless control system that operates in Industrial, Scientific and Medical (ISM) frequency bands that employs one or more variable power dual modulation radio frequency transceiver-controllers that are capable of receiving and/or transmitting signals and communicating with each other over a configurable range, from short to long range. The wireless control system is suitable for use in a wide range of medical, industrial, agricultural, military and commercial applications, including, for example, the management of irrigation systems, manufacturing processes, security systems, sewage treatment and handling systems, hospital management systems, tracking systems, ground telemetry systems, environmental monitoring systems for agriculture, viticulture, pipelines and dams, HVAC management systems, water, gas and electrical metering, parking meters, asset and equipment tracking, traffic control, fire protection, public space management, intruder detection and biological research.

### FIELD OF THE INVENTION

The invention relates generally to wireless control systems and, more particularly, to wireless control systems utilising variable power dual modulation radio frequency transceivers.

### BACKGROUND OF THE INVENTION

Modern wireless communications technology uses radio frequencies (RF) to transmit information. A variety of frequencies are available for such transmission, depending on the complexity of the information being transmitted, such as text versus multi-channel video. A variety of standards, including for example Bluetooth™ and WiFi, have been developed for mid- to high-range data rates for voice, PC LANs, video and the like. In contrast, the only standard currently in place for remote control and sensor applications is Zigbee™. Sensor and control networks do not require high bandwidth, but do require low latency and low power consumption. ZigBee™ provides for a general-purpose, inexpensive self-organising mesh network that is designed to use small amounts of power.

Regulation of the radio spectrum for information requires users wishing to broadcast in the higher bandwidth frequencies to pay licensing fees. These license costs add to the creation, scalability and maintenance costs of any system using wireless communication methods. To address this, wireless devices have been developed to use frequency bands that do not require licenses, such as the unlicensed Industrial, Scientific and Medical (ISM) frequency bands. These frequency bands are, however, very narrow, which limits the duration channel transmission time and maximum power output levels for both low power (e.g. Frequency Shift Keying—FSK) and high power (e.g. Frequency Hopping Spread Spectrum/Direct Sequence Spread Spectrum—FHSS/DSSS) communications, as well as the amount of information that can be transmitted quickly within the regulation of the Federal Communications Commission (FCC) in the United States and Industry Canada in Canada, for example.

One proposed wireless communication standard is ZigBee™, which uses the IEEE 802.15.4 Low-Rate Wireless Personal Area Network (WPAN) standard to describe its lower protocol layers (the physical layer PHY, and the medium access control MAC portion of the data link layer or DLL). This standard specifies operation in the unlicensed 2.4 GHz, 915 MHz and 868 MHz ISM bands. Zigbee™ products use conventional Direct Sequence Spread Spectrum (DSSS) in the 868 and 915 MHz bands, and an orthogonal signalling scheme that transmits four bits per symbol in the 2.4 GHz band. Although each node in a network employing Zigbee™ standard products can act as a repeater to transmit data multihop fashion to distant nodes, the transmission range of each node in a Zigbee™ based network is typically between 10 and 75 metres (approximately 33 to 250 feet). Although it may be possible to extend the transmission range of a Zigbee™ device up to 500 m in a favourable environment, the average transmission range is about 50 m, this limiting the inter-node distance in the network to about 50 m.

A wide variety of industrial, medical, agricultural, consumer and military applications can benefit from some form of sensor or control network, specifically if wireless, such as security systems, monitoring digital precision instruments on the factory floor, monitoring shipments through a supply chain, monitoring and reporting seismic activity, medical implants, irrigation management, and the like.

U.S. Patent Publication No. 2005/0195775 describes a system for monitoring and controlling remote devices. The system includes a first- and a second remote device; and a first and a second wireless transceiver integrated with the respective remote devices. The wireless transceivers are configured to communicate with at least one of a spread-spectrum communication protocol and a fixed-frequency communication protocol.

For example, a number of control systems have been developed for automatic irrigation systems with landscaping and agricultural applications. Automatic irrigation systems generally comprise a network of under and/or above-ground pipes and pumps that convey water to desired locations, and water valves and pumps that are used to control the flow of water through a variety of water dispensing devices, including valves, rotors and sprinklers. Rotors are typically enclosed in a protective housing, and may include a rotating nozzle that emerges from the top of the housing during operation and irrigates by throwing a jet or spray of water that is rotated about a generally vertical axis. The rotor may be retracted when not in use such that the top cover of the rotor may be flush with the surrounding ground. A rotor is typically actuated by an electric solenoid-controlled valve that in turn is controlled by a controller and a pump that control the flow of water to the sprinkler or group of sprinklers. Control wires for connecting the valve actuators and the controller are typically buried below ground, often in the same trenches used to run water supply pipes to the valves. Control systems can vary from simple multi-station timers to complex computer-based controllers.

Wired systems, however, are expensive to install and maintain, are not easily scalable and are extremely vulnerable to lightning strikes or damage to the control wires. Damage to buried control wires can be difficult to trace and repair, increasing the cost of such systems. As a result, attempts have been made to develop wireless and quasi-wireless system using two-way paging, cellular and GPS technologies as well as primary wireless radio frequency communication platforms. Such communication systems are, however, power intensive, and the signals can be disrupted by obstacles such as buildings, metal structures, hills, cloud cover or even dense foliage. Most of these systems employ one-way communications to change or modify a pre-programmed irrigation schedule stored in the control mechanism. Pre-programmed irrigation schedules, however, are unable to adapt to environmental changes such as precipitation or microclimates, which can result in water being wasted in irrigating at times when irrigation is not required.

A number of wireless or quasi-wireless controls for irrigation systems are known. U.S. Pat. No. 6,782,310, for example, describes a network of irrigation control devices in wireless communication with a main controller. The main controller uses commercial paging or public broadcast network signals to update watering schedules stored in the memory of the irrigation control devices.

U.S. Patent Application Publication No. 2004/0181315 describes an automated landscape irrigation control system which uses communication techniques such as wireless telephone transmissions to collect environmental information and derive irrigation schedules which are then sent to irrigation control units. The irrigation control units in turn control a plurality of irrigation stations such as valves or sprinklers.

U.S. Pat. No. 6,600,971 describes a system for operating a distributed control network for irrigation management. The system incorporates a peer-to-peer network of satellite irrigation controllers which can be in communication with a central computer. The network is connected by a communication bus which includes a radio modem but can be controlled through wireless transmissions. Each irrigation controller controls solenoid operated sprinkler valves and optionally sensors. The system is a quasi-wireless system in which the satellite irrigation controllers have wireless capability to be controlled from a central computer or hand held device, but the satellite irrigation controllers need to be hard-wired to the solenoid operated sprinkler valves by field wiring. Thus, although control wiring from the central computer to the satellite station could be eliminated, the system would still require the laying of control wire underground from the satellite irrigation controllers to the solenoid operated sprinkler valves.

U.S. Patent Application Publication Nos. 2005/0090936, 2004/0100394, 2004/0090345, 2004/0090329 and 2004/0083833 all describe a method for wireless environmental monitoring and control utilising a distributed wireless network of independent sensor and actuator nodes that communicate with each other to transmit sensor data or a command to control the sensor or actuator. The system is designed to be self-operating without the need for a central controller and the nodes in the system are able to perform certain tasks independently. The system supports multi-hop wireless sensor irrigation control for a plurality of irrigation zones, each comprising a plurality of sensor nodes, actuator nodes and repeater nodes. The system is complex and control requires large numbers of independent sensor and actuator nodes, which in combination with the multi-hop transmission of information signals, results in a large amount of RF traffic within the system. The amount of traffic is further increased when independent repeater nodes are used.

The above patent applications also describe a wireless control system that can be used as an add-on to a pre-existing hard-wired irrigation system. The sensor system provides a moisture control override mechanism to an existing wired irrigation system that schedule irrigation cycles and times. The system of wireless moisture sensor nodes communicate moisture levels to an actuator node that is attached to the common power line of a two-wire power supply system and provides the ability to control and/or override the predetermined irrigation schedule that is controlled by hard-wire from the main terminal.

U.S. Pat. No. 5,813,606 describes a plurality of moisture sensors in wireless communication with a control unit that activates an irrigation system in response to signals from the moisture sensors.

U.S. Pat. No. 5,760,706 describes an RF control system characterized by the use of remotely located low profile radio frequency antennas which are concealed in conventionally appearing valve boxes or similar housings. The system includes a central control station, including a central RF transmitter, and a plurality of remote stations, each including an RF receiver and antenna. A preferred remote station includes a valve box or similar housing of the type intended to be at least partially buried in the earth. The housing has a peripheral wall defining an access opening and a removable cover for bridging the opening. A directional discontinuity ring radiator (DDRR) antenna is physically mounted in the valve box housing on the interior side of the cover and is connected to a receiver, preferably also physically mounted on the cover.

This background information is provided to reveal information believed by the applicant to be of possible relevance to the invention. No admission is necessarily intended, nor should be construed, that any of the preceding information constitutes prior art against the invention.

### SUMMARY OF THE INVENTION

An object of the invention is to provide a wireless control system using variable power dual modulation transceivers. In accordance with one aspect of the invention, there is provided a wireless control system configured for operative association with a first controller for generating and processing information for controlling one or more devices, said wireless control system comprising: a first transceiver operatively associated with the first controller and configured for operation in two or more modulation modes, each modulation mode for generating and receiving radio frequency (RF) signals configured in a predetermined format for wireless transfer of the information; and one or more second transceivers operatively associated with the first transceiver and configured for operation in the two or more modulation modes, each of the second transceivers operatively associated with one or more of the devices thereby enabling provision of the information for control of the one or more devices.

In accordance with another aspect of the invention, there is provided a wireless irrigation control system configured for operative association with a first controller for generating and processing information for activating and deactivating one or more irrigation devices, said wireless irrigation control system comprising: a first transceiver operatively associated with the first controller and configured for operation in two or more modulation modes, each modulation mode for generating and receiving radio frequency (RF) signals configured in a predetermined format for wireless transfer of the information; and one or more second transceivers operatively associated with the first transceiver and configured for operation in the two or more modulation modes, each of the second transceivers operatively associated with one or more of the irrigation devices thereby enabling provision of the information for activating and deactivating the one or more irrigation devices.

In accordance with another aspect of the invention, there is provided a wireless communication apparatus for forwarding information for control of a device to and from a wireless control system, said wireless communication apparatus comprising: a transceiver configured for operation in two or more modulation modes each modulation mode for generating and receiving radio frequency (RF) signals configured in a predetermined format for wireless transfer of information; and one or more antennas operatively coupled with the transceiver for emitting and receiving the RF signals.

### BRIEF DESCRIPTION OF FIGURES

These and other features of the invention will become more apparent in the following detailed description in which reference is made to the appended drawings.

FIG. 1 illustrates a topology of a wireless VPDMT control system according to an embodiment of the present invention.

FIG. 2 illustrates a block diagram of a VPDMT-controller module according to an embodiment of the present invention.

FIG. 3 illustrates schematic and block diagrams of single and dual VPDMT main controller modules for use with a central controller according to an embodiment of the present invention.

FIG. 4 illustrates schematic and electronic block diagrams of a VPDMT module for interconnection with a handheld node and a VPDMT module for installation in a handheld node according to an embodiment of the present invention.

FIG. 5 illustrates a schematic representation of the individual and overlapping communication ranges of individual VPDMT-controller modules in a wireless control system with and without smart repeaters according to an embodiment of the present invention.

FIG. 6 illustrates a view of a VPDMT rotor controller module attached to a rotor in a wireless control system according to an embodiment of the invention.

FIG. 7 schematically illustrates a VPDMT rotor controller module attached to a rotor in a wireless control system according to one embodiment of the invention.

FIG. 8 schematically illustrates a VPDMT valve controller module attached as a retrofit to a valve box lid in a wireless control system according to one embodiment of the invention.

FIG. 9 illustrates a schematic plan of a wireless control system for an irrigation application according to one embodiment of the present invention.

FIG. 10A illustrates a network communication diagram for a wireless control system in accordance with an embodiment of the present invention.

FIG. 10B illustrates a flow chart for a network communication for a wireless control system as illustrated in FIG. 10A.

FIG. 11 illustrates a schematic representation of transmission of a signal within a VPDMT in a wireless control system with a hand held or main controller in accordance with an embodiment of the present invention in which the system has a star network topology and master/slave communication.

FIG. 12 illustrates a flow chart illustrating transmission of messages within a VPDMT wireless control system in accordance with an embodiment of the present invention in which the system has a star network topology and master/slave communication.

FIG. 13 illustrates an architecture wireless control system according to an embodiment of the present invention.

FIG. 14 illustrates a plan of a wireless control system in accordance with an embodiment of the present invention.

FIG. 15 illustrates a schematic representation of a central controller in accordance with an embodiment of the present invention.

FIG. 16 illustrates a block diagram of a VPDMT in accordance with an embodiment of the present invention.

FIG. 17 illustrates a connection diagram of an example VPDMT when used as a sprinkler VPDMT in accordance with an embodiment of the present invention.

FIG. 18 illustrates a top view of a part of a sprinkler head to which may be attached a ring antenna assembly in accordance with an embodiment of the present invention.

FIG. 19A illustrates a top plan view of a sprinkler ring and antenna assembly for attachment to the sprinkler head of FIG. 18.

FIG. 19B illustrates a cross sectional view of the assembly of FIG. 19A.

FIG. 19C illustrates a partial bottom plan view of the assembly of FIG. 19A.

FIG. 19D illustrates a cross sectional view of the assembly of FIG. 19A mounted in accordance with an embodiment of the present invention.

FIG. 20 illustrates a connection diagram for a VPDMT when used as a valve VPDMT in accordance with an embodiment of the present invention.

FIGS. 21A and 21B illustrates a swastika antenna in accordance with an embodiment of the present invention.

FIG. 22 illustrates a schematic interconnection diagram of a VPDMT for use as a controller VPDMT in accordance with an embodiment of the present invention.

FIG. 23 illustrates a bow-tie antenna for use with a wireless control system node in accordance with an embodiment of the present invention.

FIGS. 24A and 24B illustrate top and cross-sectional views of a sprinkler in accordance with an embodiment of the present invention.

FIGS. 25A and 25B illustrate top and cross-sectional views of a sprinkler with ring antenna insert assembly in accordance with an embodiment of the present invention.

FIGS. 26A and 26B illustrate top and cross-sectional views of a sprinkler with ring antenna embedded in an embossed/routed/channelled surface thereof in accordance with an embodiment of the present invention.

FIGS. 27A and 27B illustrate top and cross-sectional views of a sprinkler with ring antenna moulded therein in accordance with an embodiment of the present invention.

FIGS. 28A and 28B illustrate top and cross-sectional views of a sprinkler with ring antenna moulded in a side mounting assembly thereof in accordance with an embodiment of the present invention.

FIGS. 29A and 29B illustrate top and cross-sectional views of a square valve box lid in accordance with an embodiment of the present invention.

FIGS. 29C and 29D illustrate top and cross-sectional views of a circular valve box lid in accordance with an embodiment of the present invention.

FIGS. 30A and 30B illustrate top and cross-sectional views of a square valve box lid with an antenna fastened into an outer antenna assembly thereof in accordance with an embodiment of the present invention.

FIGS. 30C and 30D illustrate top and cross-sectional views of a circular valve box lid with an antenna fastened into an outer antenna assembly thereof in accordance with an embodiment of the present invention.

FIGS. 31A and 31B illustrate top and cross-sectional views of a square valve box lid with an antenna fastened or moulded into an inner antenna assembly thereof in accordance with an embodiment of the present invention.

FIGS. 31C and 31D illustrate top and cross-sectional views of a circular valve box lid with an antenna fastened or moulded into an inner antenna assembly thereof in accordance with an embodiment of the present invention.

FIGS. 32A and 32B illustrate top and cross-sectional views of a square valve box lid with an antenna that may be either moulded into the lid or fastened into an embossed, routed or channelled assembly in accordance with embodiments of the present invention.

FIGS. 33A and 33B illustrate top and cross-sectional views of a circular valve box lid with an antenna that may be either moulded into the lid or fastened into an embossed, routed or channelled assembly in accordance with embodiments of the present invention.

FIG. 34 illustrates range diagrams for single mode communication in a wireless control system using full wave antennas according to an embodiment of the present invention and commercially available ¼ and ½ antennas.

FIG. 35 illustrates a range diagram for dual mode communication in a wireless control system according to an embodiment of the present invention and the range diagram for single mode communication in a wireless control system using full wave antennas according to an embodiment of the present invention of FIG. 34.

FIG. 36 illustrates a block diagram and schematics of an impedance matching circuit for an antenna according to an embodiment of the present invention.

FIG. 37 illustrates a top plan view and a side cross section of a rotor for an irrigation system with an embedded antenna according to an embodiment of the present invention.

FIG. 38 illustrates a pair of asymmetrically top-loaded crossed-dipole antennas disposed on the top side of a device cover according to an embodiment of the present invention.

FIG. 39 illustrates a pair of asymmetrically top-loaded crossed-dipole antennas disposed on the bottom side of a device cover according to an embodiment of the present invention.

FIG. 40 illustrates a pair of bow-tie antennas on a printed circuit board according to an embodiment of the present invention.

FIG. 41 illustrates a top view of an assembly of a ring antenna with housing attached to an irrigation device according to an embodiment of the present invention.

FIG. 42 illustrates a side view of the assembly of FIG. 41.

FIG. 43 illustrates an example loop antenna with a balun for use in a wireless control system according to an embodiment of the present invention.

FIG. 44 illustrates a dome antenna for use in a wireless control system according to an embodiment of the present invention.

### DETAILED DESCRIPTION OF THE INVENTION

A wireless control system according to embodiments of the present invention may comprise a plurality of nodes configured for exchanging information with other nodes. The information may include predetermined commands and data used to indicate operational conditions of components or infer parameters of the environment of the system. One or more of the nodes may use a variable power dual modulation (VPDM) radio frequency transmission scheme for wireless communication with other nodes. Depending on the embodiment, the wireless nodes may be configured to communicate selectively with other wireless nodes using one of two or more predetermined signal modulation modes. Pairs of wireless nodes may adaptively select a modulation mode depending on a number of criteria as described below. According to some embodiments of the present invention, a node may be configured to switch between a number of predetermined power consumption modes. According to one embodiment of the present invention, the wireless system may be configured for operation using license free Industrial, Scientific and Medical (ISM) frequency bands.

In one embodiment, one or more of the nodes comprise a variable power dual modulation radio frequency transceiver-controller (VPDMT) module for wireless communication with other nodes.

In one embodiment, at least some of said VPDMT modules are configured to transmit RF signals a distance of at least 500 m without line of sight and up to 5 km with line of sight in low power modulation.

In one embodiment, at least some of said VPDMT modules are configured to transmit RF signals a distance of at least 500 m without line of sight and up to 20 km with line of sight in high power modulation.

In one embodiment, the wireless control system further comprises one or more smart repeaters or gateways acting as self-operated controllers for storing, controlling, scheduling or relaying one or more commands between VPDMT modules, for example from a central controller or sensor within said network of VPDMT modules. For example, smart repeaters or gateways can enable information to be passed in a multi-hop manner in a peer-to-peer network.

In accordance with embodiments of the invention, VPDMT modules are provided having one or more bow-tie, loop, miniaturized helical dome or modified crossed dipole antennas. In one embodiment, one or more antennas associated with the VPDMT modules are situated in a horizontal plane to provide a desired low-profile form factor. In one embodiment, an antenna system can include a full wave directional, dual array antenna or bow-tie antenna. In one embodiment, an antenna can comprise a phased array of antennas configurable to produce a desired radiation pattern by superposition of phase-shifted signals.

In accordance with one embodiment of the invention, one or more of the VPDMT modules are each operatively associated with one or more actuators and/or one or more sensors. In one embodiment, an antenna can be moulded into, mechanically fastened or embedded into a portion of a device controlled by the VPDMT module, for example, a rotor or sprinkler or valve box and lid.

In one embodiment, the system comprises one or more independent controllers, smart repeaters or gateways or field controllers and at least some of the VPDMT modules are adapted for direct or indirect wireless communication with the one or more independent controllers, smart repeaters or field controllers to receive commands therefrom.

In accordance with one aspect, the invention provides for a VPDMT module comprising one or more frequency tuned, impedance matched and phased antennas having either a horizontal or vertical polarization, the VPDMT configured for operation using license free Industrial, Scientific and Medical (ISM) frequency bands.

In accordance with another aspect of the invention, there is provided a connected network of VPDMT modules, each VPDMT module configured to associate with at least one other VPDMT module. Each VPDMT module can be configured as or coupled to one or more devices such as a controller, smart repeater, gateway, sensor or actuator. The communication links between VPDMT modules can be configurable with respect to at least one of transmission power, modulation, and radiation pattern, so as to establish an energy-efficient or long-lifetime network of sufficient capability for a desired collection of operations, such as irrigation system management.

### DEFINITIONS

As used herein, the term “about” refers to approximately a +/−10% variation from a given value. It is to be understood that such a variation is always included in any given value provided herein, whether or not it is specifically identified.

The term “plurality” as used herein refers to two or more, for example, 2, 3, 4, 5, 6, 7, 8, 9, 11, 12, 13, 14, 15, 16 or greater.

### Wireless Control System

### System Architecture

Depending on the embodiment, the wireless control system may be configured as a connected mesh network, star network, hierarchical network or other network. Accordingly, nodes may be configured to support formation of one or more types of networks on an ad hoc basis during operation or in a preconfigured way, depending on the embodiment. The selection of the network type, configuration of nodes and communication links may be predetermined depending on a number of parameters, as further described herein, including energy-efficiency, bandwidth, connectivity, form of power supply of the nodes and other network parameters, for example. A wireless control system may include a number of types of nodes including nodes for controlling other nodes, nodes for relaying signals, and device control nodes for controlling other devices, for example. Nodes may be preconfigured to be able to provide one specific function or to selectively provide one of a number of functions during operation. A wireless control system according to an embodiment may be configured to provide control of one or more aspects of a node or other devices associated with nodes in real time.

Depending on the embodiment, a node may comprise one of one or more wired or wireless network interfaces including a VPDMT module that embodies the above referenced VPDMT scheme for wireless communication, for example. A wireless node may comprise one or more sensors for sensing internal or external node parameters. A node may be operatively associated such as via actuating means, for example, with one or more devices for control of at least one function of the one or more devices. A node may further be configured for relaying information such as sensor signals, for example, provided by the one or more devices. A node and its one or more associated devices may be formed as one unit, or form separate units interconnected using an adequate interconnection system. Integrating VPDMT modules and associated sensors and devices may help keep the number of nodes within the system low and reduce the amount of RF traffic required for control and monitoring.

A wireless control system according to an embodiment of the present invention may be configured to be operated within a distributed, self-organizing network and/or long-range wireless control system. Depending on the embodiment, it may include one or more nodes for control of the system. For example, the wireless control system may be configured for use with a central controller or for distributed control using a number of smart nodes, or it may be configured for a combination of central and distributed control.

According to an embodiment of the present invention, smart nodes may be configured to provide a predetermined set of control functions for control of the system, for example via a user interface. Smart nodes may include central controllers, repeater nodes, terminal nodes or mobile nodes, for example. Employing smart nodes with enhanced system control capabilities may enable better distributed system control and reduce the importance of a central controller.

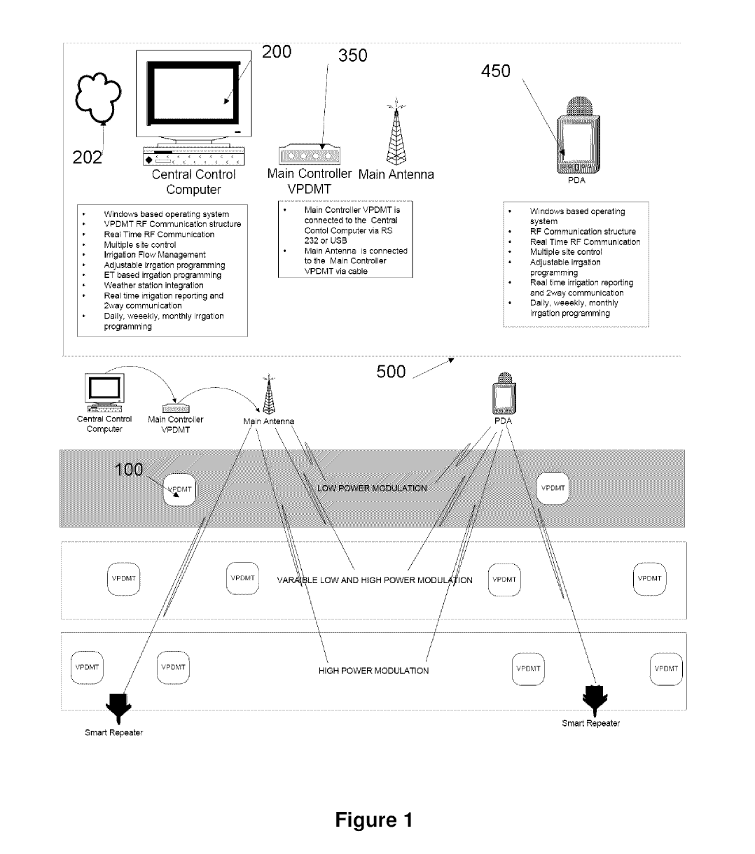

FIG. 1 schematically illustrates an example of a wireless control system 500 according to an embodiment of the invention. All nodes of the system use a VPDMT module. The VPDMT modules 100 within the system 500 communicate with at least one other VPDMT module, one or more repeaters, one or more independent or field controllers, and/or one or more central computing devices 200 that control the activities of the VPDMT modules and provide a user interface for system control.

The individual VPDMT modules 100 of the system 500 may be disposed so that each is in communication range of at least another, for example, within a range permitted by their particular configuration, components and operating as indicated on the bottom of FIG. 1 and FIGS. 34-35, for example. One skilled in the art would readily understand that the maximum distance to which VPDMT modules may be spaced to achieve a functional system also depends on the terrain surrounding each VPDMT. It is noted that distances between different pairs of VPDMT modules need not be uniform. For example, buildings or building elements, terrain features such as hills, buildings, dips, power lines, and the like, can increase or decrease radio transmission and reception ranges of individual VPDMTs, due to factors such as availability of line-of-sight communication paths and electromagnetic interference or presence of regions where interference from VPDMTs is restricted. The system can thus comprise VPDMT modules that are within a shorter distance of each other due to line of sight restrictions, as well as VPDMT modules that are spaced up to several kilometres apart due to the availability of unrestricted line of sight transmission. Distance can similarly be decreased in areas which are relatively inaccessible, for example to prolong battery life in such areas.

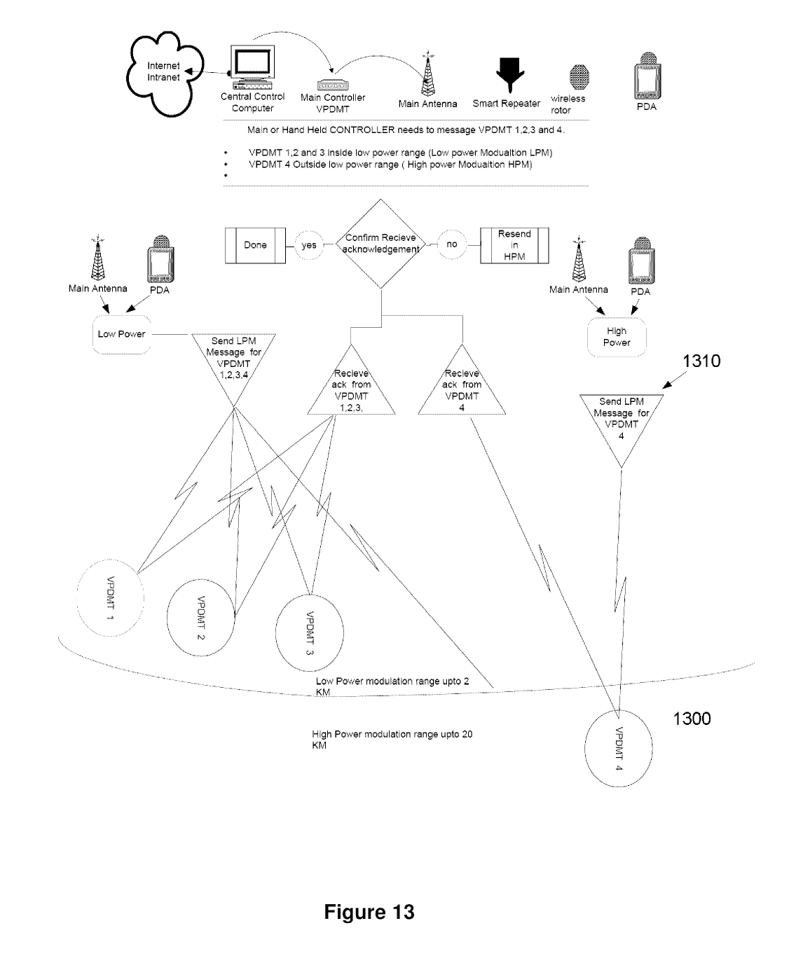

In one embodiment, as shown in FIG. 13, a wireless control system 1300 includes repeater nodes 1310 to provide additional transmission coverage. A repeater node 1310 can be used, for example, where one or more VPDMT modules 100 are located outside the transmission range of the central controller, or other VPDMT modules that need to communicate. A repeater node may be less complex than other nodes as it needs to relay signals only. As such, a repeater node may be used, for example, in a location within the control system where there are no control devices and therefore no requirement for a controller to be at that location. Thus, when a VPDMT module associated with a control device is outside the transmission range of the central controller or another VPDMT module, a repeater node can be used to bridge the transmission gap.

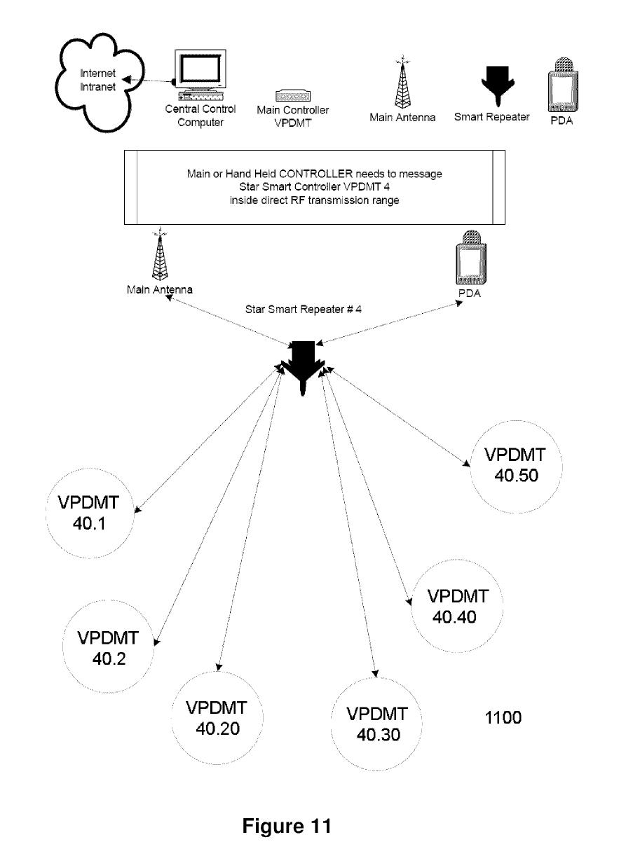

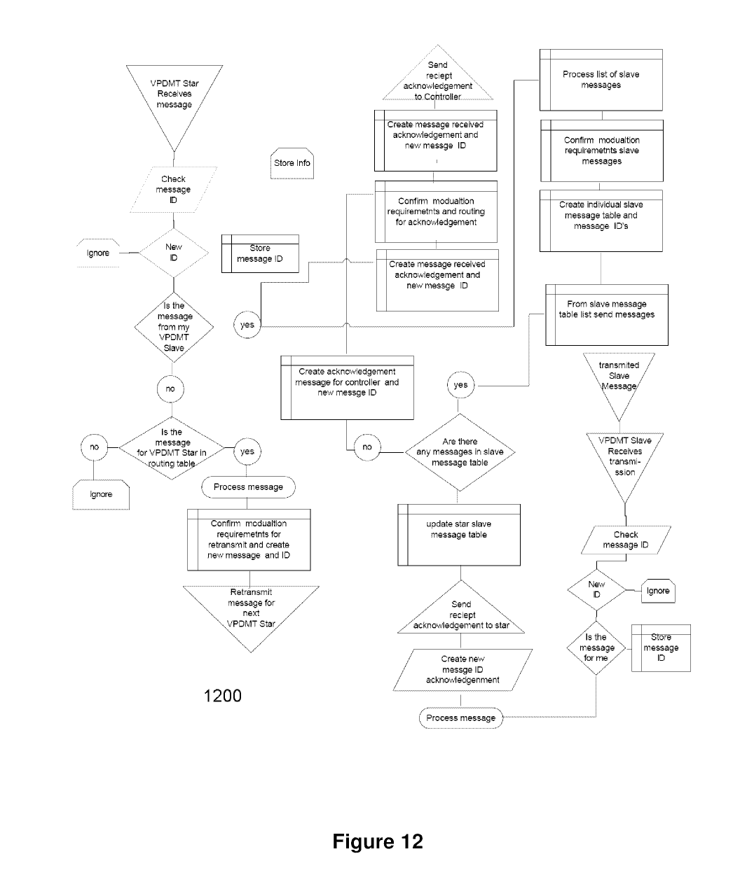

The control system of the invention is configured to have a network topology consistent with ad hoc peer-to-peer style transmission of signals within the system. In one embodiment, the network topology comprises a star topology. In general, a star network comprises a master/slave hierarchy as illustrated in FIGS. 11 and 12, for example, and may be designed, for example, for systems in excess of 2000 VPDMT modules. The person of ordinary skill in the art will understand that other network configurations and protocols may be considered herein without departure from the general scope and nature of the present disclosure.

### Central Controller

A central controller may be, for example, a personal computer, dedicated server, PDA, laptop or other sufficiently powerful electronic information processing device. The central controller may be part of a multi-layered communication network such as a communications node to communicate, for example, with several data termini in a connected wired network, as well as with the wireless network. As such, a central controller can serve as a wired and/or wireless access point, a wireless access server, or another type of wireless device providing access to the wireless network. A central controller may optionally provide functions of devices such as printers, stationary scanners, and the like. In one embodiment, the central controller may be connected to an intranet or the Internet. In another embodiment, the central controller may be configured to interface with, for example, a handheld device, a smart phone, personal digital assistant, Tablet PC, notebook or the like to allow a central controller to be controlled remotely from a mobile unit. In another embodiment, a central controller or a function thereof may be provided by, for example, a handheld device, smart phone, personal digital assistant, Tablet PC, notebook or the like.

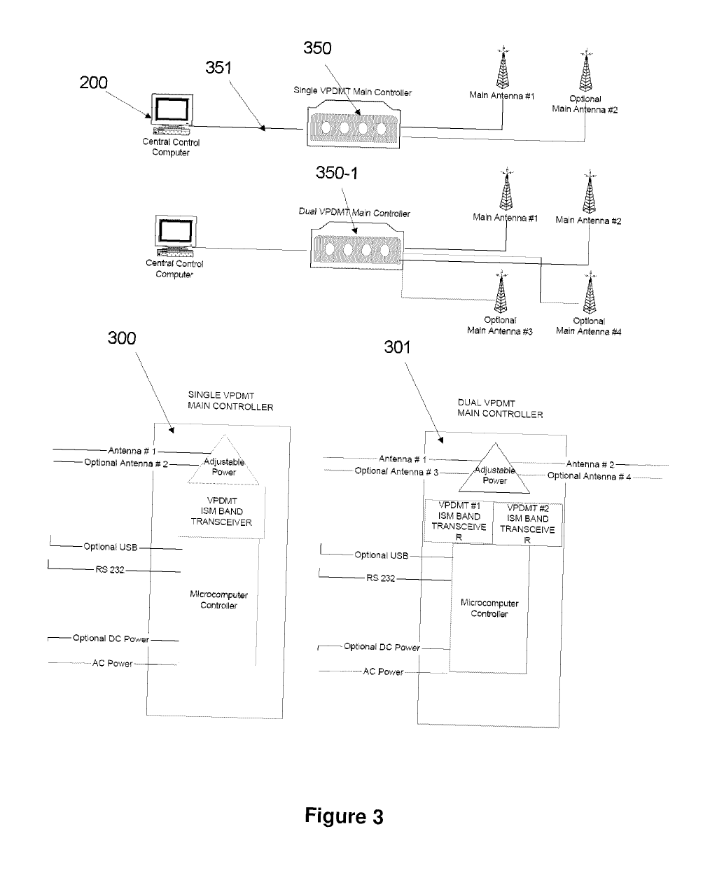

As schematically illustrated in FIGS. 1 and 3, a central controller 200 may be operatively connected with the wireless control system via a main controller 350 or other module capable of receiving and transmitting RF signals in the appropriate range. According to an embodiment of the present invention the operative connection may be wired or wireless. A wired connection may use a number of interconnect systems such as USB or RS232, for example.

### Handheld Node

The wireless control system can optionally further comprise one or more handheld nodes, such as hand-held devices, as described in more detail below. For example, the system can comprise a mobile controller that also interfaces with the network through an integrated VPDMT module and provides a means of controlling the system remotely. A mobile controller, such as a handheld computer or personal digital assistant, can include software configured to control or obtain information from the network, and can use an internal wireless radio system or wireless adapter for communication therewith. A user interface can also be provided for interaction with the network.

A handheld node may be used to control various aspects of the wireless control system independently or in combination with a central controller. A handheld node may comprise a VPDMT module 100, or a less complex module capable of receiving and transmitting RF signals in the appropriate range, and can be equipped with a user interface suitably configured with software to accept operator input including, for example, one or more of pushbutton controls, switches, an alphanumeric keypad, LED indicators, and a display screen. Handheld nodes can be, for example, a portable wireless device, such as a laptop, mobile phone, PDA, or Blackberry, comprising a RF transceiver or VPDMT module 100 configured to communicate with other modules in the system. In addition to various hand-held devices, the invention also contemplates that the handheld node could be installed in vehicles, worn by a user/operator, or generally installed in a manner that causes the device to be mobile. In one embodiment, the handheld node is a hand-held device, as depicted generally at 450 in FIG. 1. In another embodiment the mobile device functions as an auxiliary hand-held controller or independent main controller.

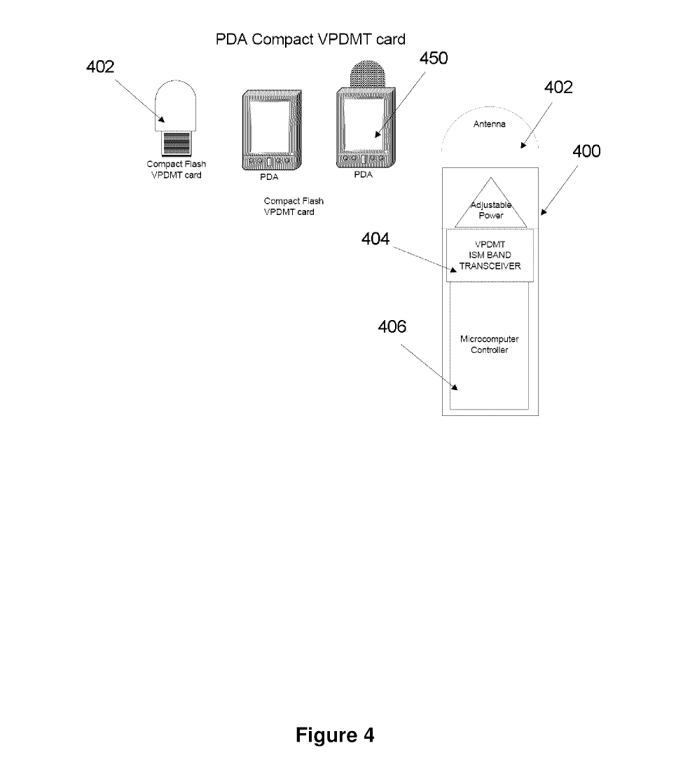

An example of a handheld node 450 is illustrated in FIG. 4. The hand-held node comprises a VPDMT module 400, which in turn comprises an antenna section 402, a RF transceiver 404 configured to transmit and receive RF signals in the ISM frequency band and a controller 406.

Handheld nodes can be configured for a variety of applications within the control system, for example, for manual control of the operation of individual VPDMT modules, manual control over or override of commands initiated by the central controller 200, real time mobile monitoring of the control system, and providing telemetry information for navigation. In order to accomplish these tasks, handheld nodes can transmit to and receive data from the central controller 200 or from individual VPDMT modules 100 as required. Handheld nodes can also be configured to exchange signals with other nearby VPDMT modules and use the information to triangulate the physical location of the handheld node relative to the rest of the system, for example by measuring RF signal strength between the handheld node and the surrounding VPDMT modules.

### Device Control Node

The wireless control system can comprise one or more device control nodes comprising a VPDMT module operatively associated with a device to be controlled. In accordance with this embodiment, the VPDMT module is operatively associated with one or more actuators and/or one or more sensors for transmitting control signals to and/or receiving information therefrom.

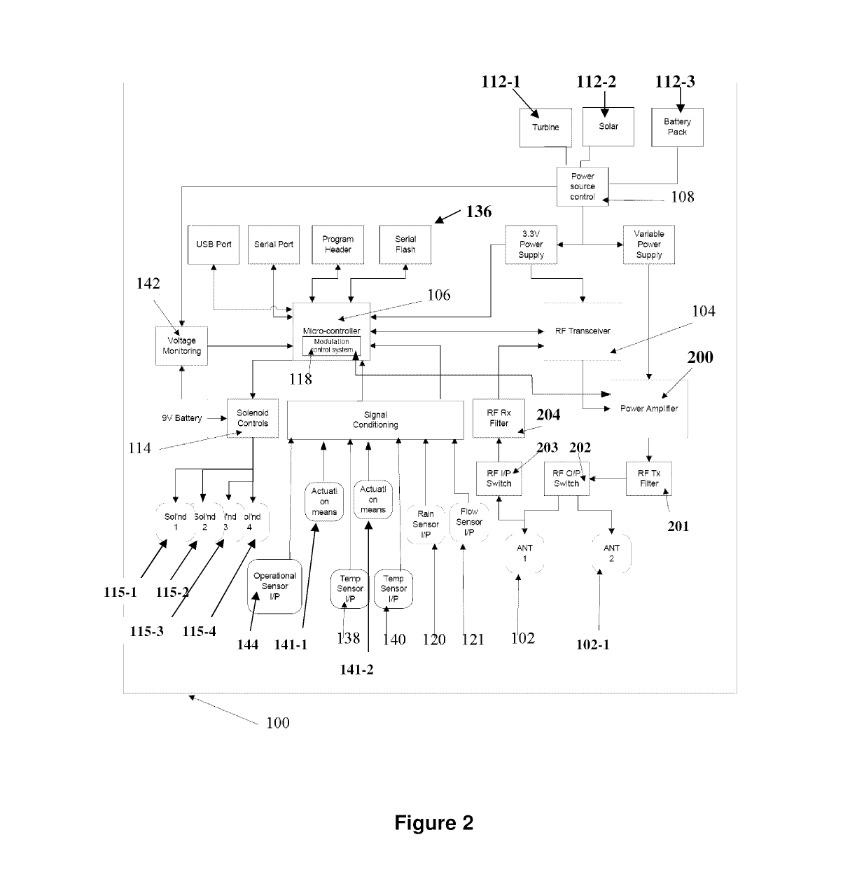

An example of a VPDMT suitable for incorporation into a device control node in accordance with one embodiment of the invention is shown in FIG. 2. The VPDMT module shown generally at 100 comprises a RF transceiver 104, an antenna 102 and optional additional antenna 102-1, a controller 106, which comprises supervisory circuitry 118, a serial flash memory 136 and a power source control 108 operatively coupled to a rechargeable or non-rechargeable energy storage device and a power source such as a turbine 112-1, solar cell 112-2, or battery pack 112-3. The energy storage device may comprise a battery-, capacitor- or other system, for example. The VPDMT module is further operatively associated with one or more actuating devices represented as 115-1 to 115-4. While four actuating devices are illustrated in the embodiment depicted in FIG. 2, it is to understood that the number of actuating devices may be more or less than four, for example, two or three, or 5, 6, 7, 8, 9, 10, 11, 12, 13, 14, 15 or 16. In one embodiment, the VPDMT module is operatively associated with 8 actuators. In another embodiment, the VPDMT module is operatively associated with between 8 and 16 actuators. In one embodiment, in the device control node, the VPDMT module is hard-wired to the one or more actuators.

The VPDMT module 100 may be operatively associated with one or more sensors. For example FIG. 2 illustrates temperature sensors 138 and 140, rain sensor 120, and water flow sensor 121, which would be suitable for a wireless control system for irrigation management for example. The VPDMT module can be associated with other sensors for example, for monitoring motion, telemetry, moisture, and the like, depending on the application of the wireless control system. Sensors operatively associated with the VPDMT can also be for sensing or detecting one or more configurations of an actuator, for example, a valve or solenoid position 141-1 and 141-2.

### Communication Routing

Communication within the wireless control system may involve one or more nodes. According to an embodiment of the present invention, routing of an RF signal from a controller to a destination VPDMT module, for example, may be determined on an ad hoc basis by the system and may be direct, if the destination VPDMT module is within range, or via re-transmission of the signal by one or more intermediate VPDMT modules. The RF signals transmitted from the central controller(s) represent commands to the VPDMT modules to execute an event, such as activating or deactivating one or more of the actuating means with which it is operatively associated, collecting data from one or more sensors, or checking the status of the actuating means or sensor(s).

With reference to FIG. 1, the wireless control system 500 comprises a plurality of VPDMT modules 100, which are in communication via RF signals with at least one central controller 200. The central controller 200 is operatively associated with a VPDMT module 100 to interface wirelessly with the network. The VPDMT main controller module 350 can be integrated into the central computing device or can be part of an intermediary device. In an alternative embodiment, a less complex module, such as a RF transceiver, can be used in place of the VPDMT associated with the central controller. If necessary, the intermediary device can be configured to convert the transmissions between TCP/IP format and wireless network format to provide communications between VPDMT modules on the wireless network and the central computing device 200 via TCP/IP. The central controller 200 can further be connected to the internet through a standard connection 202.

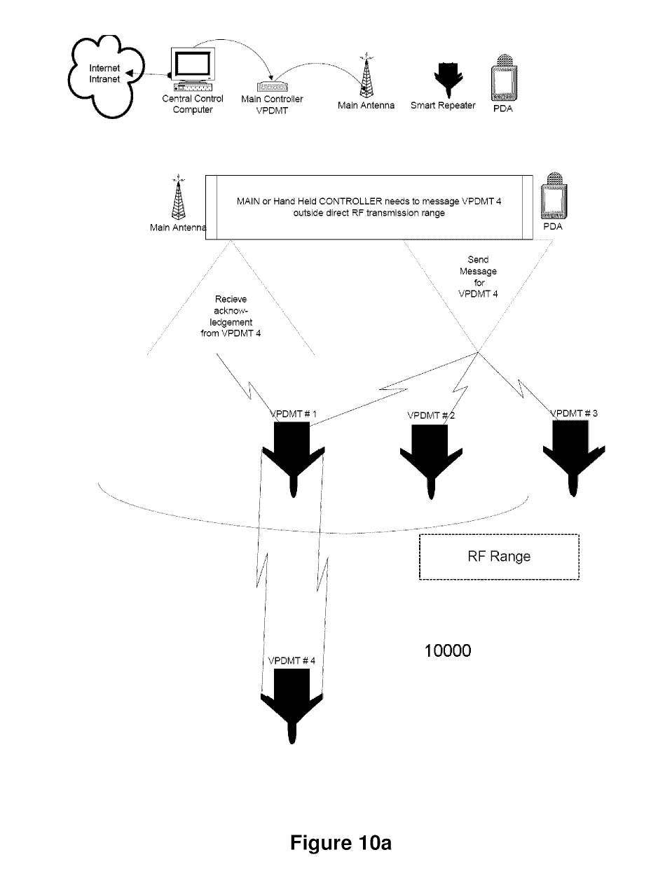

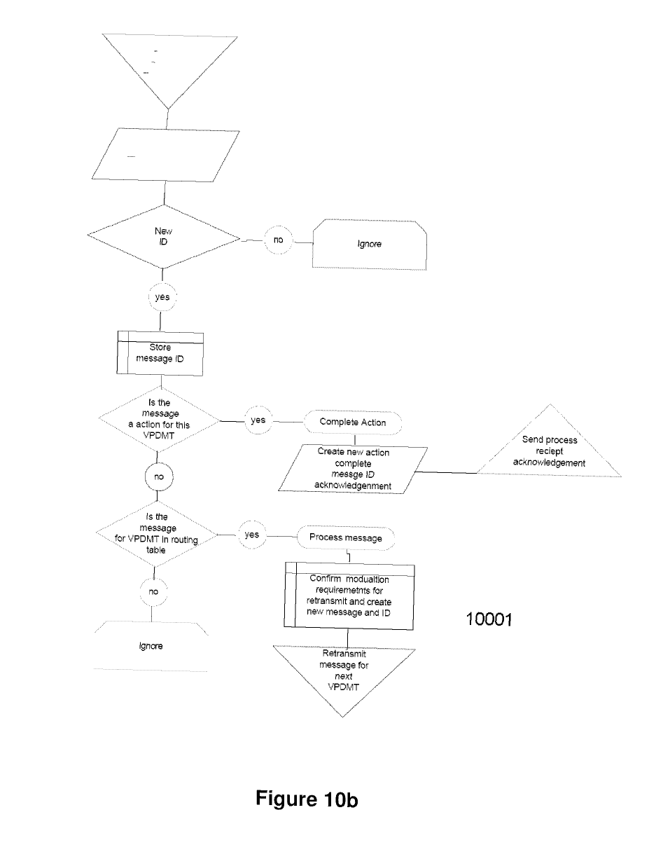

The central controller 200 may comprise a processor for processing communication signals, for example. When the control system is in operation, the VPDMT modules 100 transmit signals to the central controller 200 either constantly or in a predetermined manner, for example regularly, intermittently, upon request or in another way. Each VPDMT module 100 may possess a unique identifier for enabling the system 500 to route transmissions from any one module within the system to any other module in the system. A VPDMT module 100 that is out of range of the central controller 200 may route transmissions through intermediate VPDMT modules until the transmission reaches its destination and vice versa. An example of a corresponding wireless control system communication diagram 10000 is illustrated in FIG. 10A and a flow chart 10001 of example communications in the wireless control system is illustrated in FIG. 10B.

A wireless control system according to an embodiment of the present invention may employ one or more of a number of communication protocols as would be readily understood by a worker skilled in the art. A wireless control system according to an embodiment of the present invention may also employ one or more or a combination or two or more of a number of routing schemes, for example, pro-active table-driven routing, reactive on-demand routing, flow-oriented routing, adaptive situation-aware routing, hierarchical routing, geographical routing, power-aware routing, multicast routing, geographical multicast or other routing protocol, as would be readily understood by a worker skilled in the art.

By way of example, in the network shown in FIG. 1, the nodes are disposed such that the communication range of each node corresponds with the power and transmission mode used by the transceiver of its VPDMT module. The VPDMT module is configured to provide at least two modulation modes. Low power modulation is used to reach nearby nodes, while a high power modulation is used to reach more remote nodes. Special purpose nodes such as repeaters may be used to relay signals to other, more distant nodes.

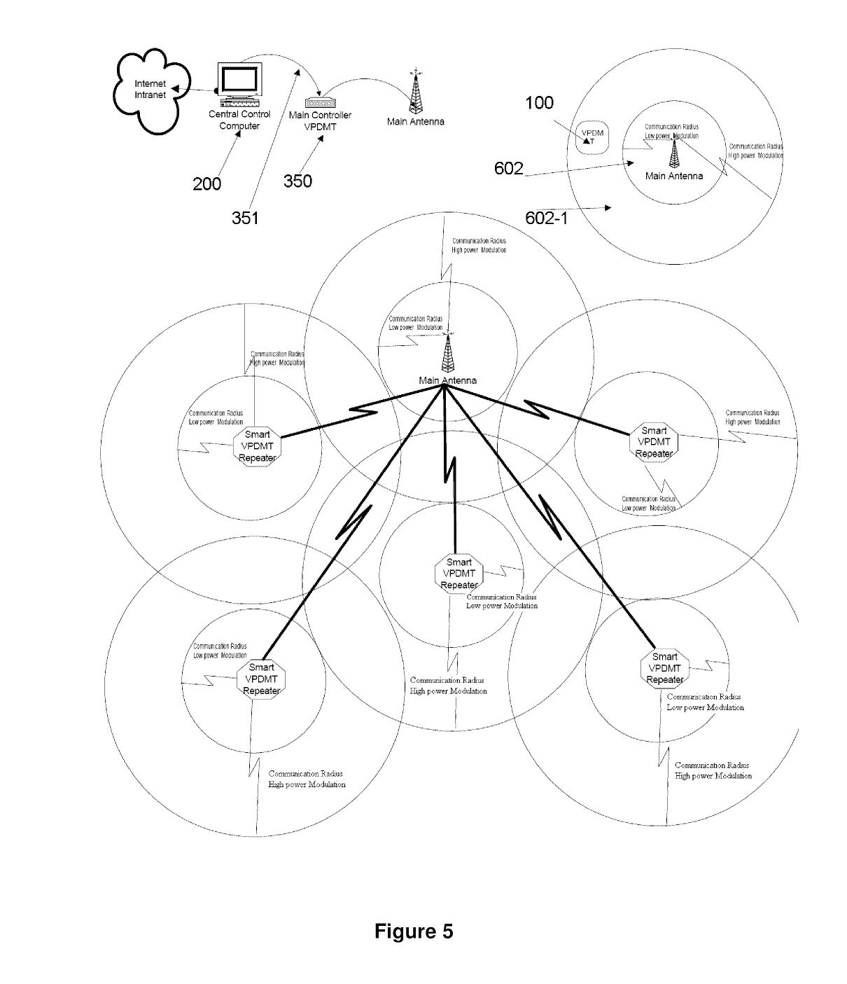

FIG. 5 depicts an example of an arrangement of VPDMT modules in a control system in one embodiment of the invention and illustrates schematically the overlap of the extended communication radius 602-1 of each VPDMT module 100 with neighbouring VPDMT modules. Central controller 200 needs to communicate only with the most proximal of the VPDMT module(s), which will in turn route the signal via other VPDMT module(s) within its communication radius 602. Subsequent VPDMT modules continue to re-transmit the signal until it ultimately reaches its target VPDMT module. The topology of the network of VPDMT modules thus allows for an extended reach for the control system even when the communication radius of each module is limited. When a VPDMT module is connected to more than two other modules, relaying of signals can be performed using a variety of routing methods, as would be understood by a worker skilled in the art, in order to route the message in a desirable mariner, for example using the fewest hops, the lowest delay, or the least overall power. Routing tables, similar to those used in internet protocol (IP) routing, can be kept for this purpose. In a typical routing operation, a VPDMT can check the intended address of an incoming packet and look up which node the packet should be forwarded to next using a routing table. A sequence of such forwarding operations is configured to ensure the data reaches its destination. Important communications can be routed across multiple paths to ensure a destination VPDMT node is reached in a timely manner.

In one embodiment, and with reference to the VPDMT module depicted in FIG. 2, the wireless control system is configured to transmit signals as follows. A VPDMT module 100 receives an incoming signal via the one or more antennas 102 and passes the signal on to the controller 106, which evaluates the signal to determine whether the identifier matches the identifier of that particular VPDMT module. If the intended recipient is the VPDMT module itself, the VPDMT module then prepares the appropriate response, such as activating an associated actuating means or collecting data from a sensor or monitor. If the intended recipient is not the VPDMT module itself, the controller 106 then prepares the signal to be re-transmitted to the intended recipient module. The controller 106 determines the best route to the destination, based on its knowledge of the positions of other VPDMT modules in the network and re-transmits the signal as necessary. The best route can be determined, for example, by the smallest number of intermediate modules, by modules with the maximum power available, by the most reliable links or by a pre-established routing protocol. The transmitting VPDMT module awaits confirmation of receipt of the signal. If confirmation is not received, the VPDMT module attempts to re-transmit the signal. When confirmation is received, the processing for the signal is completed. This routing process allows for the transmission of data around obstacles, such as buildings or metal structures that may block RF signals. The supervisory circuitry for supporting the operation of each VPDMT module can be implemented in software or in firmware that is stored in a memory, such as memory 136. The controller 106 executes the instructions stored in the memory to carry out the signal interpretation and transmission functions of the VPDMT module 100.

The data transmitted from the VPDMT modules 100 to the central controller 200, in FIG. 1, can include status information, power levels and/or it can include data gathered from any connected sensors. In one embodiment of the invention, a VPDMT module can periodically sample one or more sensor or monitor to obtain sensor/monitor data for processing by controller 106 and/or transmission. Processing of the data can include, for example, statistical analysis (average, median, standard deviation and higher order correlations), linear regression, linear approximation and other mathematical modelling processes to facilitate the end use of the data. The processed data can be stored in memory 136 and accumulated over a pre-determined period of time and then transmitted, or it can be transmitted directly after processing. Data compression can be performed if required to reduce the data transmission requirements and/or to facilitate the end use of the data. Compression can include differential coding within a channel or jointly between multiple correlated channels. Similarly, the data can be filtered prior to transmission, for example, by noise reduction, cross-channel interference reduction, missing sample interpolation and other signal processing to enhance the quality of the data. Data fusion, or aggregation and processing of data from multiple VPDMTs can also be performed.

The data thus processed can be transmitted to other VPDMT modules, to the central controller or to a handheld node incorporated into the system, as described below. The data can be transmitted on a pre-determined schedule or modulation mode, when the accumulated data reaches a pre-determined size or when requested by a central controller or an auxiliary mobile controller. When the data is delivered on a schedule, the memory 136 or controller 106 of transmitting VPDMT module is programmed with the address of the VPDMT modules or controllers that are to receive the data as well as the schedule for delivery. When data is delivered on request or on command, the request or command sent to the transmitting VPDMT module contains the address of the requesting module/controller.

Depending upon the size, for example the number of nodes, of the system 500 and the power of the central controller 200, the system can be organised such that certain VPDMT modules 100 act as “reporter-nodes” to collect data from surrounding modules and transmit this data to the central controller 200, as well as receiving and transmitting signals from the central controller 200 and distributing these to surrounding VPDMT modules, in order to reduce the volume of incoming transmissions. Each VPDMT module 100 of the network, however, remains independent and can send and receive transmissions independently. In one embodiment of the invention, the VPDMT modules 100 are in constant communication with the central controller 200 and the control system is dynamic allowing for real time control.

In one embodiment, the wireless control system is configured such that certain VPDMT modules 100 act as “intelligent gateways” and are programmed to store data for operating up to 200 actuators via VPDMT modules 100 operatively associated with the actuators, thus allowing for continuity of control during power brown-outs. In another embodiment of the invention in which the wireless control system is configured such that certain VPDMT modules 100 act as “intelligent gateways” capable of operating up to 200 actuators via VPDMT modules 100 operatively associated with the actuators, for example between about 50 and about 180 actuators, the system is configured to allow control of up to 20,000 actuators in total, for example between about 4,000 and about 15,000 actuators. In one embodiment in which the wireless control system comprises intelligent gateways, communications can be sent from a central or handheld controller to all gateways essentially simultaneously. The gateways then relay the communications to the VPDMT modules 100 operatively associated with the actuators. This configuration and routing protocol allow for much more rapid distribution of commands throughout the system, for example within minutes rather than hours.

As discussed above, a wireless control network according to an embodiment of the present invention may be configured to use a star network topology with a master-slave communication hierarchy. An example architecture 1100 of a wireless control network according to an embodiment of the present invention is illustrated in FIG. 11. In this network, all communication is directed via a star VPDMT module (Star Smart Repeater #4), which re-transmits the information to the destination VPDMT module. The star VPDMT module (or “master”) acts as a relay station and is therefore positioned within radio range of all modules in the “star” (the “slave” VPDMT modules). In this network, the effective range of the VPDMT modules in the network can be as much as doubled by retransmitting signals through the smart repeater.

FIG. 12 illustrates a flow chart 1200 of a routing protocol for an example signal exchange within the wireless control system 1100 illustrated in FIG. 11. Described below is an example of a basic network scenario in which central controller 200 attempts to communicate information to VPDMT 40.40, which is outside the transmission range of central controller 200. The course of action is as follows: Central controller 200 generates and transmits a signal to VPDMT 4 and requests acknowledgment. VPDMT 4 recognizes that it is the intended recipient and responds using an acknowledgment signal addressed to central controller 200. Central controller 200 recognizes the acknowledgment signal from VPDMT 4 which concludes the communication with central controller 200. VPDMT 4 re-transmits the signal to VPDMT 40.40 as soon as possible (a delay may occur if there is other channel traffic). VPDMT 40.40 recognizes that it is the recipient of the retransmitted signal and transmits an acknowledgment signal addressed to VPDMT 4. VPDMT 4 recognizes the acknowledgment signal from VPDMT 40.40 and concludes the communication.

In the example, four signals are used to forward the information from central controller 200 to VPDMT 40.40. This is may be considerably different from what would occur in a multi-hop communication system such as a Zigbee™ network, which may require transmission of between 14 and 18 signals to achieve successful acknowledgment of a transmitted signal, for example. Multi-hop communication systems typically require large numbers of short-range hops to relay a signal in a mesh network. A wireless control network according to another embodiment of the present invention may comprise a plurality of suitably disposed “slave nodes” to improve coverage and to reduce power requirements for transmission of its VPDMT modules.

In one embodiment of the invention, all VPDMT modules within the system are configured to both receive and transmit signals. In accordance with this embodiment, each VPDMT module transmits an acknowledgement signal to the sender of a signal upon receipt of the signal.

A wireless control system according to an embodiment of the present invention may include one or more variable power dual modulation repeaters/field controllers, which may be used to reduce communication time. For example, the radio spectrum may be subdivided into channels and each smart repeater may be configured to use only channels that are not also used by another repeater within communication range. Furthermore, a repeater may selectively allocate channels when broadcasting or multicasting. This may allow simultaneous transmissions of different signals without collisions and may be used to facilitate low in network latency in certain network configurations and accordingly employed in some embodiments of the present invention.

### Signal Transmission

A system in accordance with an embodiment of the present invention may provide for a VPDMT module using a single transceiver or two or more transceivers for enabling both low power (e.g. low to mid-range communications up to about 5 km) and high power (e.g. long-range communication up to 20 km) communications. In general, the single transceiver variable power dual modulation is capable of independently selecting the appropriate modulation requirements or using a predetermined modulation technique based on, for example, data size, bit rate and packet size, with automatic adjustable power output levels that may provide a predetermined range, latency and/or bandwidth.

A VPDM transmission scheme may reduce and potentially eliminate packet loss/degradation and increase system wide acquisition times and communication link rates in excess of 75%. For example, it has been demonstrated that transmissions that would take 20-30 minutes using a single modulation system, may be performed in three to five minutes using a VPDM transmission scheme.

It is noted that a number of communication algorithms and methods may be used in a wireless control system, such as for example described in PCT Publication No. WO2007/104152. For example, various signal transmission algorithms and timing details may be considered for a particular application to provide for greater communication efficiency and/or reliability. Accordingly, different RF transceiver states may be considered and implemented to provide for such improvements. Examples of transceiver states may include, but are not limited to: transceiver Sync States, wherein acquisition of a communication path between a controller and a transceiver is performed; transceiver Transmit States, wherein signal transmission between transceivers is performed; transceiver Active States, wherein the transceiver actively waits for a signal transmission to be received; transceiver Listen States, wherein the transceiver inactively waits for a signal transmission; transceiver Standby States, wherein a transceiver is temporarily inactive, and transceiver Deep Sleep States, wherein an inactive transceiver remains inactive after a long wait time; transceiver Wake Burst Modes, wherein a central controller awakens a transceiver to enable signal transmission; transceiver Receive Modes, wherein a communication path is established with a central controller for signal transmission therefrom; and controller/transceiver Transmit Modes, wherein signal transmission between controllers is performed.

In one embodiment of the invention, at least a portion of the VPDMT modules in the control system are configured such that in Listen State, the module listens simultaneously in two modes, for example, in FSK mode and in DHSS/FSSS mode.

According to some embodiments of the invention, a number of modulation modes may be used by a VPDMT module transceiver. For example, frequency shift keying (FSK) is a modulation mode wherein a carrier signal is switched between different frequencies to convey information. For example, a binary “1” may be communicated by transmitting a carrier wave at a first frequency for a predetermined period of time, while a binary “0” can be communicated by transmitting a carrier wave at a second frequency for a predetermined period of time. As another example, spread spectrum modulation modes such as frequency hopping spread spectrum (FHSS) and direct sequence spread spectrum (DSSS) may be employed, which may enable high data transfer rates and reduced risk of interference with other devices in or outside the network. The spread spectrum schemes operate essentially by spreading the transmitted power over a wider bandwidth to improve signal-to-noise ratio and reduce interference. For example, FHSS can operate by periodically changing carrier frequencies according to a predetermined sequence known to both transmitter and receiver. Spectrum spreading helps avoid dwelling at a single frequency for an extended period of time. Avoiding dwelling at one particular frequency can also enable transmission at higher power while complying with telecommunication regulations. FHSS can also be made adaptive such that when communication is poor at a specific carrier frequency that frequency is not further used until the expiration of a predetermined period. DSSS similarly modulates a signal by multiplying a signal to be transmitted by a “noise signal” known both to transmitter and receiver. Further modulation schemes, including conventional and spread spectrum, amplitude modulation, amplitude shift keying, quadrature amplitude modulation, frequency modulation, phase shift keying, on-off keying, phase modulation, and/or other modulation schemes as would be readily understood by a worker skilled in the art can be used.

In accordance with an embodiment of the present invention, the wireless control system may employ frequency-shift keying (FSK) and/or frequency hopping to transmit signals within the system when operating in a low power mid range mode, and may employ Direct-Sequence Spread-Spectrum (DSSS) and/or Frequency Hopping Spread Spectrum (FHSS) modulation when operated in a high power long range mode. As described, a selection of the operation mode may be determined automatically and dynamically by the control system and VPDMTs, or preset for a given embodiment. As noted above, one or more ISM or other frequency bands may be used for signal transmission, for example, 433, 868, 915 MHz, 2.4 GHz or 5.8 GHz. In one embodiment, signal transmission is in the 915 MHz ISM Frequency Band which may provide a low bit rate, which can help to increase the range and receiver sensitivity, and may also provide better soil penetration than other frequencies, which can facilitate signal transmission in applications related to landscape management. For example, lower frequencies are known to be attenuated less by obstacles such as soil, and can therefore penetrate soil to a greater depth than higher frequencies. This enables improved communication by facilitating increased signal strength at near or below-ground antennas.

In one embodiment of the invention, the wireless control system comprises a plurality of above-ground VPDMT modules configured to receive transmit signals at 433 MHz and a plurality of ground level and/or below ground VPDMT modules configured to receive and transmit signals at 915 MHz.

In one embodiment, to decrease network latency and reduce message collisions, communications in a star network can be performed using a time division multiple access (TDMA), frequency division multiple access (FDMA), code division multiple access (CDMA), or other multiple access method/multiplexing scheme, as would be understood by a worker skilled in the art. For example, each VPDMT can communicate with the smart repeater on a separate frequency (for example for FSK), schedule of frequencies (for example for FHSS), or using a substantially orthogonal chip sequence (for example for DSSS). This can enable substantially simultaneous communication with multiple VPDMTs, thereby increasing efficiency and decreasing latency. For example, the smart repeater can communicate substantially simultaneously with multiple VPDMTs using different and substantially separated carrier frequencies for each communication link.

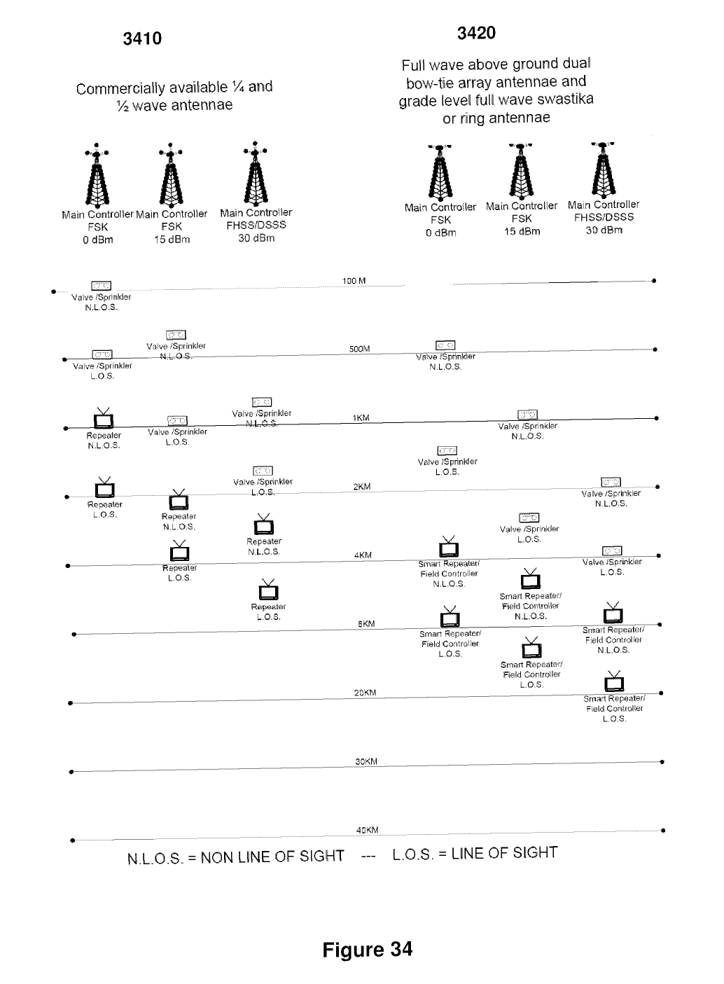

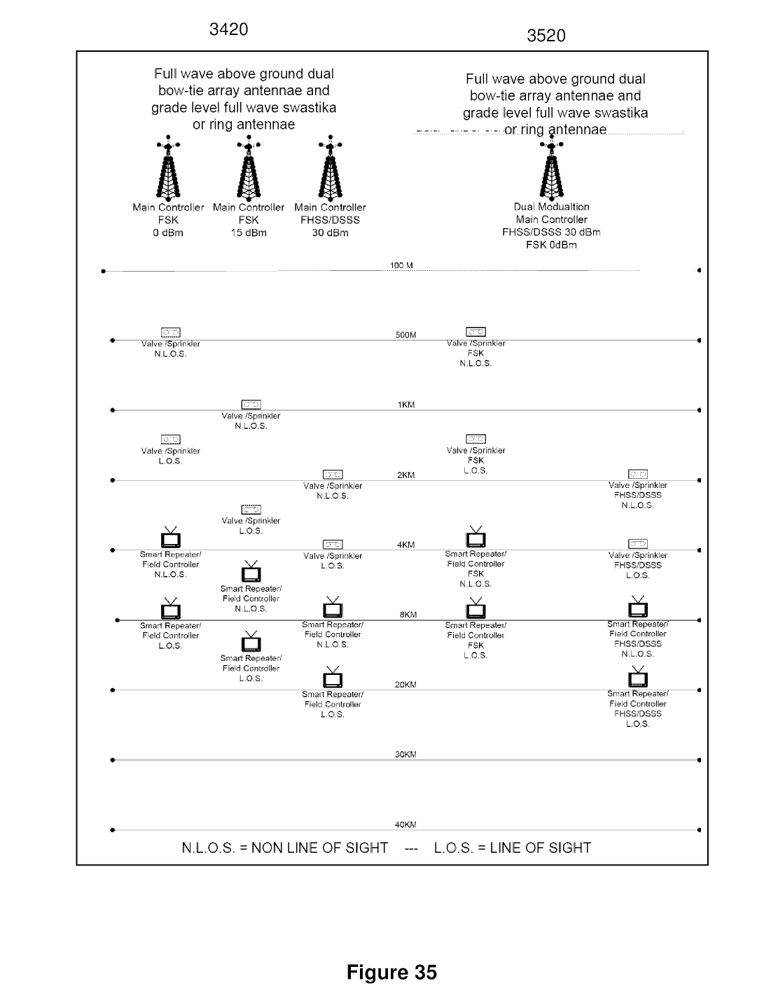

FIG. 35 schematically illustrates a communication range diagram 3420 associated with the embodiments of FIG. 34, and a communication range diagram 3520 for a similar system wherein variable power dual modulation is provided to include both FHSS/DSSS modulation at 30 dBm output power and FSK modulation at 0 dBm. Accordingly, depending on the range and type of communication required, the variable power dual modulation system enables further selectivity, which leads to improved communication and power characteristics.

In accordance with various embodiments of the present invention, low power consumption and long-range transmission capability are provided and may optionally be optimized in a number of ways. For example, by configuring a node to operate at substantially maximum output power allowed for unlicensed operation under FCC Part 15; selecting an antenna that will allow propagation to be substantially maximised over terrain in area of intended use; configuring transceiver antenna orientation to optimize signal transmission by minimizing noise interference and power loss; configuring the node to provide short response time; or configuring the node to utilise routing protocols that offset the exponential increase in communications that occur when a plurality of nodes are utilised in a control network.

For example, a network of nodes with restricted line of sight of 100 meters that needs to send a message to another node 2 km away may require more than 20 line of sight (LOS) relay nodes for communication, whereas a wireless control system with nodes that can communicate without LOS (NLOS) over 1 km, for example, may require one relay node. Therefore, using a higher power modulation mode may require fewer relay nodes.

### Frequency-Shift Keying

In one embodiment of the invention, the control system employs FSK to transmit signals between components of the system when operated in a low power mid range mode. FSK allows the frequency of the signal carrier to vary between lower and upper operating frequency limits, but the signal can only be carried on one frequency channel. The carrier frequency is shifted using a set of predetermined values. For example, transmission of a lower frequency carrier wave for a predetermined period of time may signify transmission of a binary “0,” while transmission of a higher frequency carrier wave for a predetermined period of time may signify transmission of a binary “1.” Frequency shift keying and variants thereof are known in the art.

According to an embodiment of the present invention, an FSK technique with a center frequency of 915 MHz may be used that may switch between 902 MHz and 928 MHz, for example.

According to an embodiment of the present invention, signals may be transmitted from a central controller either directly to a VPDMT module or via repeater transceivers using an FSK method. In accordance with this embodiment, the central controller attempts to send the signal across the network using a particular frequency channel, for example, the 915 ISM Frequency Band. If the VPDMT module or repeater transceiver does not receive the signal, no acknowledgment signal is sent to the central controller and the central controller attempts to re-transmit the signal using a different carrier frequency on the same frequency channel. This process continues until the central controller receives an acknowledgment signal from the VPDMT module or repeater transceiver. If the signal needs to be re-transmitted in order to reach its final destination VPDMT module, the VPDMT module or repeater transceiver attempts to send the signal to another repeater transceiver, another VPDMT module or to the destination VPDMT, depending on whether the destination VPDMT is within its range, and repeats the above transmitting process until it receives an acknowledgment signal from the proper transceiver.

It is noted that other techniques for signal transmission may be used in a wireless control system according to an embodiment of the present invention, such as Amplitude-Shift Keying (ASK), Minimum Frequency-Shift Keying (MSK), Phase-Shift Keying (PSK), or other methods as would be readily understood by a person skilled in the art.

### Direct-Sequence Spread-Spectrum

A wireless control system according to some embodiments of the present invention may employ one or more of a number of spread spectrum modulations to transmit signals between nodes of the system. For example, a direct sequence spread spectrum (DSSS) modulation scheme may be used between nodes operating in a high power long range communication mode. According to one embodiment, selecting DSSS over FSK, for particular types of communications, for example in a burst mode, and then using DSSS for low data transfer or scheduled FSK for high data transfer, may lead to power savings and increases in system efficiency. Different modulations may also provide different communication ranges, for example.

The person of ordinary skill in the art will understand that other signalling algorithms may be considered to operate in this mode, without departing from the general scope and nature of the present disclosure.

### Frequency Hopping

In one embodiment of the invention, the wireless control system employs frequency hopping, optionally in combination with FSK and/or DSSS (for example Frequency Hopping Spread Spectrum—FHSS), for signal transmission.

In one embodiment, frequency hopping may be used to reduce the time to complete a system wide communication. For example, when using a single channel transmission system such as a FSK modulation, updating VPDMT modules may take 20 minutes or more. For example, communicating with a large number of VPDMT modules may take multiple hours because of the low bit rates. The frequency hopping method may improve transmission time and reduce communication time.

As an example of this time reduction, in an FSK system with a single controller, four repeaters and 40 valve actuating nodes, communication with each unit must be sequential if broadcast is available using a single channel only. A wireless control system using low bit-rate FSK transmissions may take about 20 minutes or 30 seconds per unit (based on 1.6 seconds communication time and a 20 second wake cycle) to update the 40 valve actuating nodes. In contrast, using FHSS (based on a 1.6 seconds of communication time and a 20 second wake cycle) each smart repeater controller can act as an independent controller that can simultaneously talk to 12 nodes requiring only 1-3 minutes to perform the same communication.

Use of the frequency hopping in a wireless control system according to one embodiment of the invention can provide advantages over a fixed-frequency transmission For example, signals transmitted using frequency hopping are more resistant to noise and interference and are more difficult to intercept. In addition, transmissions can share a frequency band with many other transmissions with minimal interference.

In one embodiment of the invention, frequency hopping is used to vary the frequency of the signal carrier between pre-set operating frequencies, and the signal can be carried on more than one frequency channel.

### VPDMT Module

A variable power dual modulation transceiver module may be included in one or more nodes of the wireless control system. A VPDMT module may be configured for communication using a VPDMT scheme for long range high power signal modulation and short range low power signal modulation. A VPDMT module according to an embodiment of the present invention may be configured as an internal or external component of a node as further described herein. A VPDMT module may be used as a peripheral device for interconnection with certain nodes using a predetermined interconnect system. For example, it may be a peripheral providing wireless communication to a handheld node via a USB, PCMCIA or CardBus™ interface or another interface as would be readily understood by a person skilled in the art. According to one embodiment of the invention, a VPDMT may be configured to be used universally within one or more types of wireless control system nodes. For example, VPDMTs may be configured to require merely software and/or firmware programming to provide the functions of two or more types of nodes of the system.

A VPDMT module according to an embodiment of the present invention may include one radio frequency transceiver for each VPDMT mode or one radio frequency transceiver that can operate in each of the VPDMT modulation modes intermittently as required, for example to adjust one or more of power output, range, reliability and link budgets for both large data and low data transmissions. Examples of high power long range modulation may include, but are not limited to FHSS/DSSS modulation, whereas examples of low power low to mid-range modulation may include, but are not limited to FSK modulation.

In accordance with one embodiment of the invention, the VPDMT module comprises one radio frequency transceiver that can operate in each of the VPDMT modulation modes as required. In another embodiment, the VPDMT module comprises one radio frequency transceiver that can operate in each of the VPDMT modulation modes as required and two antennas, each configured to operate in one of the modes.

A node according to some embodiments of the present invention may comprise a VPDMT module configured to transmit and receive RF signals. A long range transmission mode may be provided using a spread spectrum modulation such as a frequency hopping spread spectrum (FHSS) or direct sequence spread spectrum (DSSS), for example. A low power transmission mode may be provided using a low data rate communication mode such as a low-power frequency shift keying (FSK), for example. According to an embodiment of the present invention, a node may be configured for dual mode operation and to selectively operate in at least one of at least a high power or a low power mode. The high and low power modes may be further characterized by predetermined use of one or more of one or more antennas, antenna directivity, orientation and configuration and selection of direction of signal propagation, for example.

In one embodiment, the VPDMT module is capable of operating with low power consumption and in a variety of environments of varying hostility to communication. In one embodiment of the invention, the VPDMT module is configured to operate in a star network topology with a master/slave hierarchy. In the star network, one master device serves as a central hub with communication links to a number of slave terminals, which are directly linked principally to the master. The person of ordinary skill in the art will appreciate that other types of network configuration may be considered without departing from the general scope and nature of the present disclosure, for example a hierarchy of star networks, ad-hoc networks, mesh networks, ring networks, or combinations thereof.

In one embodiment, one or more VPDMT modules can be configured to operate in a low power communication mode, while one or more other VPDMT modules operate in a frequency hopping spread spectrum (FHSS) mode. For example, VPDMT modules that require only short range communication can operate using a lower power FSK mode, thereby saving power. This dual mode system can be configurable such that some VPDMT modules are configured to use only one or the other of the communication modes, while other VPDMT modules are configured to switch between modes depending on which VPDMT module is being communicated with. For example a smart repeater VPDMT module can be configured to operate in one mode, such as FSK, when communicating with a nearby VPDMT module using FSK, and to operate in another mode, such as FHSS, when communicating with another VPDMT module using FHSS. This allows terminal-to-terminal communication compatibility while simultaneously supporting multiple transmission modes.

In another embodiment, VPDMT modules may be configured to adjust their communication modes depending on observations indicative of the radio environment and of network conditions at each VPDMT module. For example, one or more VPDMT modules can execute a configuration operation wherein one or more communication modes are tested and evaluated to determine a collection of communication modes that can be used for communication links between various VPDMT modules to support network connectivity and bandwidth requirements in an energy-efficient manner. For example, evaluation can include determining the strength of signals transmitted and received by the VPDMT modules, the reliability of test messages transmitted through the network, and other mechanisms as would be readily understood by a worker skilled in the art. Based on this evaluation, the VPDMT modules, or a central controller, can cooperatively or independently select communication modes to be used by each VPDMT module such that the plurality of communication links supports a functioning and energy efficient communication network. It is noted that some VPDMT modules, for example smart repeaters, may be required to operate alternately in two or more communication modes in order to facilitate connectivity of all VPDMT modules. This can allow communication between devices operating in different modes by using an intermediate device to “translate” messages. Other considerations, such as remaining battery power at one or more VPDMT modules, may also be accounted for during configuration to maximize the operational lifetime of VPDMT modules. For example, VPDMT modules with relatively low battery energy can be preferentially assigned lower power communication modes. Furthermore, to avoid premature battery drainage of high-use devices such as “gateway” VPDMT modules which are called upon to relay a disproportionately large amount of network traffic, the configuration operation can be performed dynamically, so as to share communication burdens between devices. Other methods of configuring the communication modes of the VPDMT modules to provide energy efficiency or long lifetime would be readily understood by a worker skilled in the art.

In one embodiment, both the transmission power and the communication mode of each VPDMT module can be adjusted to provide a network having desired connectivity and other characteristics such as bandwidth, while retaining energy efficiency or long lifetime of the network. For example, in a configuration operation, VPDMT modules can select or be assigned a predetermined communication mode, and can adjust transmission power such that network connectivity is retained while power in excess of what is required for operation is reduced. For example, a transmitting VPDMT module can be configured to transmit one or more test signals at predetermined power levels and the test signals that are received by a selected receiver VPDMT module may trigger a predetermined response that, if returned to the transmitting VPDMT module within a predetermined time, may serve as an acknowledgement and an indication of what power levels are required for successful communication. The transmitting VPDMT module can select as its transmission power level the lowest power level corresponding to the set of test signals for which an acknowledgement is received, for example.

In one embodiment, different aspects of the radio operation of the VPDMT modules can be adjusted to establish an effective network of communication links with desired energy efficiency. For example, radiation patterns can be adjusted by using phased antenna arrays so that transmitted radio energy is focused on a target receiver area, thereby reducing interference between VPDMT modules and reducing the energy required for communication with a target. Alternatively, broadcast information can be transmitted in a substantially omnidirectional manner, by suitably configuring the antenna array. In one embodiment, radio energy can also be transmitted at an oblique angle with respect to the ground or other surface to facilitate radio range enhancement using ground wave propagation or signal reflection. Various methods for direction of radio energy using a phased array or diversity antenna system, or by adjusting the orientation angle of an antenna, would be understood by a worker skilled in the art.

A VPDMT module according to an embodiment of the present invention may be configured to selectively operate in either a high power mode or a low power mode to complete certain types of communications pre-determined to respectively provide various advantageous system conditions. For instance, proper selection of low or high power modes for a given type of communication may lead to increases in one or more of a range selection for a given environment or application, power savings, system reliability and/or efficiency, reduction of inter-device interference, and other such advantages.

As is depicted in FIG. 35, in one embodiment of the invention, using VPDMT modules in a control system provides for the use of a single, flexible transceiver type without sacrificing the ranges achievable by using separate transceiver types. This allows for increased flexibility in the system, as well as energy efficient networks with low interference between VPDMT modules. For example, since VPDMT modules can reduce their transmit power if only short-range communication is required, there is less incidence of interference since the number of VPDMT modules within transmission range is decreased. This also allows for spatial frequency re-use which can facilitate more options for simultaneous communication, as would be understood by a worker skilled in the art.

In one embodiment, variable power dual modulation allows for improved data transfer rates and/or reliability with increased or maximum range availability. For example, in one embodiment, the creation of a low power sniff mode and a high power burst mode system provides for significant energy savings which may provide battery powered units with battery life of up to a number of years. In one particular example, where FHSS/DSSS and FSK modulation are used in high and low power modes respectively, a unit standby time could be provided such that a given unit only wakes up to listen for incoming communications for six seconds out of every 300 seconds instead of three seconds out of every 60 seconds for real time activation.

In another example, where FHSS/DSSS and FSK modulation are used in high and low power modes respectively, the high power FHSS/DSSS mode can be used to wake a unit from a power saving sleep mode where the unit remains asleep for about 98% of the time. For example, a unit can enter a sleep mode when it is anticipated that communication with the device will not be required for a predetermined period of time. Once awoken the unit can transmit and receive in a low power FSK mode. This would allow the individual units to listen for common broadcast messages but take advantage of a particularly strong smart repeater to remote unit link to save power while standing by to receive messages from the repeater. For example, when a unit enters a sleep mode, it can be configured with a schedule of times at which the unit receiver is temporarily powered on to listen for signals indicating that the unit is being prompted to exit the sleep mode. If a strong FHSS signal is used for transmitting the wake-up signal, the listening period can be shortened since data can be transmitted faster in this mode. Furthermore, a powerful FHSS wake-up signal can be detected using less power since the signal-to-noise ratio is strong. For frequency hopping, the unit listening for wake-up signals can also be provided with a schedule of frequencies to monitor, thereby further increasing the efficiency of communicating wake-up signals. Wake-up signals can be similarly scheduled for transmission when the sleeping units are known to be listening to improve communication efficiency. Clocks can be periodically synchronized or adjusted such that wake-up signal listen and transmit activities overlap, as would be understood by a worker skilled in the art.

In one embodiment, bursts can be implemented in FHSS/DSSS to bring units out of sleep mode or standby mode, which then communicate via FHSS/DSSS for low volume data transfer, or schedule a transmission time for larger data transmissions via FSK. Bursts configured to bring units out of sleep mode or standby mode can be scheduled to be transmitted substantially at times when the receivers of units to be woken up are active. A predetermined wake-up signal may be used for this purpose.

According to an embodiment of the present invention a VPDMT module may be used in combination with an antenna system. The antenna system may comprise one or more antennas and may be configured to support the variable power output and/or the data link budget requirements for output power and signal modulations of the VPDMT module. In one embodiment, frequency and impedance matching, and phased array operation to improve signal pattern integrity and strength can improve efficiency levels to about 66% for above-ground transmission, and to about 25-30% efficiency at or below ground level.

In a specific embodiment, the VPDMT module is configured for operative association with one or more actuating means and optionally one or more sensors, for example irrigation sprinkler rotor or valve control actuators, or rainfall or water flow sensors. Solenoids or other electronically controllable actuators can be used for this purpose, along with analog to digital converters, electromagnetic relays, motors, piezoelectric actuators or sensors, optical encoders, and the like.

The VPDMT module is suitable for use in various communication systems including point-to-point, point-to-multipoint and peer-to-peer systems. In one embodiment of the present invention, there is provided a wireless control system that comprises a plurality of the long-range RF transceiver-controller modules arranged in a distributed, ad hoc networking topography. In this context, all or a sub-set of the long-range VPDMT modules in the system are operatively associated with an actuating means for actuating a device to be controlled by the system and can optionally be further operatively associated with one or more sensors. The wireless control system may be controlled by one or more central computing devices, which interface with the network through a VPDMT module incorporated into, for example, a modem or other such communication devices, which can be integrated or external.

A long-range RF transceiver-controller VPDMT module in one embodiment of the invention is illustrated in FIG. 2. The VPDMT module 100 comprises a RF transceiver 104, an antenna 102 and optional second antenna 102-1, and a controller 106, the latter illustratively comprising dual modulation supervisory control system 118, and operative access for flash memory 136 and a power source control 108 operatively coupled to a rechargeable or non-rechargeable energy storage device and a power source such as a turbine 112-1, solar cell 112-2, or battery pack 112-3. The energy storage device may comprise a battery system, capacitor system or other system, for example. The RF transceiver 104 may be configured to transmit and receive RF signals in one or more ISM frequency bands such as 433, 868, 915 MHz, and 2.4 and 5.8 GHz, for example.

The controller 106 may be operatively coupled to the serial flash memory 136 and may also include supervisory modulation control circuitry 118. The supervisory circuitry may provide a watchdog function configured to reset the controller 106 upon occurrence of a predetermined event. The controller may interface with, control and/or gather and processes data from the associated actuating means and one or more sensor(s).

In one embodiment of the invention, the controller 106 comprises in addition to memory 136, the following programming modules: secure communications modules for authenticating, transferring, identifying and routing signals; self-protection health check modules for synchronising routings and periodically checking for operational requirements, battery power, network configuration node location and the like; power management modules for controlling power requirements for various components, and application processing module 114 for example for controlling activation of the solenoids 115-1 to 115-4.

In one embodiment, the VPDMT module 100 is configured for operative association with solenoid controls 114 and solenoids 115-1 to 115-4 coupled to actuating means for actuating one, or a plurality of devices, to be controlled by the system and optionally one or more sensors (or monitors) 120, 121, for example, for sensing and/or monitoring environmental conditions such as rainfall or water flow, or other system conditions and/or motion. In one embodiment, the actuating means controls between one and about 4 to 8 solenoids, for example, between one and about 4 to 6 solenoids, 115-1 to 115-4. The actuating means interfaces with the controller 106 through a hard-wired series of connections, including solenoid controls 114 and associated solenoids 115-1 to 115-4. The solenoids 115-1 to 115-4 can be used to actuate various electrical or mechanical devices such as indicators, valves, switches, motors, and the like. Feedback from the actuation means can also be provided to monitor operation, for example at 141-1 and 141-2.

In some embodiments, the VPDMT module 100 may be optionally configured for operative association with one or more sensors. For example, one or more temperature sensors 138 and 140 for sensing the temperature of environmental or internal elements such as air, soil or VPDMT module components to detect overheating of the VPDMT module, or to allow for scheduling of a sleep mode, as discussed below; a power voltage monitoring device 142 for monitoring the status of the power source in real time and to provide proactive failure warning, and/or an operational sensor 144 for monitoring one or more functions of the device actuated by actuating means, in turn influenced by solenoid controls 114.

Other examples of sensors that can be associated with the VPDMT module may include, but are not limited to, light sensors (such as sensors to monitor ambient light levels), motion sensors, moisture sensors, humidity sensors, and the like.

The one or more sensors and monitors may be operatively connected to the VPDMT module via a wireless or a hard-wired connection. The sensors/monitors may interface with the controller 106, which can be programmed to collect data from and/or send commands to the sensors and monitors.

In one example, the long-range VPDMT RF transceiver-controller module 100 can be further configured for operative association with more than one actuating means, which may also be controlled by the controller 106. The controller 106 may control the actuating means directly and/or control the power source for the actuating means, depending on the embodiment.

The VPDMT module can further optionally comprise, or be operatively associated with a power generator 112-1, 112-1, and/or 112-3 for recharging a power source via power source control 108, which in turn can be controlled via the controller 106. The power generator may comprise a battery 112-3, a solar power source 112-2, an oscillator power source or a turbine 112-1, for example. In one embodiment of the invention, the power source control 108 includes a battery or other energy storage device. In another embodiment, the main energy source may be photovoltaic. In another embodiment, the main power source may be a water turbine which may be attached to the main line of the irrigation system or directly to the rotor, for example.

In operation, the RF antenna 102 or dual antenna 102 and 102-1 intercepts, or receives, transmitted signals from another VPDMT module, a central controller, a mobile unit or a repeater, and retransmits at least a portion of the signals, as necessary, to one or more other VPDMT modules or repeaters. The antenna 102 is coupled with an RF output (O/P) switch 202, RF transmission (TX) filter 201, and power amplifier 200 to the RF transceiver 104 of the dual antenna 102 and 102-1 which are coupled with an RF O/P switch 202, RF TX Filter 201 power amplifier 200, RF input (I/P) switch 203 and RF receiver (RX) filter 204 to the RF transceiver 104 which employs conventional demodulation techniques for receiving the RF signals. In general, the RF signals are used to convey data (such as operating data and/or sensor data) and/or commands. In accordance with some embodiments of the invention, the antenna 102 or dual antenna 102 and 102-1 and RF transceiver 104 operate on one or more of the 433, 868, 915 MHz, and 2.4 and 5.8 GHz ISM frequency bands. The RF transceiver 104 is coupled to the controller 106 and is responsive to commands from the controller 106.

When the RF transceiver 104 receives an appropriate command from the controller 106, the RF transceiver 104 sends a signal via the antenna 102 or dual antenna 102 and 102-1 to one or more other long-range RF transceiver-controller modules. In this manner, the antenna 102 or dual antenna 102 and 102-1 and the RF transceiver 104 enable the VPDMT module 100 to operate in a RF operating mode. In one embodiment of the invention, the antenna 102 and RF transceiver 104 are configured to operate on multiple, selectable frequencies to help reduce traffic within the network on any one frequency. In one embodiment, the two antennas can alternatively be operated simultaneously as a phased array, which would require the RF O/P switch 202 to include a phase shifting device.

In one embodiment, the long-range RE VPDMT module 100 includes a single or dual antenna and a VPDMT transceiver for receiving and transmitting signals from another long-range VPDMT module and second single or dual antenna and a VPDMT transceiver for receiving and transmitting signals to one or more other long-range VPDMT modules. A module 100 according to this embodiment can serve to relay information over long distances, for example along a long-range or mid-range network backbone, thereby extending the range of the network. The module can optionally be equipped with additional sources of power, to compensate for possibly comparatively large power requirements.

In one embodiment, the dual antenna 102 and 102-1 can be operated as a phased antenna array, such that the interference pattern produced by the phase-shifted replicas of the signal transmitted by each component of the phased array constructively and destructively interfere to produce a desired radiation pattern as would be readily understood by a worker skilled in the art, for example using smart antennas, beamforming, adaptive beamforming, MIMO, and the like. A phased array can be used to increase signal strength in certain directions, for example, in the direction of another VPDMT with which communication is intended. A phased array can also be used to decrease signal strength in certain other directions, for example to reduce interference with VPDMTs with which communication is not intended. Phased arrays can be operable for both transmitting and receiving antennas, as the radiation pattern associated with a phased array is applicable for describing both transmission and reception signal strengths as a function of direction.

Coupled to the RF transceiver 104 is the controller 106, which utilises dual modulation signal-processing techniques for processing received signals and for sending commands, as necessary, to one or more of the VPDMT RF transceiver 104, the solenoid control actuating means 114, and/or any associated monitors or sensors. The controller 106 thus controls the operation of the VPDMT RF transceiver 104 and the solenoid control actuating means 114, and optionally associated sensors and monitors. The controller 106 generally includes a data interface for processing received signals and for sending commands. If the received signal is an analogue signal, the data interface may include an analogue-to-digital converter to digitise the signals. The controller 106 can also determine whether an incoming signal is addressed to the VPDMT module 100 and directs the RF transceiver to re-transmit the signal if it is addressed to another VPDMT module. An address header is typically included in the information encoded in the transmitted signal for this purpose.

Controller 106 may comprise a dual modulation supervisory control system 118 and be operatively coupled to the memory 136. The dual modulation supervisory control system 118 may be configured to regulate the power consumption of the VPDMT module, such that it operates within predetermined acceptable limits, and to interface with the associated VPDMT, sensors and/or monitors when present, for example, to establish reporting parameters based on predetermined ranges for each sensor/monitor. The dual modulation supervisory control system 118 may comprise hardware, firmware and/or software or solely hardware and be embedded in long-range RF transceiver-controller module 100 and can be programmed remotely, or can be a downloadable application. Configuration software and/or firmware may be stored in memory such as RAM, NVRAM, ROM, EEPROM, or other stores as would be readily understood by a worker skilled in the art. It will be appreciated that other programming methods can be utilised for programming the dual modulation supervisory control system 118 into the VPDMT module 100. It will be further appreciated by one of ordinary skill in the art that the dual modulation supervisory control system 118 can be hardware circuitry within the VPDMT module 100, for example portions of the control system can reside in an ASIC, FPGA, a collection of digital or analog hardware components, or other electronic device as would be understood by a worker skilled in the art.

In one embodiment, the dual modulation supervisory control system may be configured to select a modulation and transmission power so as to establish one or more desired communication links in an energy-efficient manner. For example, if a low-power FSK modulation mode is sufficiently operable to transmit and receive data, this mode will be selected. Otherwise, if FSK does not provide the desired connectivity, the dual modulation supervisory control system can be configured to switch to a FHSS or DSSS modulation mode having increased transmission power. In addition, the transmission power can be adjusted. For example, for FHSS, the transmission power can be adjustable between about 250 mW and about 1 W, so that output power can be adjusted as required to achieve a sufficient quality communication link while conserving power and reducing interference with other radio devices, according to FCC regulations and network operation parameters. The transmission power and modulation mode can be adjusted by a program executed by the dual modulation supervisory control system 118 and stored in the memory 136. Similarly, output power of the FSK modulation mode can be adjusted, for example between 0 and 15 dBm in accordance with FCC regulations.

The memory 136 can be provided in one of a variety of standard formats known in the art, for example, random access memory (RAM), non-volatile random access memory (NVRAM), read-only memory (ROM), electrically erasable programmable read-only memory (EEPROM), flash memory and the like. The memory 136 can include various memory locations, for example, for the storage of one or more received or transmitted signals, one or more software applications, one or more location data, and the like. Memory 136 can also function to maintain records of transmission and acknowledgment packets in order to avoid duplicate transmissions being broadcast, as well to hold data collected from any associated sensor(s) so that it can be broadcast at later time, for example, when system communications are low. It will be appreciated by those of ordinary skill in the art that the memory 136 may be integrated in the VPDMT module 100, or it may be at least partially contained within an external memory such as a memory storage device, for example.

The VPDMT module may further be configured to provide a watch dog function, for example, a self-diagnostic capability which may be provided using a self-diagnostic module. The self-diagnostic module may be implemented in hardware, firmware and/or software, or solely in hardware. For example, the self-diagnostic module may comprise one or more methods for reconfiguring software; hardware and RF identification; time synchronization; setting, confirming, and/or changing an active schedule for a device associated with the VPDMT module, for example, an irrigation schedule for a water management device; system check operations; reporting on system activation for a set period of time, for example, the past 24 hours; communication routing checks and analysis, and/or frequency availability and congestion checks.

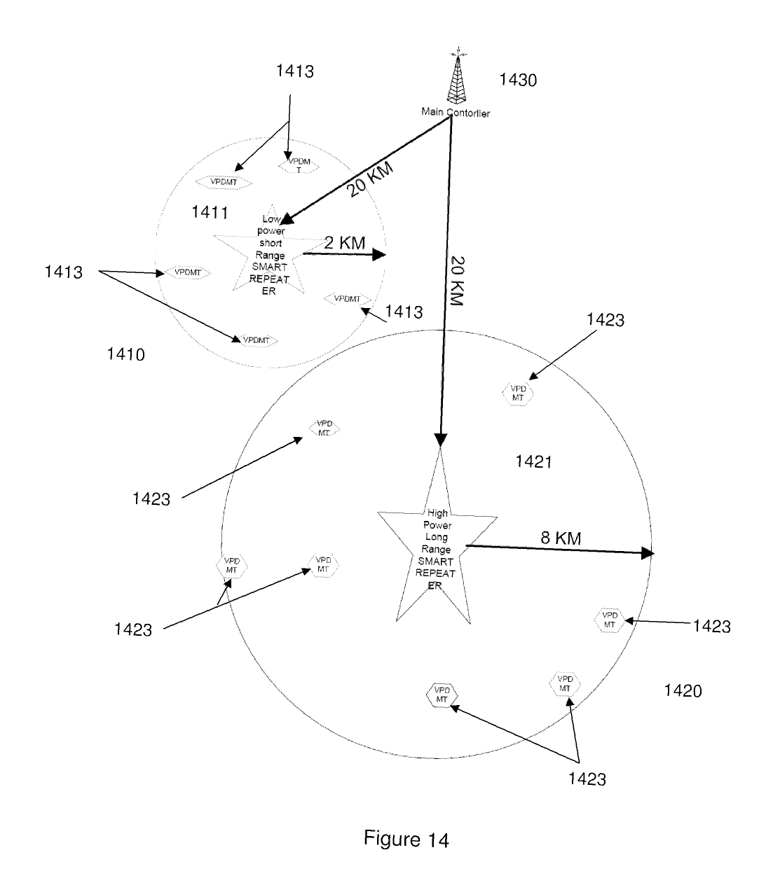

A VPDMT module according to some embodiments of the present invention may be configured to operate in a star network with a master/slave hierarchy. For example, FIG. 14 illustrates star networks 1410 and 1420 including smart repeaters 1411 and 1421 acting as local masters for slave VPDMT modules 1413 and 1423, respectively. In this embodiment, a two-way communication link may be established between the smart repeater and each VPDMT within a predetermined communication radius. In a star network, a VPDMT module may not directly exchange signals with another VPDMT, but indirectly by relaying signals and thereby routing messages carried by the signals through a smart repeater, for example. The smart repeater can further route messages between the main controller 1430 and individually addressable VPDMTs, or alternatively broadcast or multicast messages to multiple VPDMTs simultaneously.

In one embodiment, the controller 106 of the VPDMT module may be programmed to generate and receive two types of signals, a data signal that contains control or sensor data, and an acknowledgment signal. An acknowledgment signal can be sent out each time a signal is received by the VPDMT module, for example. Both types of signals include, in addition to an address and an error correction code which can be used for in a cyclic redundancy check (CRC), for example, between 0 to about 25 bytes of data and about one byte of control information consisting of a sequence number and a signal type. An acknowledgment signal contains 0 bytes of data. The sequence number can contain a counter, such as a four bit counter, that is incremented after each signal is sent and can be used by the receiver to record which packets it has received. To verify complete data transfer, packet flow control schemes, for example TCP/IP or another scheme, as would be understood by a worker skilled in the art, may be used.

As depicted in FIG. 2, the long-range VPDMT RF transceiver-controller module can further be equipped with power management capability 116 to reduce overall power consumption when various portions of transceiver's circuits are not required. For example, the actuating means 114 can be put in a sleep mode when they are not used for predetermined periods of time. As a separate example, the receiving portion of the RF transceiver 104 may be powered down when there is no incoming traffic and may be configured to use an automatic (timeout) wake-up protocol, or an interrupt driven wake-up protocol from the controller 106. For example, the receiver can be operatively associated with a timer that is set to wake up the receiving portion periodically to listen for network activity.

As noted above, the VPDMT module may be configured to transmit and receive RF signals in one or more ISM frequency bands such as at 433, 868 and 915 MHz. In one embodiment of the invention, the VPDMT module is configured to transmit and receive RF signals in one or more of the 433, 868 and 915 MHz ISM frequency bands meeting the European (ETSI, EN300-220-1 and EN301 439-3) or the North America (FCC part 15.247 and 15.249) regulatory standards. In a further embodiment of the invention, the VPDMT module is configured to transmit and receive RF signals in the 868 and/or 915 MHz ISM frequency bands. In an alternative embodiment of the invention, the VPDMT module is also configured to transmit and receive RF signals in the 2.4 or 5.8 GHz ISM frequency band.

A number of suitable RF transceivers that operate in the 433, 868 and 915 MHz ISM frequency ranges are known in the art and are commercially available, for example, from Aerocomm (Kennexa, Kans.), Semtech (Camarillo, Calif.), Amtel (California) and Nordic VSLI ASA (Norway) which may be used in VPDMT modules according to embodiments of the present invention.

In one embodiment, the VPDMT module is configured with a sleep/wake-up mode that allows for relaxed network synchronization so the module does not have to remain ON and synchronized for extended periods of time. For example, by dynamically or statically determining an efficient schedule of sleep/wake modes, synchronization times can be specified for a given communication radius to allow reception and/or transmission of high or low power burst commands which may be used in activating and/or scheduling wake-up times for mass communication. Synchronization times may range over several orders of magnitude, for example milliseconds to tens of seconds.

### Power Conservation

Power conservation may be an important aspect in wireless control systems for a number of reasons, for example when operating nodes off line, on battery power, water turbine or solar power. As described, VPDMT modules that provide power management capabilities, for example, may reduce overall power consumption wherein various portions of transceiver circuits may be selectively deactivated or shifted into a sleep mode when they are not in use. The invention contemplates various power conservation options for the wireless control system. For example, all the VPDMT modules can be powered down at once when there is no activity in the network, or when the control system is not required for a certain period of time. According to another embodiment, at least some VPDMT modules within the network may be activated or deactivated according to a predetermined schedule. Other, for example predetermined, VPDMT modules may remain ON in order to be able to receive and transmit signals all the time.

Another option includes the powering down of certain subsets of VPDMT modules within the system, which could also be on a cyclic schedule such that each VPDMT module in the system is powered down at some point in the cycle. In the former instance when all VPDMT modules are powered down at once, when signals are to be transmitted, a synchronisation event can be used to synchronously bring all VPDMT modules out of a powered down state and restore end-to-end network connectivity. The synchronisation event can be a command generated by the central controller 200, by an auxiliary controller, such as a hand-held device comprising a mobile VPDMT module 450, or by the individual controller 106 within the VPDMT module. The event can be time based, for example, a period of time determined by an operator or set by a pre-determined schedule that can be programmed into the central controller 200, auxiliary controller or the controller 106 of the VPDMT module. Alternatively, the controller 106 can be programmed to wake up the RF receiver 104 periodically to listen for a synchronisation signal generated by the central controller 200, or auxiliary controller. After a pre-defined period or the receipt of a power-down signal, the VPDMT modules can power down.

To assist in signal routing, operating mode selection, power saving and also to allow the control system to recognise the location of individual VPDMT modules it may be beneficial to be able to determine the relative geographical position of each VPDMT module. Accordingly, in one embodiment of the invention, the wireless control system may be configured to allow determination of the relative position of VPDMT modules by measurement of the RF power received and transmitted from each VPDMT module for one or more of the operating modes.

As RF power decreases with distance from the transmitting source in correspondence with predetermined absorption and dissipation characteristics of ambient terrain, RF power of a propagating signal may be used to determine a reliable communication range using predetermined formula and the characteristics of the ambient terrain. By triangulating the measured RF power from multiple VPDMT modules and/or handheld nodes, the position of an individual VPDMT module or handheld node can be determined. For example, a VPDMT module may transmit a signal that indicates the measured transmit power. Each VPDMT module that receives this measurement signal can measure the transmit power and report this back to the transmitter VPDMT module. The transmitter VPDMT module processes the received information and calculates the relative position of each VPDMT module in the network from which it has received information. The processed data provides the relative positions of the modules, which can be converted into physical positions based on the known physical positions of at least two VPDMT modules in the network, which are used to orient and scale the relative positions.

### Scheduled Transmissions

The wireless control system can further be configured to implement a scheduled transmission protocol in order to conserve power further. A non-limiting example of a scheduled transmission protocol is as follows: the VPDMT module 100 is allocated a transmission slot by the central controller 200 by way of a signal sent from the central controller 200 that contains the timing information for the next scheduled signal transmission. After the VPDMT module 100 receives and acknowledges the signal containing the timing information, the VPDMT module 100 powers down until the next scheduled time slot.

The central controller 200 and the VPDMT module 100 can also negotiate the next scheduled time slot, for example, the central controller 200 can publish its available timeslots to the VPDMT module 100. The VPDMT module 100 processes the information and compares the information with its own available timeslots, selects a desired timeslot and sends an acknowledgment signal to the central controller 200 to confirm the selected timeslot. Thus, the central controller 200 and the VPDMT module 100 can schedule a time slot on an ad hoc basis, depending on the response time requirements of the application. During the communication between the central controller 200 and the VPDMT module 100, the start time of the next timeslot is determined so that the VPDMT module 100 can power down until the next scheduled transmission time. To further reduce power requirement, the VPDMT module 100 is capable of maintaining a sufficiently accurate time base to ensure that transmissions can be synchronised. Synchronisation of all VPDMT modules in the network may be facilitated by periodically broadcasting a synchronisation signal from the central controller 200 or the auxiliary controller throughout the system at a time when all VPDMT modules are scheduled to be listening, thus allowing all VPDMT modules in the system to synchronise their time bases. To ensure all VPDMT modules in the network receive the synchronisation signal, nodes that receive the synchronisation signal can re-transmit the signal for VPDMT modules that are not in range of the central controller 200. Such synchronisation signals can optionally be acknowledged by the VPDMT modules that receive them.

Another example of a scheduled transmission protocol is as follows: the VPDMT module 100 schedules a transmission slot. The other VPDMT modules, central controller, auxiliary controller and/or the sensor(s) associated with the VPDMT module send a signal to the VPDMT module at the scheduled time and the VPDMT module receiver responds to the signal with an acknowledgment signal, which terminates the transmission time slot. The acknowledgment signal contains the timing information for the senders next scheduled signal transmission and the next frequency of transmission (if frequency hopping is used). If the VPDMT module wants to communicate with another node in the system, such as another VPDMT module, the central controller, or the auxiliary controller, the VPDMT module sends a signal to the node after receiving a signal from the node, but before sending the acknowledgment signal that terminates the time slot. In this instance also, the VPDMT module can sleep until the next scheduled transmission slot, thus saving power.

### Antenna System

An antenna system may be configured to provide one or more antennas with predetermined ground propagation characteristics. An antenna system may be characterized by directivity, gain, polarization, transmission pattern and attenuation, for example. The antenna can optionally be operatively coupled to the transceiver electronics through an impedance matching circuit to improve performance. The antenna can also optionally include two or more active elements in a phased antenna array configured to maximize the radiation pattern in a desired direction. Features such as beamforming, beamsteering, and MIMO communication, as would be understood by a worker skilled in the art, can also be supported by the phased antenna array. The antenna can be designed for installation at or below ground level while retaining sufficient operating characteristics.

In one embodiment of the invention, antenna type and orientation may determine the communication range. As noted above, various types of antenna are suitable for use with the VPDMT modules comprised by the control system and the type of antenna may vary depending on the function of the particular VPDMT module. The antenna for the RF transceiver or VPDMT module associated with the central controller may thus differ from the antenna used for an in-ground VPDMT module, or a VPDMT module located in an occluded position, which may also vary from the antenna selected for use in a repeater node.

Accordingly, the invention provides for the use of multiple antenna designs in the control system. For example, a bow-tie antenna can be used for long-range transmission capability, for instance a range from about 3 km to about 20 km. Similarly, a full wave antenna can be used for local area network devices having shorter transmission range requirements, for example a hand held supervisory controller or device.

As is known in the art an antenna can be selected based on its polarization, i.e. the direction of the electromagnetic waves (described in terms of the direction of the electric field, knowing that the magnetic field is perpendicular to the electric field). Horizontal polarization occurs where the electric field radiates on the x-axis, i.e. substantially parallel to the earth's surface, whereas vertical polarization occurs where the electric field radiates along the y-axis, i.e. substantially perpendicular to the earth's surface. In general, horizontal polarization is less affected by vertical reflections such as a building, whereas vertical polarization is less affected by horizontal reflections such as water or land reflections.

A variety of antennas may be used in nodes of a wireless control system according to embodiments of the present invention. Antennas that are adequately designed, for example, for proximate ground level operation in predetermined types of terrain, may provide good communication range and gain at ground level and therefore good system performance. Different types of antennas may be used in different nodes depending on the application of the system.

An antenna according to an embodiment of the present invention may be configured to provide a predetermined radiation pattern, directivity, gain and/or polarization. The antenna can be a directional antenna, for example. The antenna can be integrally included in the VPDMT module, for example, as an internal printed board antenna, or it can be external and configured for operative interconnection with the VPDMT module. The antenna may be configured to provide predetermined transmission and radiation characteristics depending on direction, distance and/or linear, elliptical or circular polarization.

In one embodiment the antenna is a full wave antenna, or an array of full wave antennas. A full wave antenna is dimensioned such that the effective length of the antenna is substantially equal to one full wavelength of electromagnetic radiation at a predetermined operating frequency. The effective length may correspond with the physical antenna length, or an equivalent electrical length due to top loading or bending of the antenna, for example. The effective length of the antenna may correspond with the order of magnitude of the wavelength λ of the electromagnetic radiation which can be determined by its frequency f using c=f*λ, where c represents the speed of light in the transmission medium as would be readily understood by a worker skilled in the art.

In one embodiment, in which the VPDMT module is intended for use proximate above or below ground level, the antenna may be integrated into the VPDMT module. In a further embodiment, the antenna for in-ground use may be printed onto a circuit board and may be configured to emit electromagnetic radiation characterized by a predetermined polarization, for example, linear or elliptical polarization. The antenna may be disposed and oriented to emit vertically or horizontally polarized radiation, for example. According to an embodiment of the present invention, the antenna can be defined by conductive traces on one or more layers of a printed circuit board, or by apertures in a conducting plane on a printed circuit board or other conducting layer, as would be understood by a worker skilled in the art. A printed circuit board antenna can be configured to resonate preferentially with electromagnetic radiation in predetermined frequency ranges, in predetermined directions, and having predetermined polarization, these characteristics being related to the size, shape, orientation, and electrical connections of the antenna, and also being affected by the number and configuration (size, phase, distance, orientation, etc.) of active antennas, and the number and configuration of passive electromagnetic elements such as reflectors, directors, counterpoises and ground planes. The antenna may be disposed along with components of the VPDMT module on a single board substrate.

In one embodiment, in which the VPDMT module is intended for ground level or below ground level use, the antennas may be installed on devices at or below ground level, for example irrigation system valve boxes or valve in head rotors. Consequently, such antennas are located near or below ground level and are required to have a low profile. For example, antennas constructed from flat, horizontal components can be constructed having a sufficiently low profile.

In another embodiment, in which the VPDMT module is intended for above ground use, the antenna may be a vertically or horizontally polarised antenna. Other polarizations are possible, for example circular or elliptical polarizations. For above ground use, the antenna or array of antennas can have omni-directional, bidirectional or unidirectional radiation patterns. In one embodiment, the antenna for above ground use is mounted externally to the VPDMT module. For example, the antenna can be mounted on a wall, mast, tower, tree or other device such as can enable increased line-of-sight antenna range. The antenna can be tilted or directed to capitalize on reflections, ground propagation, or other effects to increase communication effectiveness, as would be understood by a worker skilled in the art.

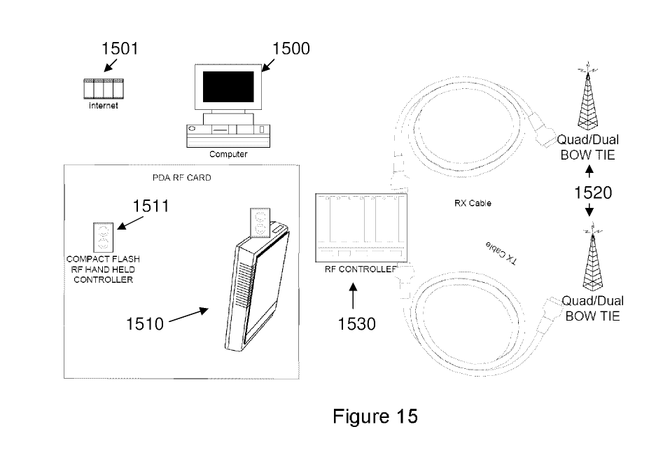

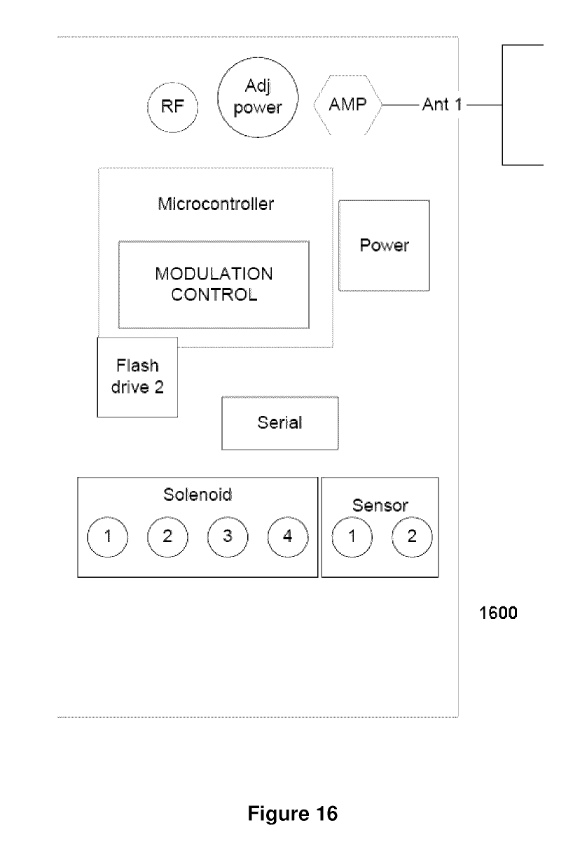

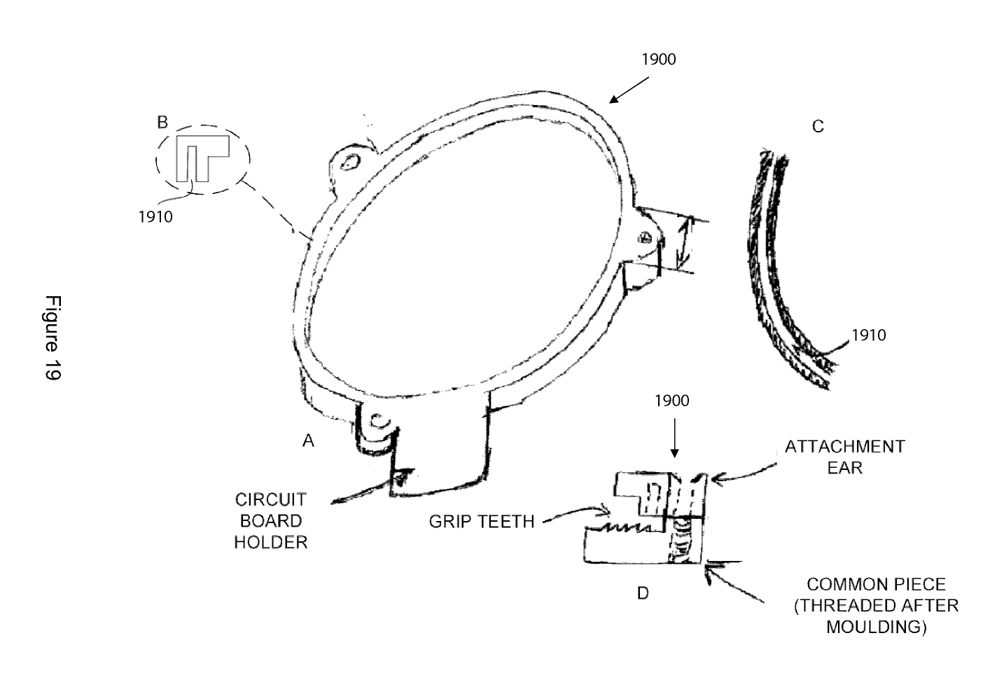

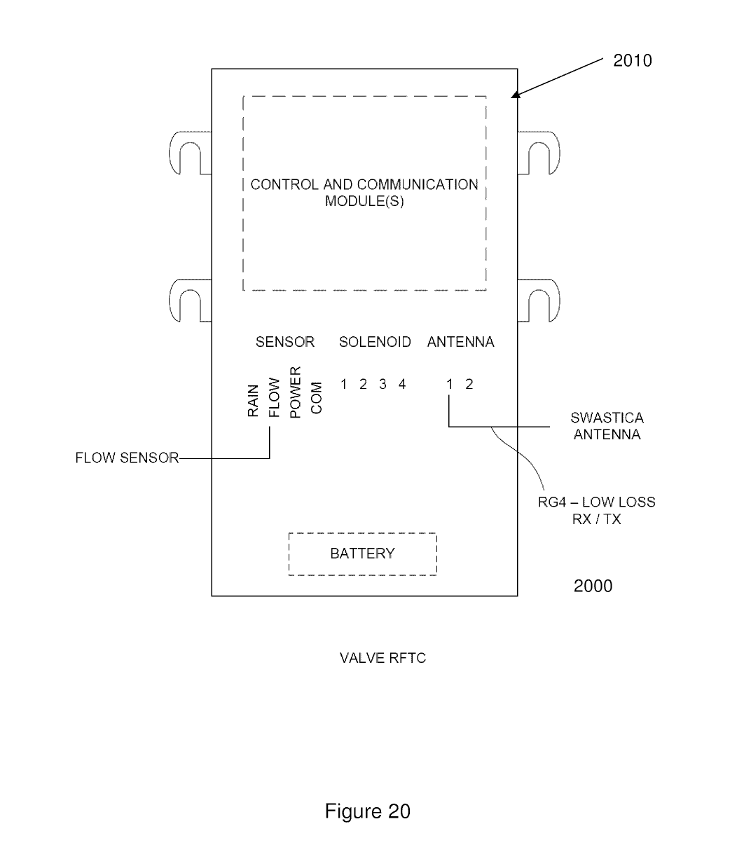

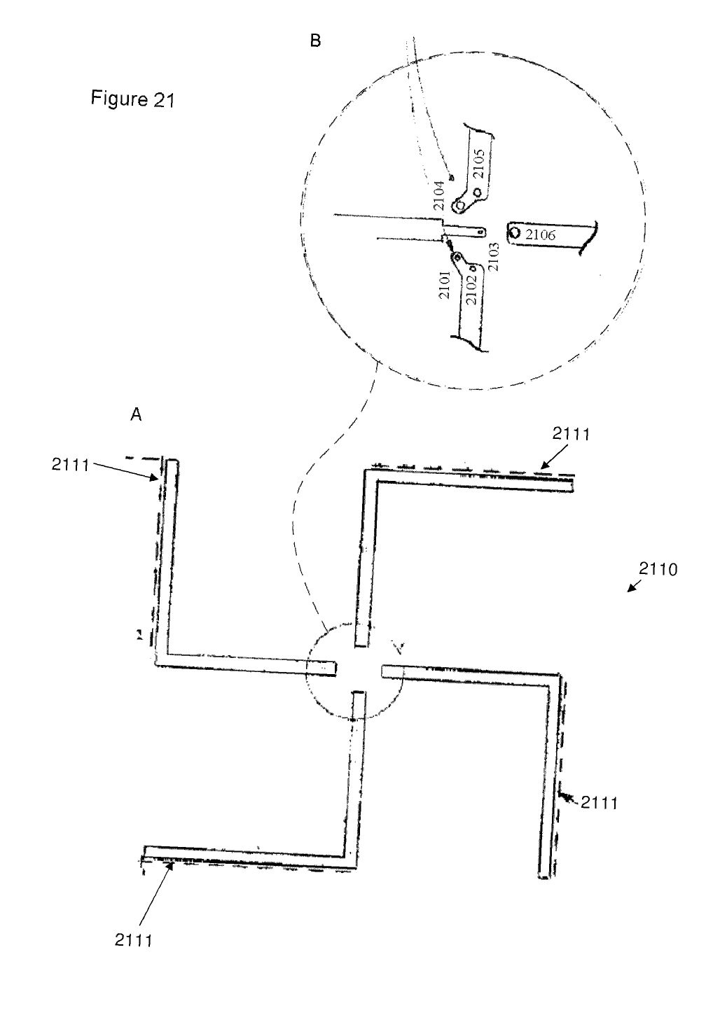

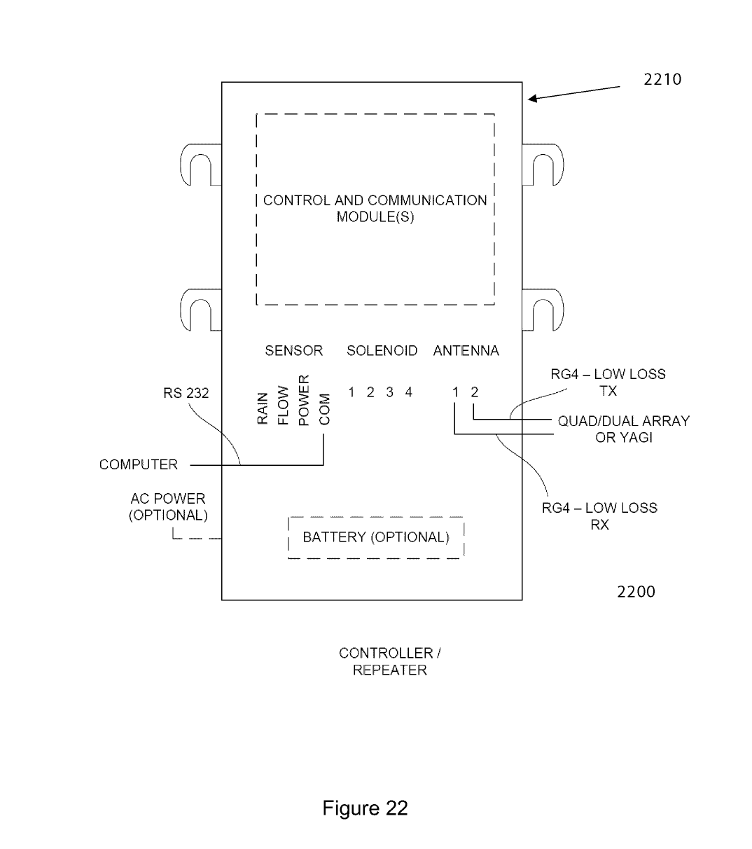

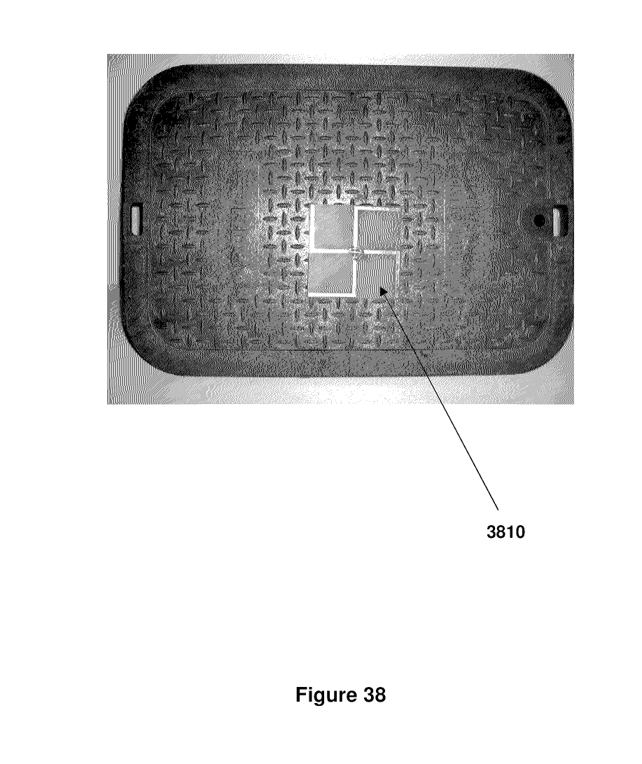

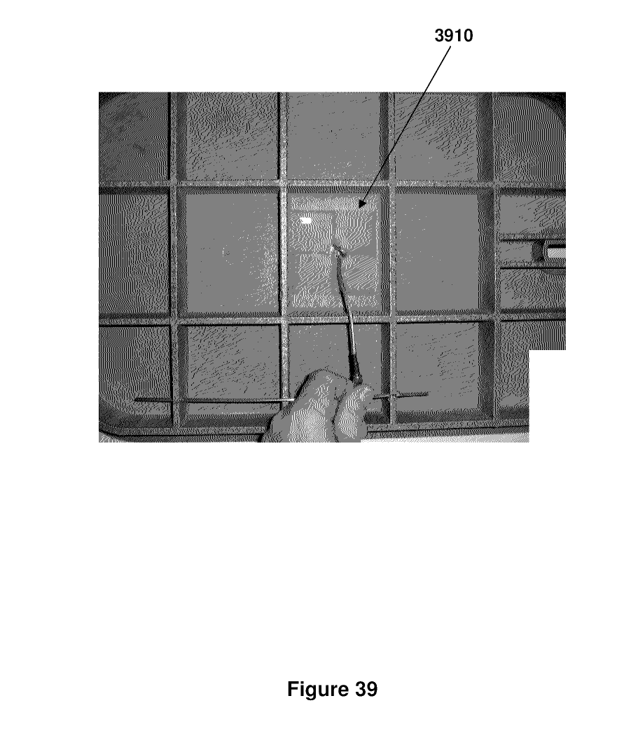

As described below, different antennas may be employed in different nodes of the wireless control system. For example, one or more quad/dual array, Yagi antennas, bow-tie antennas, U-shape, L-shape, Alford, round loop, short cross, X-dipole, radome or other antennas may be used in combination with, for example, the controller of FIG. 15, FIG. 16 or the repeater of FIG. 22. Asymmetrically top-loaded crossed-dipole pair antennas such as the swastika antenna 2110 illustrated in FIG. 21 may be used in combination with a VPDMT module as illustrated in FIG. 20, for example. FIG. 38 illustrates a swastika antenna 3810 disposed on the top side of a sprinkler valve box cover according to an embodiment of the present invention. FIG. 39 illustrates a swastika antenna 3910 disposed on the bottom side of a sprinkler valve box cover according to an embodiment of the present invention.

FIG. 19A illustrates a top plan view of a representation of a sprinkler ring and antenna assembly 1900 for attachment to a sprinkler head according to an embodiment of the present invention. FIG. 19B illustrates a cross sectional view of the assembly of FIG. 19A. FIG. 19C illustrates a partial bottom plan view of the assembly of FIG. 19A. FIG. 19D illustrates a cross sectional view of the assembly of FIG. 19A mounted in accordance with an embodiment of the present invention.

A VPDMT may be used in combination with one or more of a number of antennas. It is noted that, depending on the embodiment, antennas other than the ones noted above may be used in the respective system components. It is further noted that, depending on the embodiment, more than one antenna may be employed per node, and a node may include different types of antennas.

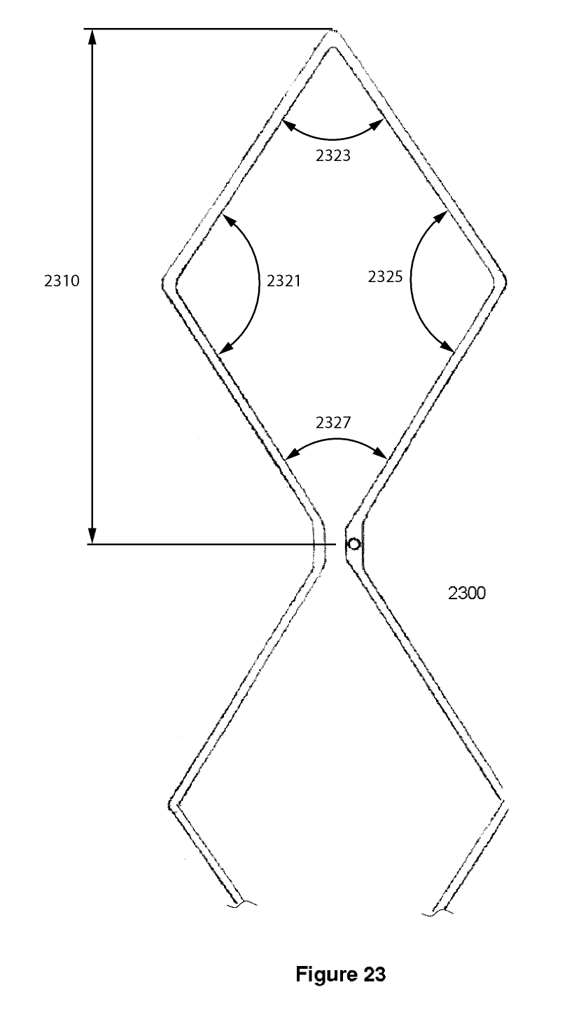

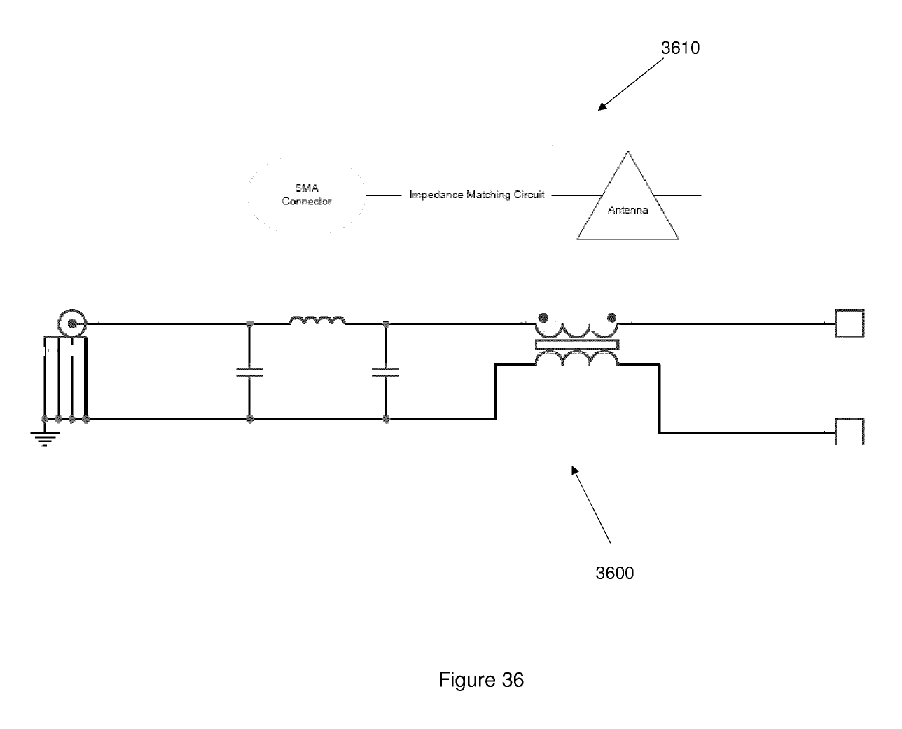

In one embodiment, in which the VPDMT module is intended for use in the control of an irrigation system, a loop antenna or adjustable loop antenna may be mounted to a rotor or sprinkler in an irrigation system. For example, an antenna may be disposed, if provided, in a groove surrounding a central aperture in a top surface of a rotor as illustrated in FIG. 25. According to other embodiments, a housing containing a loop antenna may be affixed to the outside of a rotor or disposed within a rotor head as depicted in FIGS. 26, 27 and 28, for example. The antenna may be moulded into the rotor cover, or provided on the upper or lower surface of a cover or lid. Providing an antenna housing that can be readily attached and/or detached facilitates improving or retrofitting of, for example, existing irrigation. Using a loop antenna enables other functionality of the rotor, such as space for a pop-up sprinkler head, to remain unaffected while retaining the desirable symmetry of the rotor. As is known in the art, a loop antenna comprises a single conductor shaped in one or more circular, square, triangular, elliptical or other shaped coils. The two ends of the conductor are typically located in close proximity and provide the feedpoint for the antenna. The feedpoint can be operatively coupled to a transceiver or power amplifier through an impedance matching circuit, as would be understood by a worker skilled in the art. An impedance matching circuit according to an embodiment of the present invention is illustrated in FIG. 36.

A horizontally mounted loop antenna typically results in a substantially horizontal polarization of electromagnetic radiation and a radiation pattern that is substantially symmetrical in two dimensions corresponding to the plane of the loop which may be useful for wireless irrigation systems applications, for example.

In one embodiment, the loop antenna has a circumference substantially equal to an integer multiple of a half wavelength at a predetermined center operating radio frequency. For example, a loop antenna can have a circumference equal to one wavelength of a predetermined operating frequency. For example, at a center operating frequency of 915 MHz, the circumference of a loop antenna having a single wound circular coil may be about 11.5 inches. The geometry of such a loop antenna may resemble the greek letter Ω, for example, wherein the bottom opening is the antenna feedpoint, and the bottom horizontal portions are replaced with a connection to a transmission line such as a coaxial transmission line or microstrip or stripline transmission line, the transmission line operatively coupling the antenna to an impedance matching circuit, RF amplifier, RF filter, RF transceiver, or the like as would be understood by a worker skilled in the art.

In one embodiment, since the geometry of rotors for irrigation provided by manufacturers can be variable in size depending on manufacturer and model, an antenna such as a loop antenna can be provided, for example for retrofit to a rotor, which is differently sized than an optimally designed loop antenna. This size variance can facilitate attachment to the rotor, for example by making the antenna large enough to fit on the outer rim thereof, or otherwise accommodate the rotor geometry. This size variance can potentially affect the antenna characteristics, such as frequency and bandwidth responsiveness. In a further embodiment therefore, characteristics of such an antenna can be adjusted for desirable operation, for example by adjusting other physical aspects of the antenna. For example, the bandwidth of an antenna can be adjusted by adjusting the size of the conductors or microstrip conductors thereof, in order to provide an antenna that resonates at the required frequencies. As an example, a 22 gauge wire would have a bandwidth of about 40 MHz while a quarter inch copper strip would have a bandwidth of approximately 100 MHz.

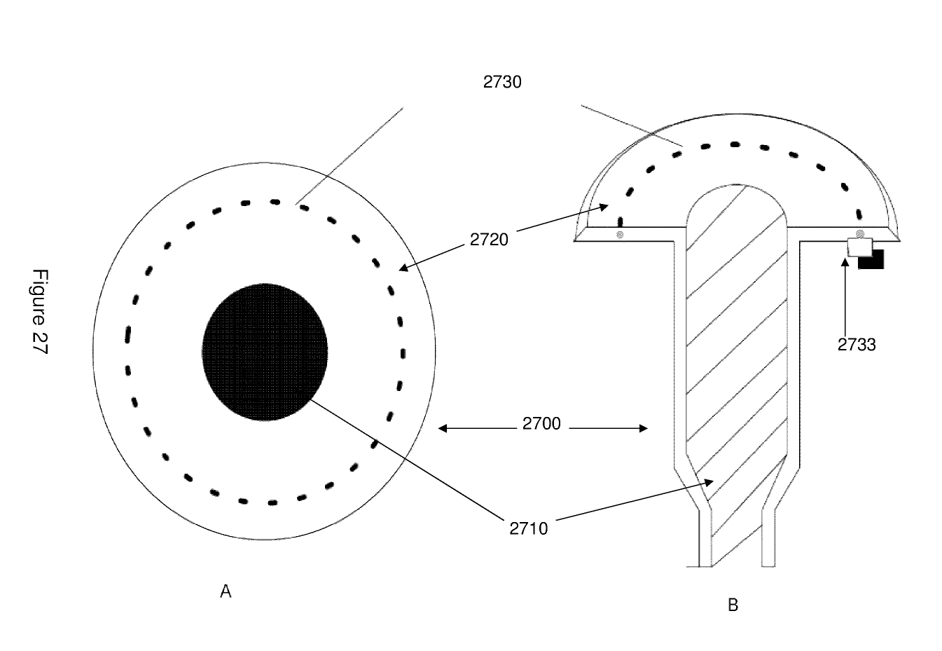

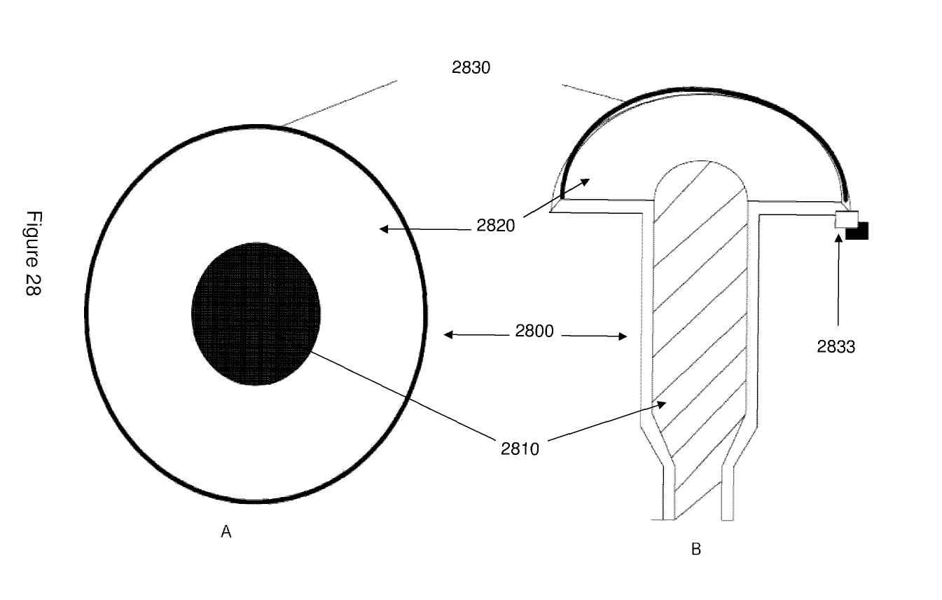

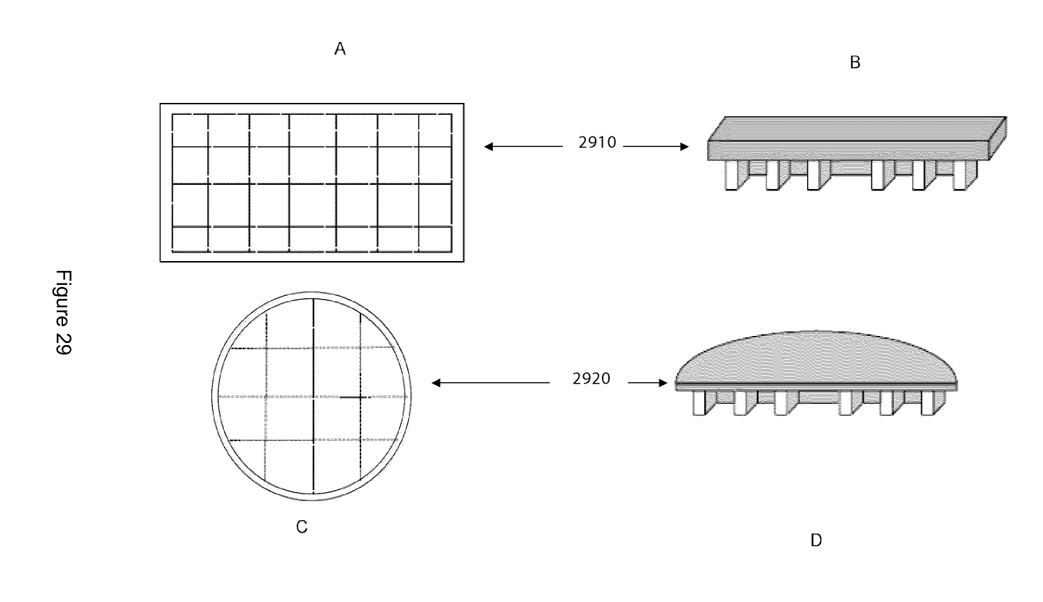

In one embodiment, a crossed dipole antenna or antenna array can be provided, for example mounted on the cover of a ground-level device such as a valve box in an irrigation system. FIGS. 29, 30, 31, 32, 33 and 38 depict different configurations of a microstrip or wire antenna mounted or fastened to the top or bottom side of a flat surface such as a valve lid. The regions defining the antenna can contain a loop, crossed-dipole or other antenna or antenna array. The radiating body of the antenna can be substantially flat conducting bodies such as conductive traces on one or more layers of a printed circuit board, or horizontally oriented wires, to provide a desired low-profile form factor.

FIGS. 21, 38 and 39 illustrate a bent or asymmetrically top-loaded crossed-dipole or swastika antenna 2110 configuration according to one embodiment of the present invention. The bent rectangular arms 2111 illustrated in FIG. 21 can be conductive material, such as printed circuit board traces, surrounded by an insulating or dielectric material. As is known in the art, the arms 2111 can also be nonconductive apertures in a surrounding plane of conducting material, to define an aperture or slot antenna.

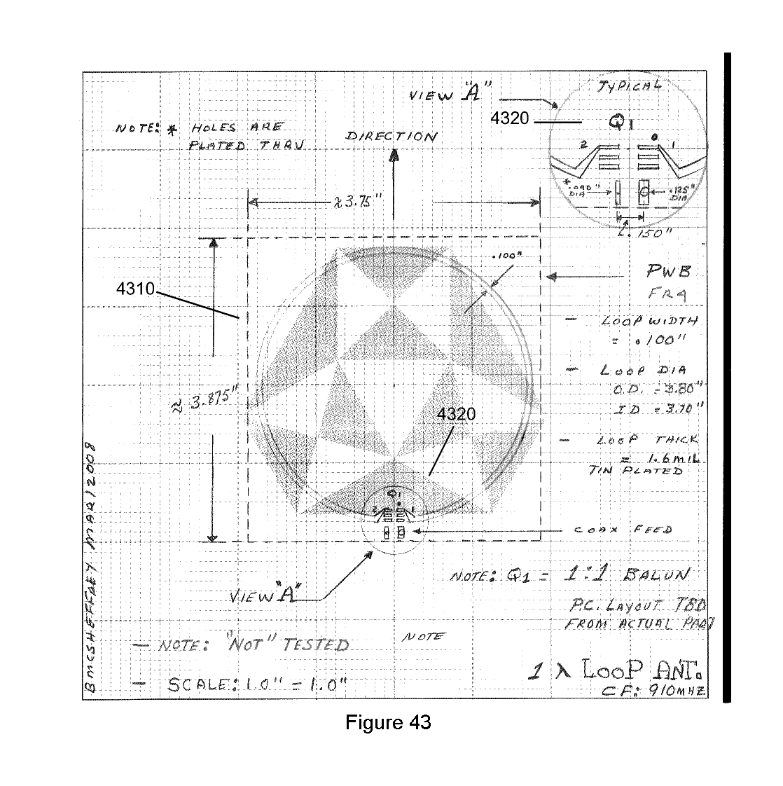

Crossed-dipole antennas may be operated such that the signal at the antennas are phase-shifted by about a quarter period relative to each other, although a worker skilled in the art would understand that adjusting the phase shift can alter the radiation pattern, for example to create a phased antenna array to direct the radiation pattern of the antenna. For example, in transmission, two quarter wave phase-shifted copies of the signal to be transmitted are sent to the two crossed dipoles. For connection to the antenna, the center conductor of a coaxial line can be connected to one arm of a dipole at feed point 2101, while the coaxial shield can be connected to the other arm at feedpoint 2104. A 90 degree phase center conductor may be connected using feedpoint 2103; the corresponding shield may be connected using feedpoint 2106. Feedpoints 2102 and 2105 may be used for optional purposes accordingly. A worker skilled in the art would understand how to connect the antenna in other manners, for example using microstrip or stripline circuit traces. Connections between each crossed dipole and a coaxial, microstrip or stripline transmission line as indicated in FIG. 21. A balun may be used optionally to transform between an unbalanced feed and a balanced feed configuration which may be required by a dipole as would be readily understood by a worker skilled in the art. An example loop antenna 4310 with a balun 4320 is illustrated in FIG. 43.

According to an embodiment of the present invention, each pair of crossed dipoles may be operatively coupled to a transceiver using a coaxial connection and an impedance matching circuit, for example. An example of an impedance matching circuit is illustrated in FIG. 36. The matching circuit may be an integral part of a connector, for example, a sub miniature type A, B, C (SMA, SMB, SMC), or a threaded Neill-Concelman, BNC, QMA or other PCB socket die cast or another connector as would be readily understood by a worker skilled in the art. The impedance matching circuit can substantially improve the power transmitted between the antenna and the radio transceiver, and reduce power loss due to signal reflection, as is known in the art.

In one embodiment, a bow-tie antenna, or phased or stacked array of “bow-tie” antennas can be provided. FIG. 23 depicts an example of a bow-tie antenna 2300 according to an embodiment of the present invention in which the bow-tie can be defined for example by two substantially flat quadrilateral conductive loops joined as illustrated and extending from a central pair of feedpoints. The design depicted in FIG. 23 differs from other bow-tie antenna designs, for example those which are essentially a modified dipole with triangular tapered radiating bodies. The bow-tie antenna of FIG. 23 can also be topologically described as two loop antennas, for example diamond-shaped single-turn loop antennas, which are mirror images of each other and connected at their feedpoints. The bow-tie can also be provided as an aperture antenna, wherein the conductive loops in FIG. 23 are replaced with nonconductive loops in a conducting plane.

The two quadrilateral conductive loops of a bow tie antenna according to some embodiments of the present invention may be different or substantially equal and, if equal, may be disposed in a rotational or mirror symmetrical manner. A quadrilateral conductive loop may have a height 2310, and include angles 2321, 2323, 2325 and 2327. The height 2300 of the loop correlates with the center frequency and to a minor degree with the bandwidth of the antenna, as would be readily understood by a person skilled in the art. Furthermore, the included angles 2321, 2323, 2325 and 2327 may substantially correlate with the bandwidth and radiation pattern as well as gain and directivity of the antenna which may determine achievable communication ranges. Similar considerations apply to other forms of antennas. A bow tie antenna according to an embodiment of the present invention may be configured accordingly. For example, the included angles of the bow tie antenna may be chosen to provide the antenna with a predetermined bandwidth and radiation pattern. According to an embodiment of the present invention, angles 2321 and 2325 may be about 118 degree, angle 2327 may be about 60 degree, and angle 2323 may be about 63 degree. It is furthermore noted that, depending on the embodiment, each quadrilateral conductive loop of a bow tie antenna may be configured to provide same or different angles.

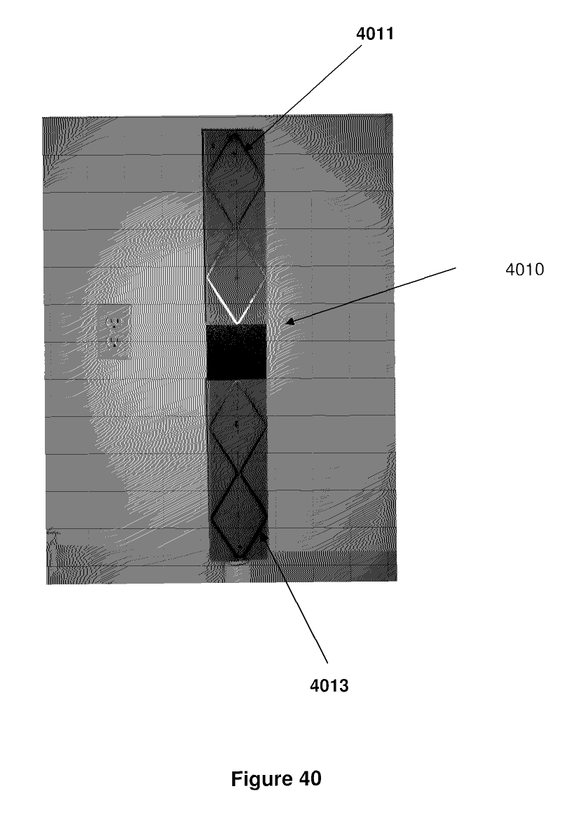

In one embodiment, the bow-tie antenna can be dimensioned as a full-wave antenna, having a long axis dimension substantially equal to the wavelength at a selected center operating frequency (for example 11.75 inches at 915 MHz), and a short axis dimension substantially less than or equal to a quarter of the wavelength at the selected center operating frequency. FIG. 40 illustrates a pair of corresponding bow-tie antennas 4011 and 4013 on a printed circuit board 4010. The bow-tie antennas may be operated as a phased array for directional communication at a range of over 20 km.

In another embodiment, the bow-tie antenna can have a substantially shorter length. For example, a bow-tie antenna having a length of four inches or of one to two inches can be provided which operates with desired performance at frequencies within the ISM bands.

In one embodiment, the bow-tie can be operatively coupled to a transceiver through a transmission line such as a coaxial transmission line, microstrip or stripline transmission line, and through an impedance matching circuit to a radio transceiver or power amplifier, filter, or other related components as would be understood by a worker skilled in the art. The coupling point for example for a direct coaxial cable connection is at the center of the bow-tie, with the coaxial conductor and coaxial shield connected to the feedpoints. Other connections are possible, for example a delay-line balun can be connected to the antenna in a typical manner as understood in the art. The feedpoints for the bow-tie, that is the points which are coupled to a transmission line which operatively couples the antenna to a transceiver, are located at the center of the bow-tie, where the spacing between conductors narrows.

FIG. 34 and FIG. 35 illustrate communication range diagrams 3410, 3420 and 3450 that provide indications of communication ranges achieved using different embodiments of the present invention. For example, in FIG. 34, ranges are compared with ranges achieved using the system described in PCT Application No. WO2007/104152, in which commercially available above-ground antennas and in-ground quarter wave or half wave antennas (e.g. L-shaped, F-shaped, etc.) are used in combination with a FSK modulation and a data link rate of about 0 dBm, or a FSK modulation and a data link rate of about 15 dBm, or a FHSS/DSSS modulation and a data link rate of about 30 dBm.

In each of the three examples of FIG. 34, full wave custom dual bow-tie array above ground antennas and grade level full wave swastika or full loop antennas are considered. As can be observed, when communications are implemented via FSK modulation and at a data link rate of about 0 dBm output power, non-line of sight (NLOS) and line of sight communications with VPDMTs can be implemented within a range of about 500 m and about 1.5 km respectively, and non-line of sight and line of sight communications with repeaters/field controllers can be implemented within a range of about 4 km and about 8 km respectively. When communications are implemented via FSK modulation and a data link rate of about 15 dBm output power, non-line of sight and line of sight communications with VPDMTs can be implemented within a range of about 1 km and about 3 km respectively, and non-line of sight and line of sight communications with repeaters/field controllers can be implemented within a range of about 6 km and about 15 km respectively. When communications are implemented via FHSS/DSSS modulation and a data link rate of about 30 dBm output power, non-line of sight and line of sight communications with VPDMTs can be implemented within a range of about 2 km and about 4 km respectively, and non-line of sight and line of sight communications with repeaters/field controllers can be implemented within a range of about 8 km and about 20 km respectively.

In one embodiment of the invention, horizontally polarized antennas are connected to the repeaters and/or central controller, and antennas with horizontal polarization are used for in-ground VPDMT modules and other VPDMT modules operatively associated with a device to be actuated.

In accordance with one embodiment relating to control systems requiring the use of some in-ground or grade level VPDMT modules, vertically polarised repeater and/or central controller antennas are employed in the system in combination with horizontally oriented VPDMT antennas for the in-ground VPDMT modules. This arrangement of horizontal polarization intended for use in this application differs from the majority of today's currently used vertically-polarized antennas. The use of horizontal polarization can add substantial isolation to the system, for example up to 6 dB of isolation from vertically-polarized radiation. The use of custom designed antenna in a horizontal orientation for the in-ground VPDMT modules may help reduce the effective depth at which the in-ground VPDMT modules need to be placed, which in turn reduces loss of signal due to soil propagation. The potential power loss due to soil propagation would otherwise be up to 20 dBm. In addition, the horizontal orientation of the in-ground antennas can provide a larger target for the transmitted signal.

In various embodiments of the invention in which the control system includes a number of ground-level or in-ground VPDMT modules, repeater node antennas can be configured to use horizontal polarization with a gain not exceeding about 3 dB. Higher gain may result in a narrower radiated horizontal beamwidth, which can result in the signal not encompassing ground modules. In another embodiment, the central controller antenna height is kept relatively low, from about 6 feet to about 40 feet above ground, to facilitate a low radiation angle ground wave propagation.

Ground wave or surface propagation refers to radio wave propagation wherein radiation interacts with the semi-conductive surface of the earth. The wave is directed in part by these interactions to move along the surface, over and around obstacles, and to otherwise follow the curvature of the surface. Vertical polarization is commonly used in the art for ground wave propagation, however the present invention also uses horizontal polarization effectively. Radio waves propagating along the ground are attenuated, with higher attenuation at higher frequencies. However, ground wave propagation can enable non line-of-sight radio communication since radiation is allowed to diffract or bend around obstacles. Reflection also enables non line-of-sight communications. The effective use of horizontally polarized, non line-of-sight communication using ground wave propagation at frequencies in the ISM band, for example at 900 MHz, significantly enables communication in the present invention.

In one embodiment, an antenna or array of antennas can be configured to direct electromagnetic radiation preferentially toward the ground at an oblique angle, the angle selected to capitalize on the effects of ground wave propagation to increase transmission distance at a selected transmission power level. For example, the radiation pattern can be adaptively modified, with respect to the angle of a main lobe thereof, in order to increase the received signal strength at a selected receiver. Feedback from the receiver can be used to assist in selecting a radiation pattern for this purpose.

A person skilled in the art would recognize that antenna choice for the central controller and repeaters will be influenced by the type of control system, location of the central controller relative to the other components of the system, and the terrain within which the control system is to be operated.

### Antenna Mounting

In one embodiment, VPDMT modules and their associated antennas may be disposed in or attached to other devices to be actuated, for example during manufacture. The antenna and electronics may be fully integrated into the device form factor in an efficient manner. However, it is also contemplated that VPDMT modules can be retrofitted to existing devices, such as sprinkler heads. In this case, the electronics can be located in an enclosure that can be situated near or attached to the device to be actuated or monitored. The antenna can be mounted on a horizontal surface, a surface on top of the electronics enclosure or on top of the device to be actuated or monitored, or on a customized cover for said device, for example. The horizontal configuration of an antenna can provide for a desirable low-profile form factor for antennas mounted near or below ground level.

Antennas may be moulded into, embossed onto or otherwise affixed in a channel within or included within an insert, or otherwise affixed or integrated into another device such as a sprinkler head or rotor, or other device, depending on the embodiment. An antenna or antenna system may also be formed as a component having a housing for attachment to another device. Integrating the antenna into another device during manufacture, or providing a suitably integrated antenna during retrofit may facilitate good RF communication performance in a convenient package, while protecting the antenna and associated electronics from potential damage.

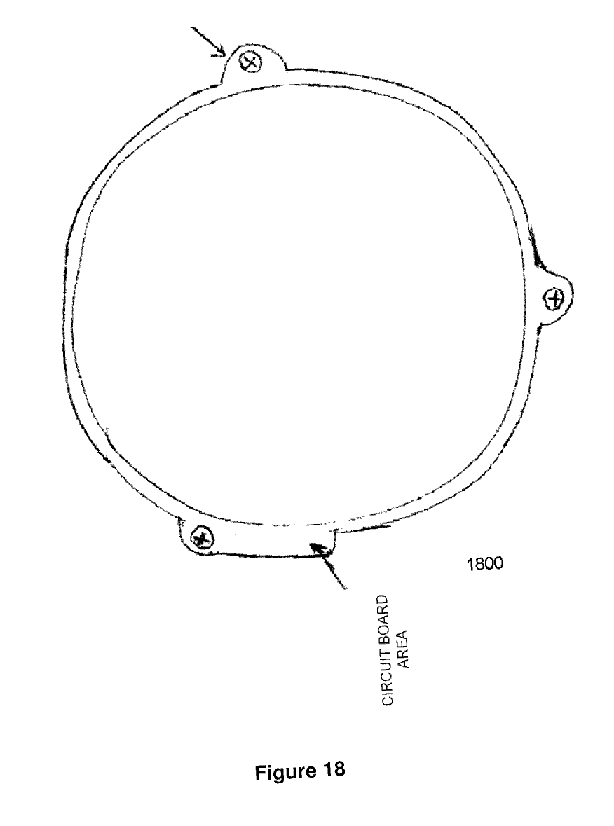

FIGS. 18, 19, and 24 to 33 illustrate various antenna housings and configuration options for disposing an antenna in other devices for use in irrigation systems. The antennas may be disposed during manufacture or retrofitted post installation.

FIG. 24A illustrates top and FIG. 24B a cross-sectional view of a part 2400 of a sprinkler with a through hole 2410. FIGS. 25A and 25B illustrate top and cross-sectional views of a part 2500 of a sprinkler with a through hole 2510. The part 2500 includes a ring insert 2520 disposed concentrically with the through hole 2510 and includes an antenna 2530. The ring insert 2520 may be made of a plastic or other adequate predetermined rugged dielectric material. The embedded antenna 2530 may be made of copper or another metal or conductive material and may be configured as a micro strip or wire antenna, for example. FIG. 25B also shows an antenna matching circuit and RF connection 2533 for use with antenna 2530.

FIGS. 26A and 26B illustrate top and cross-sectional views of a part 2600 of a sprinkler with a through hole 2610. The part 2600 includes an antenna 2630 disposed concentrically with the through hole 2610. The antenna 2630 may be made of copper or another metal or conductive material and may be configured as a micro strip or wire antenna disposed in a channel 2620 embossed or routed in the top surface of the part 2600, for example. FIG. 26B also shows an antenna matching circuit and RF connection 2633 for use with antenna 2630.

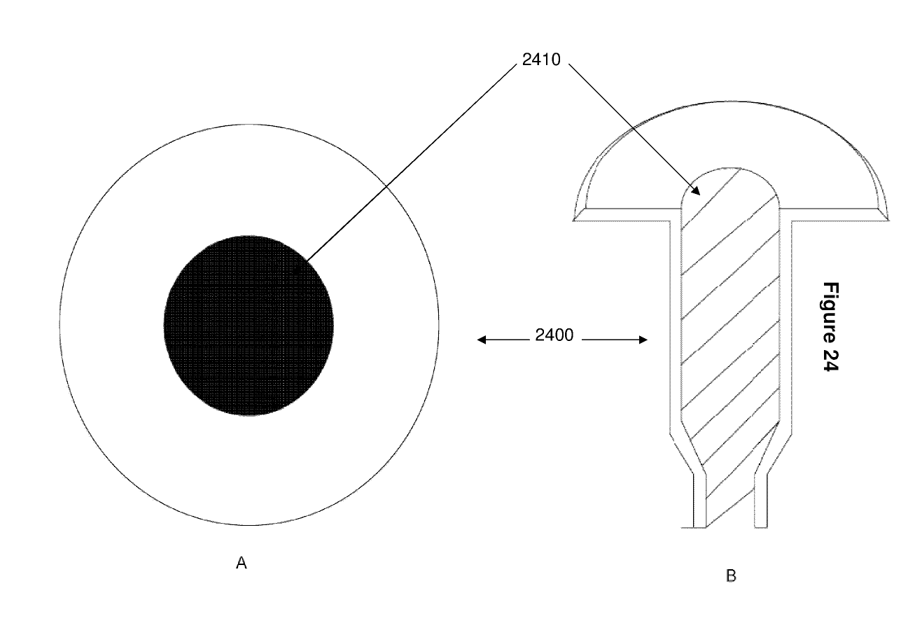

FIGS. 27A and 27B illustrate top and cross-sectional views of a part 2700 of a sprinkler with a through hole 2710. The part 2700 includes an antenna 2730 disposed concentrically with the through hole 2710. The antenna 2730 may be made of copper or another metal or conductive material and may be configured as a micro strip or wire antenna integrally disposed in the top 2720 of the part 2700, for example. The antenna 2730 may be included in the top 2720 of the sprinkler during manufacture of the sprinkler, for example. FIG. 27B also shows an antenna matching circuit and RF connection 2733 for use with antenna 2730.

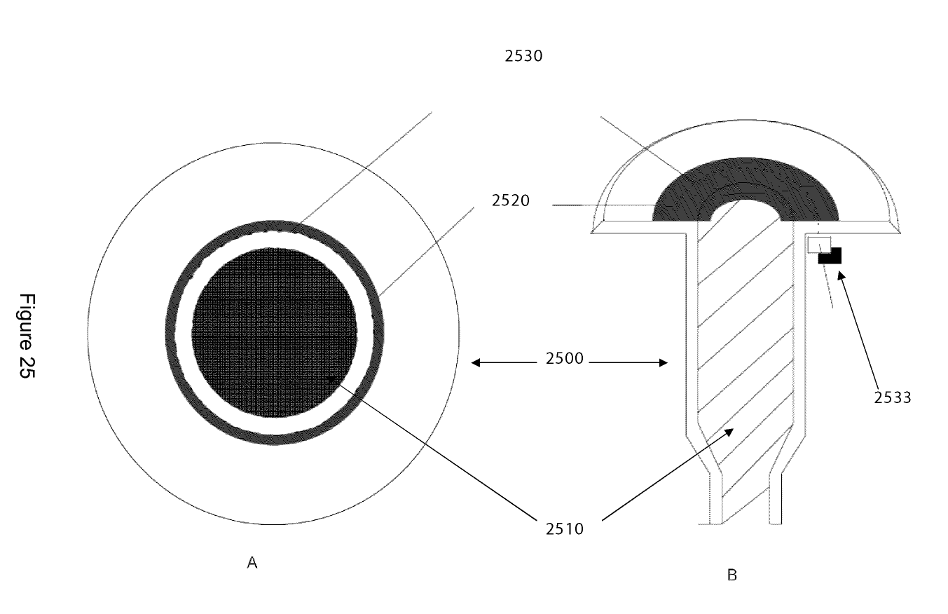

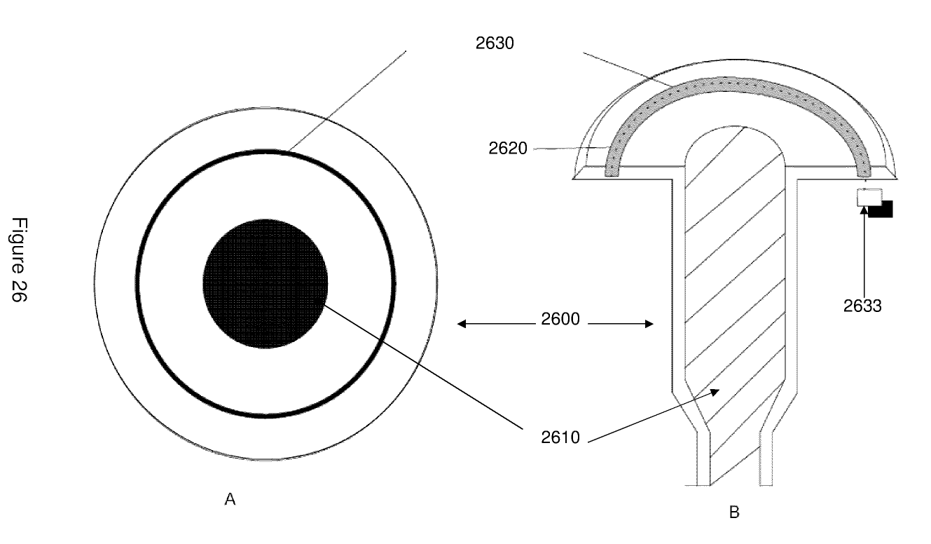

FIGS. 28A and 28B illustrate top and cross-sectional views of a part 2800 of a sprinkler with a through hole 2810. The part 2800 includes an antenna 2830 disposed concentrically with the through hole 2810. The antenna 2830 may be made of copper or another metal or conductive material and may be configured as a micro strip or wire antenna disposed in or affixed to an outer edge 2820 of the top of the part 2800, for example. FIG. 28B also shows an antenna matching circuit and RF connection 2833 for use with antenna 2830.

FIGS. 29A and 29B illustrate top and cross-sectional views of a square valve box lid 2910. FIGS. 29C and 29D illustrate top and cross-sectional views of a circular valve box lid 2920.

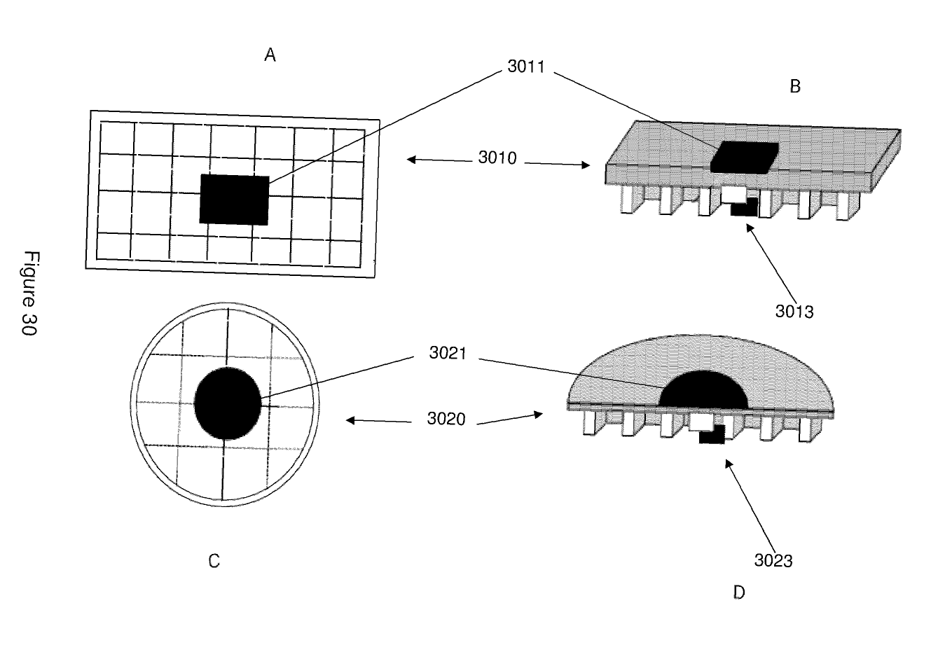

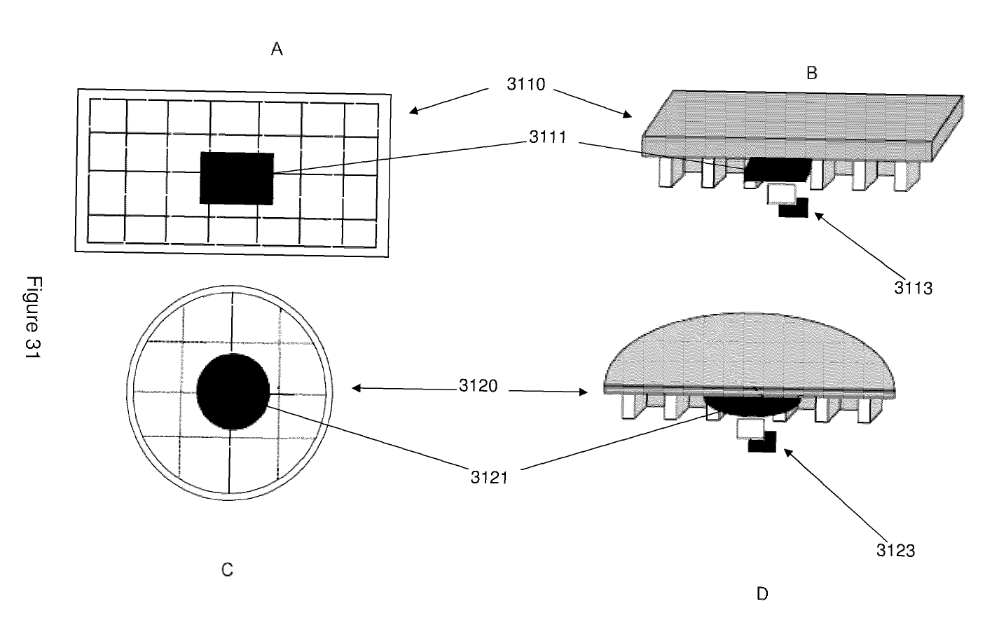

FIGS. 30A and 30B illustrate top and cross-sectional views of a square valve box lid 3010 with an antenna system 3011 disposed on an outside of the circular valve box lid 3010 in accordance with an embodiment of the present invention. FIGS. 30C and 30D illustrate top and cross-sectional views of a circular valve box lid 3020 with an antenna system 3021 disposed on an outside of the circular valve box lid 3020 in accordance with an embodiment of the present invention. FIG. 30B and FIG. 30D also show antenna matching circuits 3013 and 3023 for use with corresponding antennas 3011 and 3021.

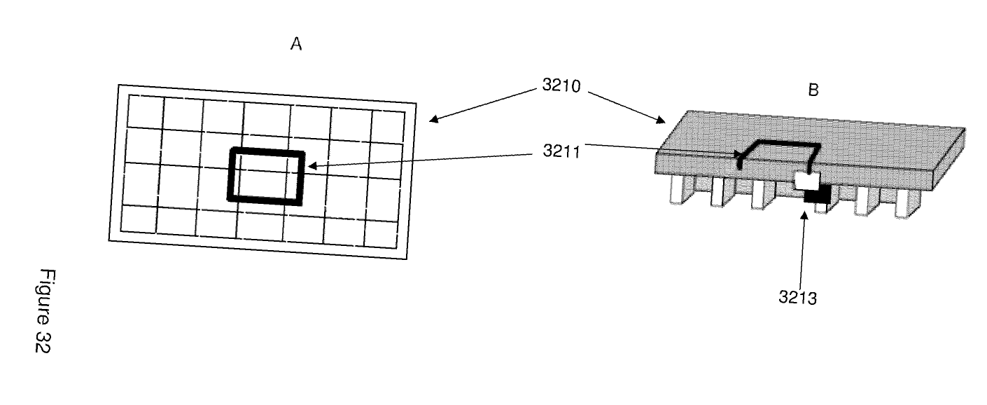

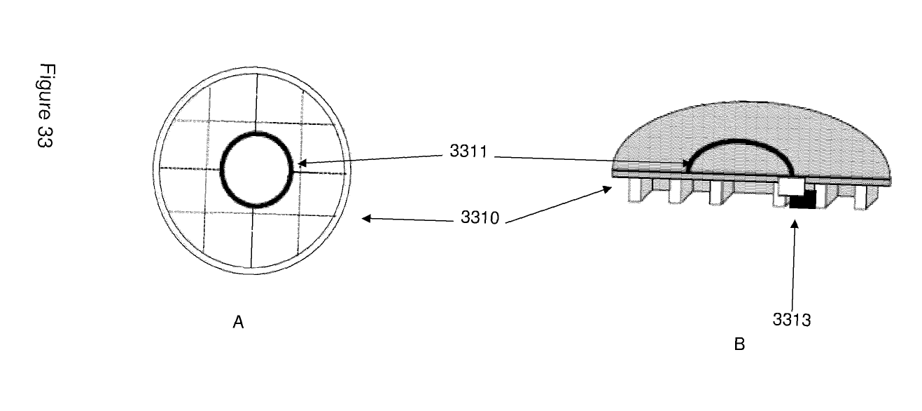

FIGS. 31A and 31B illustrate top and cross-sectional views of a square valve box lid 3110 with an antenna system 3111 disposed on an outside of the circular valve box lid 3110 in accordance with an embodiment of the present invention. FIGS. 31C and 31D illustrate top and cross-sectional views of a circular valve box lid 3120 with an antenna system 3121 disposed on an outside of the circular valve box lid 3120 in accordance with an embodiment of the present invention. FIG. 31B and FIG. 31D also show antenna matching circuits 3113 and 3123 for use with corresponding antennas 3111 and 3121.

FIG. 32A illustrates a top and FIG. 32B a cross-sectional view of a rectangular valve box with an antenna 3211 in a valve box lid 3210 in accordance with an embodiment of the present invention. FIG. 32B also shows an antenna matching circuit with RF connector 3213 for use with antenna 3211. FIG. 33A illustrates top and FIG. 33B a cross-sectional view of a circular valve box with an antenna moulded in a valve box lid 3310 in accordance with an embodiment of the present invention. FIG. 33B also includes an antenna matching circuit 3313 for use with antenna 3311. Each one of antennas 3211 and 3311 may be a micro strip or wire antenna, or another antenna integrally shaped within the respective valve box lid or disposed in embossed, routed or channelled or otherwise fabricated channels which may be formed on the outer side (as illustrated) or opposite side (not illustrated) of the respective valve box lid during moulding or other processing of the valve box lid, for example. The shape of an antenna may correspond with or it may be different from the shape of the valve box lid.

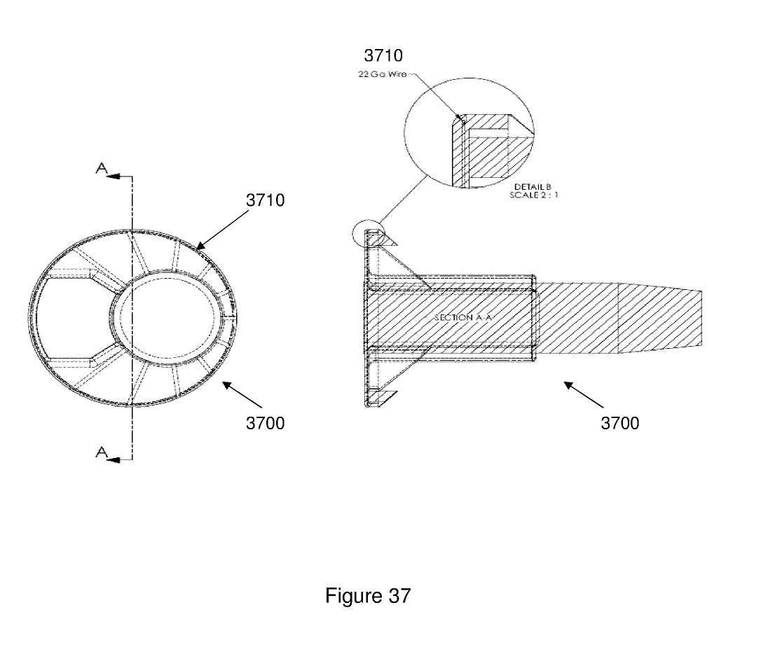

FIG. 37 illustrates a top view and a cross section of a loop antenna 3710 embedded in a rotor 3700 for an irrigation system according to an embodiment of the present invention. The antenna 3710 may be included during manufacture of a rotor or valve box lid as part of the injection moulding process or inlaid during assembly of the rotor valve box lid, for example. The loop antenna 3710 is disposed around the edge of a top surface as indicated in the top view.

FIGS. 29, 30, 31, 32 and 33 illustrate various antenna housing and configuration options for including an antenna such as a loop or crossed-dipole on a horizontal surface such as a valve-box cover for an irrigation system. The antenna may be disposed on an upper or lower side of the horizontal surface, fastened to the surface or built or moulded into the surface either at manufacture or during retrofit. Grooves, channels, or fasteners can be provided for this purpose.

Antennas can be mounted above ground level on some devices on supervisory controllers, hand-held devices, or predetermined repeaters, for example. These antennas can be affixed to an available surface, such as a mast, wall, rooftop, and the like. In addition, two or more antennas may be combined into an antenna array by disposing and orienting, and collectively driving them in a predetermined way to influence the radiation pattern of the array. For example, the directivity of the antenna array may be improved and the strength of the radiation emitted by the array in a desired direction can be adjusted, for example, by orientating the antenna array accordingly. In this manner, communication range can be improved in a desired direction corresponding with the orientation of the antenna array. As another example, the antennas can be tilted such that radiation from the antenna strikes the ground at an oblique angle, the angle configured to facilitate ground wave propagation. In this manner, VPDMTs at ground level can be configured to communicate with above-ground antennas, for example. It is noted that like considerations may apply for a single directional antenna.

### Applications

Use of a wireless control system according to embodiments of the present invention provides for an economical and efficient control of geographically distributed devices within a broad range of applications. The wireless control system has utility in a wide range of medical, industrial, agricultural, military and commercial applications, including, for example, the management of irrigation systems, manufacturing processes, security systems, sewage treatment and handling systems, hospital management systems, tracking systems, ground telemetry systems, environmental monitoring systems for agriculture, viticulture, pipelines and dams, HVAC management systems, water, gas and electrical metering, parking meters, asset and equipment tracking, traffic control, fire protection, public space management, intruder detection, biological research, and others as would be readily understood.

The wireless control system of the invention has utility in a wide range of applications in a number of fields. In an agricultural context, for example, the wireless control system can be used to monitor equipment and/or environmental conditions in poultry houses, dairy buildings, greenhouses, or livestock buildings. Similarly, the control system can be used to manage in-field irrigation systems.

In another embodiment, the wireless control system may be used for control of irrigation systems that may allow irrigation control in agricultural, recreational or landscaping settings, for example. A wireless control system according to another embodiment may be used to control aspects, including irrigation, of a golf course. Details of example embodiments for irrigation applications are described below.

The wireless control system can also be employed to manage temperature, humidity levels, water seepage, power and/or HVAC systems, for example, in homes, in waste water and sewage management facilities, and in heating, ventilation, air-conditioning, refrigeration (HVACR) applications for food processing or storage facilities. The wireless control systems also have applications in the oil and gas and industrial/chemical industries, as well as in laboratories, hospitals and commercial buildings in order to manage, for example, heating, venting and air-conditioning, elevators, lighting, security, access, and the like. The control system can also be used to provide a ground telemetry system as an alternative to GPS systems.

The wireless control system may be used in building and/or site management systems, or components thereof, for example, in security and/or surveillance systems, and can comprise sensors associated with the VPDMT modules such as smoke detectors, infrared motion detectors, ultrasonic presence detectors, or security key detectors. Corresponding actuating means associated with the VPDMT modules may actuate alarms, such as bells or visual alarm indicators.

### Wireless Irrigation Management System

In one embodiment, the invention provides for a wireless control system for managing an irrigation system. The irrigation system can be one of a variety of known irrigation systems that comprise a plurality of water management devices, such as sprinklers, valves, pumps and the like, inter-connected by a network of water supply pipes. The wireless control system can be “retro-fitted” to an existing irrigation system or installed together with a new irrigation system.

In the wireless irrigation management system according to this embodiment of the invention, a majority of the VPDMT modules in the control system are configured to be operatively associated with at least one of the water management devices of the irrigation system, for example, to allow the VPDMT module to switch the water management device on and off, and/or to monitor the status of the water management device, and the RF signals transmitted from the central controller(s) may include commands to the VPDMT module to execute a water management event, such as actuating a water management device, or collecting data from one or more associated sensor(s).

At least some of the VPDMT modules in the network may be operatively associated with one or more sensors for measuring environmental or system conditions. In the context of an irrigation management system, such environmental or system conditions can be, for example, rainfall, water flow, water pressure, temperature, wind speed, wind direction, relative humidity, solar radiation, power consumption, status of the water management device, status of the power supply, and the like. Sensors include, for example, air temperature sensors, soil temperature sensors, equipment temperature sensors, relative humidity sensors, light level sensors, soil moisture sensors, soil temperature sensors, soil dissolved oxygen sensors, soil pH sensors, soil conductivity sensors, soil dielectric frequency response sensors, telemetry sensors, motion sensors, power level sensors and the like. Information provided to the controller of the VPDMT module from the sensor(s) can be processed and transmitted back to the central controller, which in turn can process the data and transmit new commands to the VPDMT modules as necessary, for example, in order to compensate for a change in environmental or system conditions.

In one embodiment, sensors associated with the VPDMT module(s) can be configured to operate using low-power modulation such as FSK, while actuators can be configured to operate using high-power modulation such as FHSS or DSSS, thereby facilitating a network utilizing both short and long range communication.

In one embodiment, a sensor associated with a VPDMT module can be configured to detect an amount of rainfall, frost or ice and communicate data indicative of said amount of rainfall, frost or ice to devices in the network. For example, the sensor can wirelessly transmit data to a smart repeater at scheduled times, such just prior to a scheduled irrigation time. This information can be relayed to one or more controllers and used to change the irrigation schedule based on rain, frost or ice accumulation.

In one embodiment, a sensor associated with a VPDMT module can be configured to monitor water flow or water pressure along a predetermined section of pipes. Upon changes to water flow or pressure indicative of a breakage or leak, the sensor can be configured to transmit a signal to the network, for example to a local smart repeater. A networked device can then react by deactivating at least a portion of the irrigation system coupled to the broken or leaking section of pipe, and a signal can be sent to prompt maintenance.

A wireless irrigation management according to an embodiment of the invention comprises a central controller and a plurality of irrigation management nodes, each of which comprises a VPDMT module operatively associated with at least one water management device. All or a subset of the plurality of irrigation management nodes in the system can comprise a VPDMT module that is further operatively associated with at least one sensor.

According to an embodiment of the invention, the controller of the VPDMT module is configured to activate and deactivate the associated water management device via an actuating means, for example a solenoid valve actuator, in response to control signals received from the central controller. The controller of the VPDMT module also controls the cycle time and monitors the water management device operation and environmental conditions via its associated sensor(s) and transmits sensor data back to the central controller. The irrigation management nodes thus utilise two-way RF communication to determine various parameters, including for example battery levels, moisture levels, activation time and operational status, to provide dynamic monitoring and regulation of the irrigation system, thus allowing real-time irrigation scheduling. The invention further contemplates that the central controller can be connected to the internet to enable remote control and monitoring of the network. The irrigation management system can also comprise one or more mobile VPDMT module, such as a hand-held device, that can act as an auxiliary controller.

In one embodiment of the invention, the VPDMT modules are programmed with an override capability that allows them to disregard a command from the central controller. In this embodiment, when the VPDMT module receives a command from the central controller, it also gathers environmental data through its associated sensors and compares the environmental conditions with a stored set of conditions. The VPDMT module then decides to either implement the command from the central controller or to disregard the command according to whether the environmental conditions match one of the stored set of conditions. For example, a VPDMT module receives a command from the central controller to activate its water management device, however, the environmental data gathered from the sensor(s) associated with the VPDMT module indicates that it is raining. The VPDMT module compares the sensor data that it is raining against the stored set of conditions and finds a match. The VPDMT module, therefore, overrides the command from the central controller, does not activate its water management device, thus preventing wasted water, and transmits a status signal back to the central controller. The override capability of the VPDMT module can thus facilitate water conservation.

An example of a VPDMT module configured for incorporation into an irrigation management system in accordance with the invention is shown in FIG. 2. The VPDMT module shown generally at 100 comprises a RF transceiver 104, an antenna 102 and optional additional antenna 102-1, a controller 106, which comprises supervisory circuitry 118, a serial flash memory 136 and a power source control 108 operatively coupled to a rechargeable or non-rechargeable energy storage device and a power source such as a turbine 112-1, solar cell 112-2, or battery pack 112-3. The energy storage device may comprise a battery-, capacitor- or other system, for example.

The VPDMT module can further optionally comprise, or be operatively associated with, a power generator for recharging a rechargeable energy storage device, if provided by the embodiment. The charging of the energy storage device may be controlled by the controller 106 via the battery charge controller. The power generator can be, for example, a solar panel, a water turbine, oscillator, or other device for recharging battery power. In one embodiment, the power generator is a solar panel array.

The VPDMT module is further operatively associated with an actuating means for actuating one or more valves via one or more latching solenoids 115-1 to 115-4, which can be DC latching solenoids. The actuating means includes solenoid controls 114 coupled to a power source, such as a 9V battery, for example.

The water management device may be a valve, a pump, a sprinkler, a rotor, or other component of the irrigation system, for example, as would be readily understood by a person skilled in the art. Similarly, a worker skilled in the art will appreciate that actuating means other than a solenoid, which are suitable for control of a water management device can also be employed.

The VPDMT module 100 may be operatively associated with one or more sensors. For example FIG. 2 illustrates temperature sensors 138 and 140, rain sensor 120, and water flow sensor 121. Other sensors may be provided for monitoring, for example, motion, telemetry, moisture, and the like, as would be readily understood by a person skilled in the art. Sensors may also be provided to sense or detect one or more configurations of an actuation means, for example, a valve or solenoid position 141-1 and 141-2.

A VPDMT module according to an embodiment of the present invention may include one or more internal temperature sensors 138. The internal temperature sensors may be used to hibernate or deactivate the VPDMT module based on temperature. The one or more temperature sensors may be used to infer operating temperature of one or more VPDMT module components.

A VPDMT module according to another embodiment may be configured to be operatively connected to one or more external sensors. For example, an external temperature sensor 140 can be used to monitor ground and/or surface temperature, or to provide notification of soil and grass “baking” conditions to the central controller, which can then implement extra or emergency watering protocols.

As illustrated in FIG. 2, a VPDMT module according to another embodiment may also provide a power source voltage monitor 142 allows for monitoring of the status of battery and power sources in real time and can provide proactive failure warning. Operational monitors may be employed to indicate operational conditions of the associated water management device. For example, the flow sensor 121 can monitor incoming water pressure and report any drop in pressure that may indicate damaged water lines. Operational monitors can also monitor, for example, rotation of an associated sprinkler in order to determine irrigation saturation. Flow control monitors can measure and report on the volume of water during an irrigation cycle.

A VPDMT module 100 may be configured for operative association with one or more actuating means, as depicted in FIG. 2 with reference to solenoid 1 and solenoid 2, which are also controlled by controller 706. The additional actuating means can be used to control, for example, the position of a water control device, flow rate through a water control device, fertiliser flow rate, rotational speed of sprinkler, lighting, and the like.

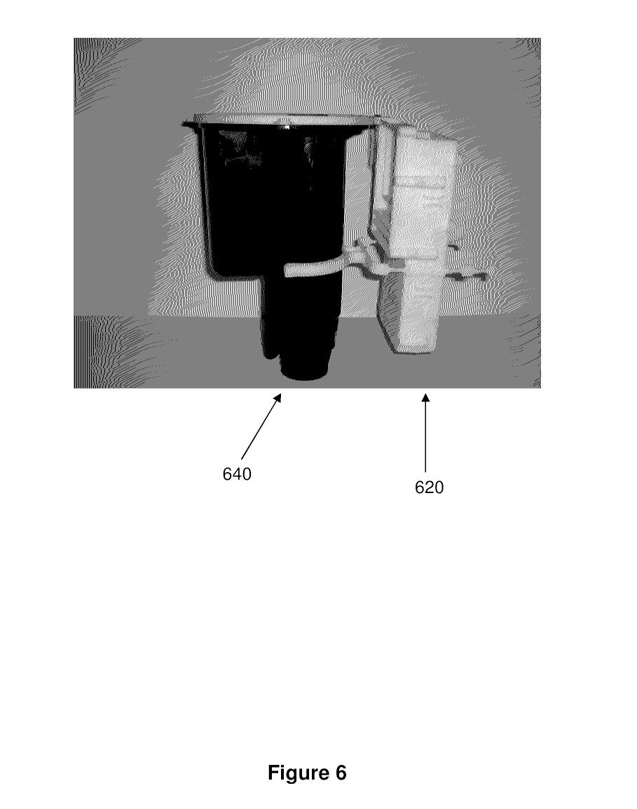

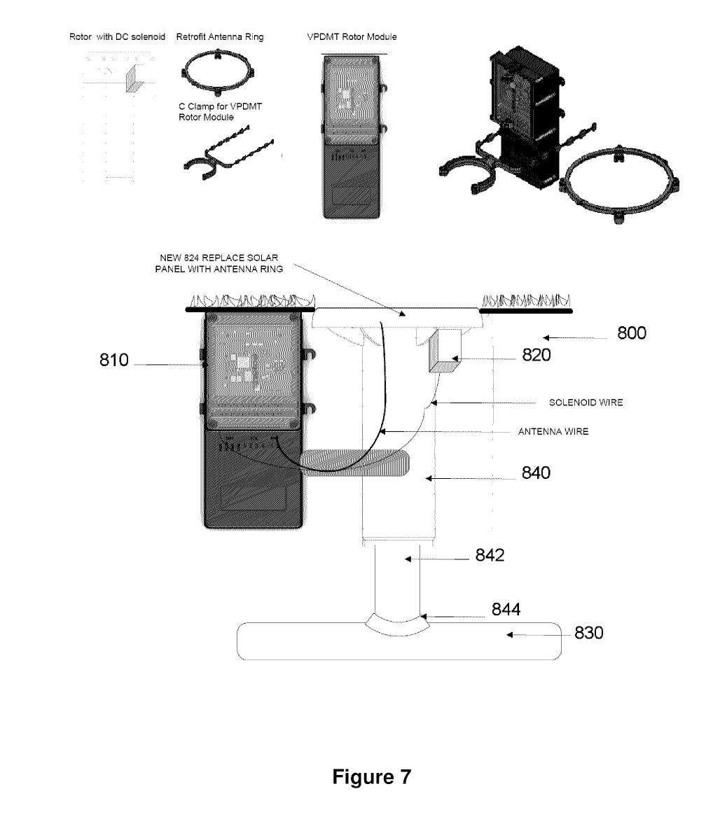

FIGS. 6 and 7 illustrate a wireless irrigation node comprising a VPDMT module associated with a water management device in accordance with an embodiment of the present invention. The wireless irrigation node can further comprise one or more sensors (not shown) operatively associated with the VPDMT module. With reference to FIG. 7, there is provided a wireless irrigation node shown generally at 800, comprising a VPDMT module enclosed within housing 810. The VPDMT module is operatively associated with a rotor sprinkler 840 via solenoid 820. The rotor 840 is connected to a sprinkler supply pipe 830, which supplies water to the rotor 840, via a riser 842 and a saddle 844. A surface mount antenna ring 824 is associated with the housing 810 and is operatively associated with the VPDMT module for communication. Accordingly, the VPDMT module does not require external electrical connections for power or control. As shown in FIG. 7, the VPDMT module in housing 810 is located generally beneath the ground with the surface mount antenna ring 824 located at ground such that they are exposed to the earth surface.

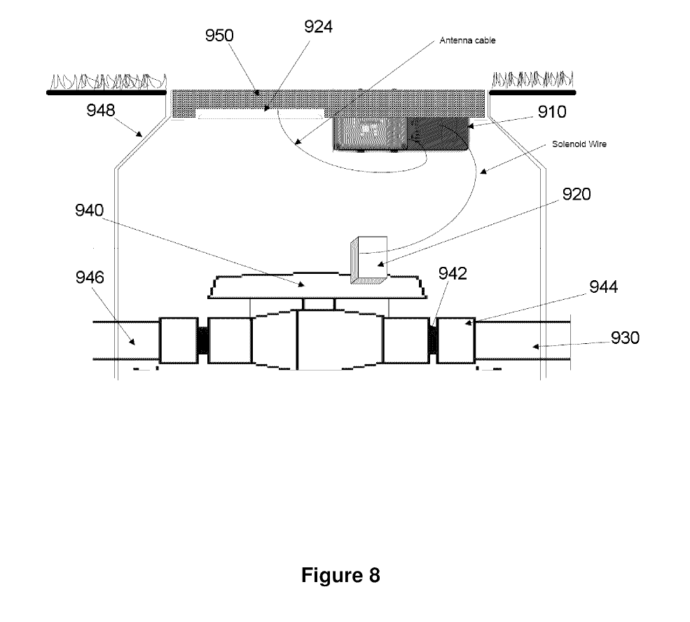

A water irrigation node in an alternative embodiment of the invention, in which the VPDMT module is integrated into the water management device, is depicted in FIG. 8. With reference to FIG. 8, there is provided a wireless irrigation node comprising a VPDMT module enclosed within housing 910, which is integrated into valve box 948 (shown in cross section). The VPDMT module housing 910 is attached to the underside of the valve lid/cover 950. The VPDMT module is operatively associated with electric valve 940 via solenoid 920. The electric valve 940 is connected to sprinkler supply pipe 946, which supplies water to individual sprinklers in the system. The sprinkler supply pipe 946 is connected to the main water supply line 930 via main line fitting 944 and nipple 942. A surface mount antenna assembly/ring 924 is associated with the upper surface of valve cover 950 such that it remains near or above ground and is operatively associated with the VPDMT module for communication.

As described above, the VPDMT modules can be equipped with power management capabilities. To provide for additional power conservation, in one embodiment of the invention, the central controller of the irrigation management system can instruct the VPDMT modules to go to a standby or sleep mode for a prolonged period of time to conserve power, for example, during the winter where irrigation is not required. The VPDMT modules can be instructed to sleep for a predetermined period of time or to wake-up periodically to check for RF signals containing activation commands at predetermined intervals.

As noted above, the irrigation management system is configured to operate on one or more of the 433, 868, 915 MHz, and 2.4 and 5.8 GHz ISM frequency bands. In one embodiment of the invention, the VPDMT modules in the irrigation management system are configured to transmit and receive RF signals in one or more of the 433, 868 and 915 MHz ISM frequency bands that meet the European (ETSI, EN300-220-1 and EN301 439-3) or the North America (FCC part 15.247 and 15.249) regulatory standards. In another embodiment, the VPDMT modules are configured to transmit and receive RF signals in the 868 and/or 915 MHz ISM frequency bands.

The irrigation management system can further comprise one or more handheld nodes (e.g. independent or field controller). For example, in addition to the central controller(s), the invention contemplates that the irrigation management system can be controlled with one or more mobile auxiliary controllers as described above. Handheld nodes can be used for a variety of purposes such as manual control of the operation of the irrigation nodes, manual control over or override of the irrigation schedule, real time mobile monitoring of the network and environmental conditions, and providing telemetry information for navigation. In order to accomplish these tasks, handheld nodes transmit to and receive data from the central controller or from individual irrigation nodes as required.

The wireless control system provided by the invention can be used to manage irrigation systems in a variety of agricultural, recreational or landscaping settings. For example, in one embodiment, the invention provides for an irrigation management system for municipal land. The network can cover several unconnected parcels of city land to allow centralised control of multiple physically separated irrigation systems that form part of one wireless irrigation control network by placing a VPDMT module on the edge of each parcel of municipal land was within the transmission range of at least one VPDMT module in the next parcel of land. In this case the installation of the wireless irrigation control network would allow new parcels of land to be added without the need for multiple site-specific central controllers or to install control wires under roads.

In another embodiment, the invention provides for an irrigation management system for agricultural land. VPDMT modules can extend the network to nearby but physically separated fields, allowing for centralized control of multiple areas. In addition to pure irrigation management, mobile nodes can be installed on farm equipment to aid in navigation and coordination based on telemetry information received from the VPDMT modules. In a further embodiment, the invention provides for an irrigation system for recreation fields.

In yet another embodiment, the invention provides for irrigation management as part of a fire prevention system in a building. The VPDMT modules are associated with sprinkler valves and are connected to environmental sensors such as smoke or heat detectors. In the event of a fire, the network would activate the sprinklers as well as fire alarms.

### Golf Course Wireless Irrigation Management System

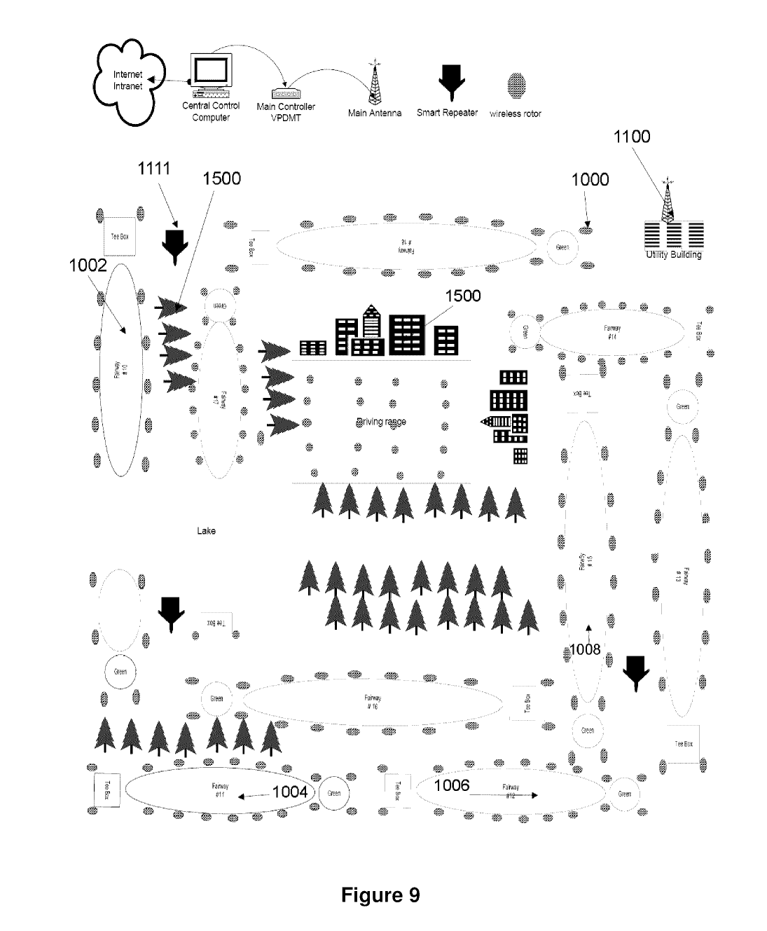

A wireless control system according to another embodiment of the present invention may be used in an irrigation management system for a golf course. An example of an irrigation management system for a golf course according to one embodiment of the invention is illustrated in FIG. 9. Irrigation nodes 1000 are installed throughout the golf course to control irrigation. The fairways 1002, 1004, 1006 and 1008 of the golf course are separated from one another and from the central controller 1100 by trees/buildings 1500. Due to their long-range transmission capabilities, the network of irrigation nodes 1000 is able to route information around the trees and buildings 1500 and between fairways 1002, 1004, 1006 and 1008 to different parts of the network and to the central controller 1100, and can use smart repeaters 1111 and ad hoc routing protocols for this purpose. The invention contemplates that the irrigation management system can control irrigation of multiple golf courses with a single central controller, provided that at least one VPDMT module in one golf course is within range of at least VPDMT module in the next golf course.

In accordance with this embodiment, a subset of the VPDMT modules in the system are dedicated to managing the irrigation of the golf course and may be operatively associated with at least one of the water management devices of the irrigation system and with one or more sensors for measuring environmental or system conditions. In one embodiment of the invention, this subset of VPDMT modules are configured as shown in FIG. 2 to be operatively associated with a solenoid for a valve, sprinkler or the like, an internal temperature sensor, an external temperature sensor, a motion sensor, a telemetry sensor, a moisture sensor, a flow control monitor, a battery status monitor and an operational monitor.

In another embodiment, the external temperature sensor detects the temperature of the soil in real-time. When soil temperatures are increased or decreased from the pre-programmed optimum range, the sensor sends an alert to the central controller or to a hand held unit. Optimal germination, growth, and development of turf grass are known to be restricted to a specific temperature ranges in the soil, therefore, the alert allows for proactive correction of potential plant stress including disease, infestation with pests (such as insects, nematodes, and/or weeds) and plant death. Appropriate ranges can be selected based on the turf grass species or cultivar.

As grass on golf courses is frequently cut very low, for example on a putting green, monitoring the temperature at the root of the plant, rather than water content by means of a moisture sensor will allow detection of any overheating of the root structure which can result in burnt grass or loss of root structure. As such the soil temperature sensor allows for proactive rather than reactive sensing and corrective steps can this be taken at an earlier stage.

The golf course wireless irrigation management system of the invention can further comprise a plurality of mobile nodes that are provided to golfers to provide spatial information such as distance to the green or hole and general mapping information which may be conveyed by communication through the irrigation nodes. Scoring information can also be transmitted and organised through the network using handheld nodes. Authorized personnel may use handheld nodes to control the irrigation system remotely. Handheld nodes or their functions may be integrated into equipment such as golf carts or other rental equipment, for example. Handheld nodes may be configured to provide a number of telemetry data. For example location data, that may be used in combination with a security system to allow for tracking of the equipment. Handheld nodes can be used to deactivate golf carts if they travel outside a defined area.

In one embodiment, the golf course wireless irrigation management system is configured with a smart topology with gateway mapping and routing protocols. In accordance with this embodiment, the system can further comprise a plurality of hand-held VPDMT modules that act as scoring units for golf players as well as showing, for example, the course map and relevant yardage. The scoring units can also act as a remote caddy to report exact yardage from any location to the player's location, as well as allowing the player to order food and beverages. Mobile VPDMT modules can also be incorporated into the golf carts and can include an LCD display allowing players to view the course map. These modules can act as a remote caddy to report exact yardage from any location to the player's location, as well as allowing the player to order food and beverages. In addition, mobile VPDMT modules can be employed for equipment control, in which the VPDMT module is incorporated into golf carts and golf maintenance equipment and is configured with an auto shut-off capability that disables the vehicle if it travels beyond course property or into forbidden areas.

The invention is described with reference to specific examples in the following section. It is understood that the examples are intended to describe embodiments of the invention and are not intended to limit the invention in any way.

### EXAMPLES

### Example 1

### Wireless Irrigation Management System for a Golf Course

The Wireless Irrigation System (WIS) can control and monitor a golf course battery operated irrigation system from one central computer or portable personal digital assistant (PDA) or from a system of smart repeaters or gateways without the need for embedded wiring. There is no limit to the number of valves, sprinkler or sensor stations that can be controlled, allowing for complete water management. The specification below outlines the requirements for the design and development of the electronics and software for the central computing device, hand held unit, main controller, smart repeater and valve or sprinkler head.

The WIS comprises six individual components: Central Control Computer (CCC), Irrigation System Software (ISS), Main Control Unit (MCU), PDA Control Unit (PDACU), Smart Repeater/Gateway Control Unit (SRCU) and Irrigation Activation Unit (IAU). The MCU and the PDACU are independent control units that can be synchronized to operate a wireless irrigation system or can independently operate an irrigation system with or without the SRCU. This shall allow for a level of redundancy.

Central Control Computer: The Central Control Computer (CCC) is comprised of a PC running the IIS on the Windows 2000, XP, Vista or Mac operating system. The PC shall be connected to the primary MCU transceiver via RS 232 or USB interface

Irrigation System Software: The Irrigation System Software (ISS) is a dual software package that controls and manages the wireless RF communication and standard irrigation system water management and scheduling software requirements for the Main Control Unit in Windows 2000, XP, Vista or Mac operating system or for the PDACU in Windows Mobile or CE

Main Control Unit: The Main Control Unit (MCU) comprises one VPDMT module that is operatively connected via RS 232 or USB interface to the CCC and provides the primary transceiver for receiving and transmitting communication signals.

PDA Control Unit: The PDA Control Unit (PDACU) is configured to act in the same manner as the combination of CCC-ISS-MCU. When the PDACU is utilized in conjunction with a CCC-ISS-MCU combination it will provide synchronization of all ISS software activities completed by the PDACU to the CCC-ISS-MCU system.

Smart Repeater/Gateway Control Unit: The Smart Repeater/Gateway Control Unit (SRCU) comprises a VPDMT module and external antenna, capable of acting as an independent controller in an WIS for receiving and transmitting communication signals, retransmitting communication signals, data logging, storing communication messages for scheduled communication times, processing direct or indirect data from sensors to adjusting irrigation schedules, processing data from ICU's and transmitting to a MCU or PDACU.

Irrigation Activation Unit: The Irrigation Activation Unit (IAU) is used to control the solenoid for individual valves or sprinkler heads. The IAU is configured for receiving commands from the MCU, PDACU, SRCU or a relayed command form any other IAU. The IAU is configured to respond to the MCU, PDACU or SRCU and to replay commands or responses. The IAU is configured to store daily, weekly, monthly and annual irrigation schedules, monitor battery and operation functionalities.

WIS Communication Lines: Each WIS unit is configured to wirelessly communicate via a 868/915 MHz RF transceiver interfaces. Each unit is configured to communicate with another unit within range using a star, mesh or ad hoc relay network approach. Each unit has a network address. The RF transceiver chip is configured as a Low-Power Sub-1 GHz RF Transceiver such as AMIS 5300, Texas Instrument CC1101 Semtec XE 1205 or equivalent. The MCU and the PDACU are configured to communicate via RS 232 or USB 2 interface.

### IAU Operation

The IAU is configured to perform the following operations.

Irrigation: The IAU is configured to store daily weekly, monthly and annual irrigation programs/schedules and to independently operate or adjust irrigation programs without requiring RF communications. The IAU is also configured to independently adjust the irrigation programs based on sensor input data.

Battery voltage: The IAU is configured to monitor the battery voltage and report back to the CCU when the battery is below a predetermined voltage level. The IAU is configured to report the present battery voltage when requested by the CCU.

Temperature sensors: The IAU is configured to monitor two separate temperature sensors (one internal and one external). The IAU is configured to report the present temperatures when requested by the MCU.

Solenoid controls: The IAU is configured to control DC latching solenoids at various pulse rates. The IAU is configured to monitor the solenoid or valve or sprinkler and report back to the MCU when a failure to activate or a failure to deactivate has occurred.

Moisture sensors: The IAU is configured to monitor three separate external moisture sensors. The IAU shall report the present moisture reading from each sensor when requested by the MCU.

Temperature operating range: The IAU is configured to meet all operational requirements for ground temperature between −40° C. & +50° C.

Elapse time indicator (ETI): The IAU is configured to incorporate an electronic ETI. The ETI is implemented in software as described in the software section below. The ETI is configured to keep track of total system on time and report this information to the MCU, PDACU or SRCU upon request.

Battery: The IAU is configured to operate from a battery of defined voltage. The IAU may be configured to recharge the battery using a solar cells or a near field induction generator driven by flowing water or both, for example.

### WIS Reset

There are four separate reset lines for the WIS. 1) Magnetic switch; 2) Watchdog timer (internal to the micro); 3) Power on reset and 4) Software command.

Magnetic switch: The magnetic switch when activated is configured to restart its program. The WIS is configured to provide de-bounce circuitry for the reset line.

Watch dog timer: The WIS processor has a built-in watch dog timer that is configured to reset the processor when not reset before a timeout occurs.

Power on reset: A reset circuit is included to assert the WIS internal reset line for 100 msec on power up.

Software Command Reset: The WIS processor is configured to reset when obtaining a reset command.

### Software

The WIS is configured with the following software modules and controls.

### Central Computer Control—Control and GUI Interface

PDA Control—control and LCD interface

Smart repeater Control—control

Irrigation Activation Unit—control

### System Topology, and Control, Sprinkler and Valve VPDMTs and Antennas Thereof

With reference to FIG. 14, and in accordance with an embodiment of the present invention, a system can be configured to have a star network topology, wherein a central controller communicates with a number of smart repeater control units, which may include one or more low power short range smart repeater control units and/or high power long range smart repeaters control units. Each smart repeater control unit is adapted to communicate with a number of VPDMTs within their range using a variable power dual modulation option, wherein each smart repeaters control units and/or the main controller may select to use either of a high power and low power modulation to communicate with respective VPDMTs. Selection of the modulation module may be pre-programmed and/or dictated by system imposed communication ranges and/or system power saving considerations, for example as discussed above. It is noted that a similar system may be implemented without using a central controller, wherein the network of smart repeaters are adapted and configured to provide control over the network of system VPDMTs.

FIG. 15 illustrates a schematic representation of the central controller, which comprises a computer 1500 operatively coupled to a PDA 1510 with a RF card 1511, and optionally the internet 1501 or other local or external network communication systems. System commands or messages are transmitted or received by the computer 1500 via an RF controller 1530 and, in this example, two quad or dual bow-tie full wave antennas 1520 operating in a phased array. Similar antennas are also considered for repeaters, for example as depicted in FIGS. 22 and 23. For example, the repeaters/controllers can communicate with other components of the system via a full wave bow-tie antennas (e.g. see FIG. 23) operating at 915 or 868 MHz and configured in a quad or dual array design based on terrain. Combining this type of antenna with the below-described sprinkler and valve antennas has been shown to increase link budgets up to 70% to 85% when compared to similar systems using quarter or half wave antennas.

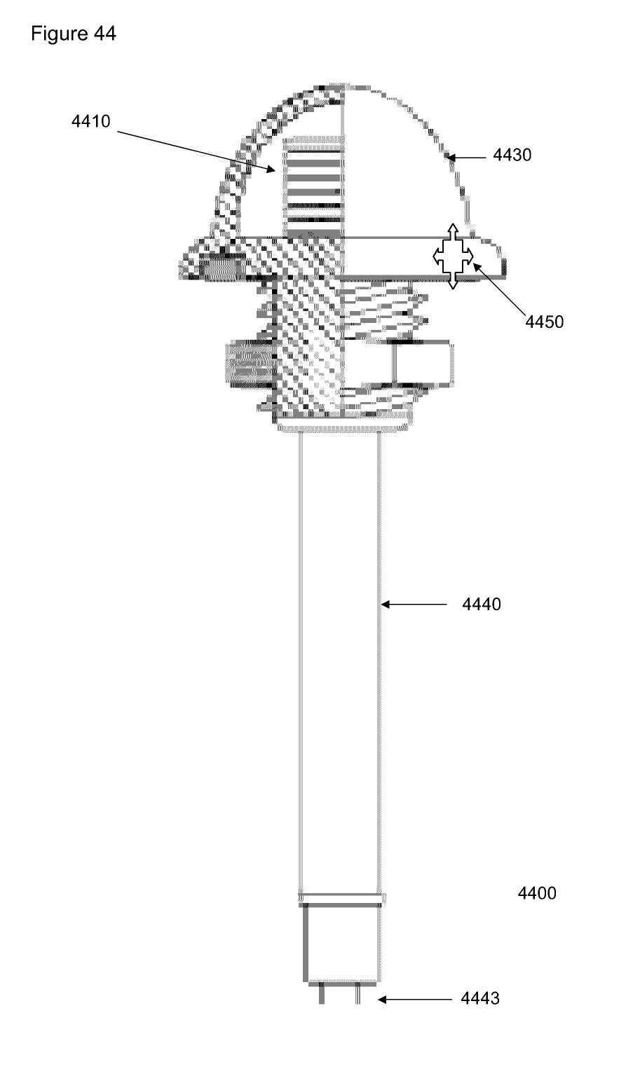

FIG. 44 illustrates a dome antenna 4400 in half cross sectional and half elevated side view according to an embodiment of the present invention. The dome antenna 4400 is fully integrated and comprises an antenna coil 4410, a dome shaped housing part 4430, a steel ground plate 4440, a RF connector 4443, a tuning element 4450 for tuning predetermined antenna characteristics. The antenna coil 4410 is operatively connected (not illustrated) to RF connector 4443. The dome shaped housing part 4430 may be integrally shaped and comprise an adequate material, for example a plastic, with predetermined dielectric properties. The dome shaped housing part 4430 may be integrally shaped or it may be configured to mate with another part of the dome antenna 4400 using a threading, bayonet mount or other mechanical interconnection as would be readily understood by a worker skilled in the art.

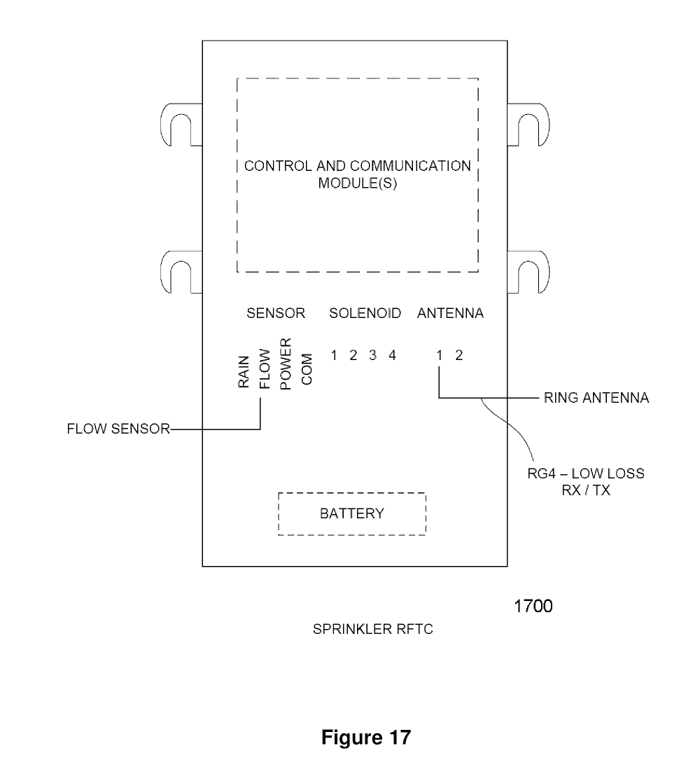

FIG. 16 illustrates a block diagram 1600 of an example VPDMT that can be used with a number of antennas. For example, the VPDMT can be used as a sprinkler VPDMT (FIG. 17), a valve VPDMT (FIG. 20) or a controller/repeater VPDMT (FIG. 22). The example VPDMT comprises a microcontroller, a power source (battery or external power source), a field programmable gate array (FPGA), serial port and flash drive 2. The microcontroller can communicate commands to one or more devices via solenoids 1 to 4, or receive sensed data signals from sensors 1 and 2. Data and/or commands can be received or forwarded via RF, power adjustment and amplifier modules configured to communicate with one or more operatively connected antennas, in accordance with either of a low power modulation scheme (e.g. FSK) or a high power modulation scheme (e.g. FHSS/DSSS) via a FSK-FHSS/DSSS switch.

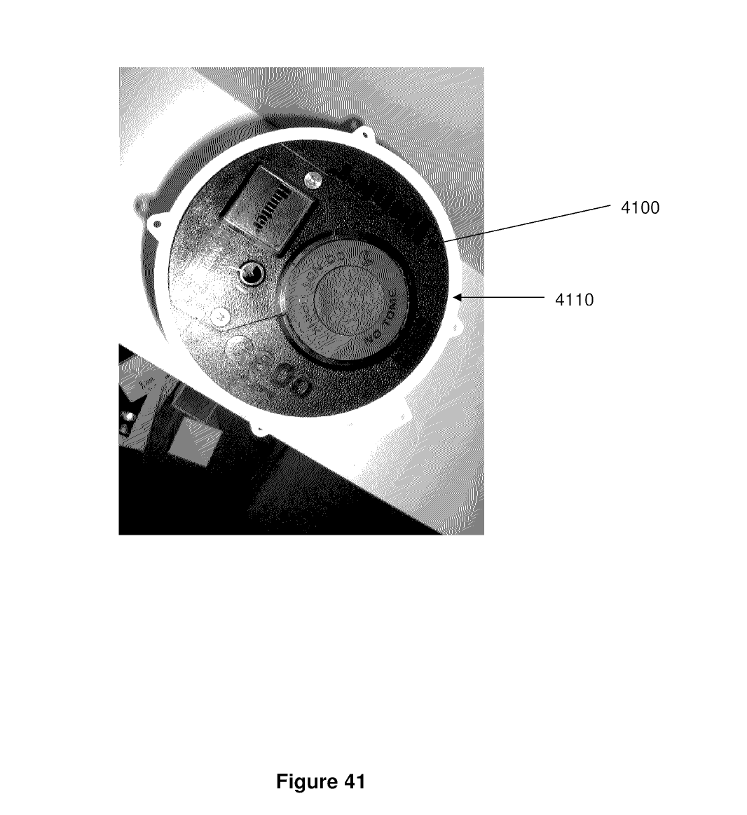

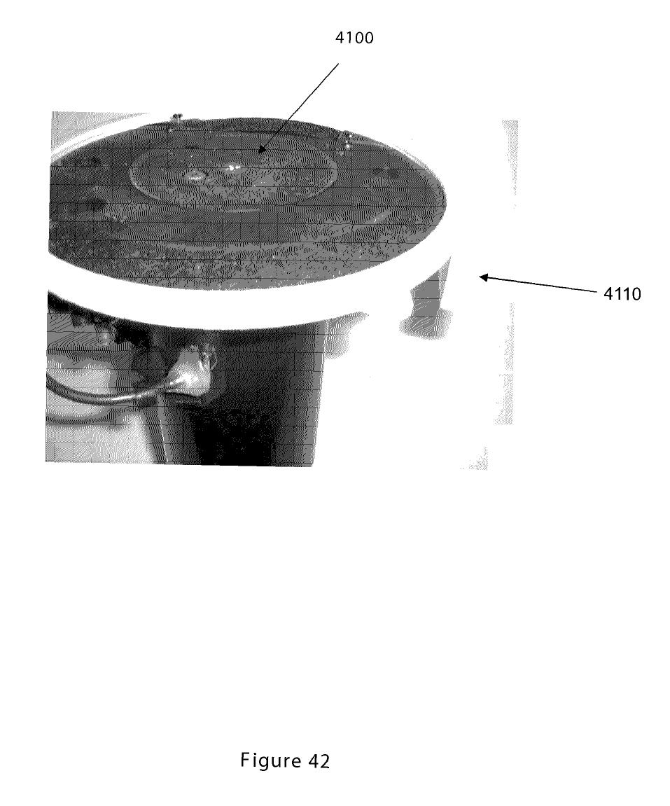

FIG. 17 illustrates a connection diagram 1700 of an example VPDMT when used to operate a sprinkler. The sprinkler VPDMT communicates with a flow sensor for detecting output flow, and with other system components using a full wave ring or loop antenna connected via a coaxial low loss communication cable, for example. The control and communication module(s) is adapted to communicate with other components of the system for receiving commands for operating the sprinkler using solenoids 1 to 4, and feedback sensed data received from the flow sensor. FIG. 18 illustrates a top view 1800 of a part of an example sprinkler head to which an antenna assembly 1900, shown in FIGS. 19A to 19D, may be attached and operatively connected. In this particular embodiment, the wire antenna is fitted within a slot 1910 of the antenna assembly. FIG. 41 and FIG. 42 show an antenna assembly 4110 of this type fastened to a sprinkler 4100.

FIG. 20 illustrates a connection diagram 2000 for an example VPDMT 2010 when used to operate a valve. The valve VPDMT communicates with a flow sensor for detecting output flow, and with other system components using a full wave swastika antenna connected via a coaxial low loss communication cable, for example. The control and communication module(s) is adapted to communicate with other components of the system to receive commands therefrom for operating the valve via solenoids 1 to 4, and feedback sensed data received from the flow sensor. FIG. 21 provides an example of a swastika antenna for use with the valve VPDMT of this example, providing a blown up view of the antenna feed point designations. In this example, the antenna comprises an omni-directional horizontally polarized crossed-dipole swastika antenna.

FIG. 22 provides an example interconnection diagram 2200 of a VPDMT when used as a smart repeater or controller. The VPDMT 2210 can communicate with a computer or other computing device for processing data and system commands, and with other components of the system using a full wave quad or dual array bow-tie antenna connected via a coaxial low loss communication cable, for example. The control and communication module(s) is adapted to communicate with other components of the system to provide commands thereto. FIG. 23 provides an example of a full wave bow-tie antenna for use with the repeater VPDMT of this example, wherein the antenna comprises a horizontally polarized antenna.

As described above, it is contemplated that different types of antennas may be used in this example to provide good system performance. In this example, sprinklers controlled by an associated VPDMT communicate with the other components of the system via a full wave low profile antenna surface mounted to or moulded within the sprinkler head and configured to operate at 915 or 868 MHz. This selection was found to provide, in one embodiment, a minimum 20 dBm gain over commercially available or in ground antennas.

In one embodiment, and in contrast to sprinkler and controller VPDMTs, valve VPDMTs can be configured to communicate with the other components of the system via a full wave low profile surface mount swastika antenna configured to operate at 915 or 868 MHz, which was also found to provide, in one embodiment, a minimum 20 dBm gain over commercially available or in ground antennas.

In one embodiment, the repeaters may optionally be designed to comprise two variable power dual modulation transceivers, for example in an agricultural or large commercial (e.g. city wide) irrigation systems in order to provide long range communication (e.g. up to 40 km) with directional antennas at 915, 868, 2400 or 5800 MHz using the first variable power dual modulation transceiver to receive commands, and transfer these commands locally using the second variable power dual modulation transceiver, for example in FSK or FHSS at 915 or 868 MHz.

FIGS. 24 to 33 present various embodiments of sprinklers and valves for use with a system as described above, depicting different methods for mounting respective sprinkler and valve antennas thereon, thereto or therein. These figures show various antenna mounts, either incorporated into the sprinkler or valve during manufacture, or retrofit to the sprinkler or valve.

FIG. 6 illustrates a VPDMT rotor controller module housing 620 and a rotor housing 610 for an irrigation application of a wireless control system according to an embodiment of the invention.

### Example 2

### Configuration of a Wireless Irrigation Control System

An example wireless control system according to another embodiment of the present invention is configured to provide the following aspects. The wireless control system uses a bidirectional VPDM data communication scheme for communication with wireless irrigation controllers that are configured to enable control of the irrigation system at the sprinkler valves that perform the irrigation using corresponding VPDMT modules. The example wireless control system may be configured to perform predetermined aspects of an irrigation program without requiring the use of one or more of AC power, field controllers, satellite stations, decoders or hard wired communication links. In one embodiment, the system may be configured to perform one or more predetermined aspects of an irrigation program without requiring the use of a central controller. The VPDMT modules are configured for use in combination with DC latching solenoid valve actuators. Other valve actuators, for example as used in some irrigation systems, may be readily replaced with DC latching solenoid valve actuators. In addition, already installed irrigation systems may be readily converted to employ the system, for example, by replacing the AC Solenoid with DC latching solenoid valve actuators. The system includes one or more gateway controllers providing independent two-way communication for relaying communications from a central controller for control of to up to about 16,000 sprinkler valves. The system may also comprise one or more handheld nodes. In one embodiment, the central controller is operatively associated with a handheld node. The system nodes operate in the 915 Mhz ISM band with the following characteristics:

Handheld node: ultra low power FSK at 3 kb/s output power 0-15 dBm.

Sprinkler valve node with ring, radome or cross dipole antennas: low power FHSS at 9.6 kbs output power ¼ W or 24 dBm.

Gateway node with cross dipole, radome or bow tie antennas: mid power FHSS at 9.6 kbs output power ½ W or 27 dBm.

Central controller node with dross dipole, radome or bow tie antennas: high power FHSS at 9.6 output power 1 W or 30 dBm.

The example irrigation control system, when operated at about 10 kHz deviation and about 20 kHz bandwidth, is configured to communicate at about 3 kb/s or 9.6 kb/s down to −111 to −113 dBm over distances between nodes as listed in the table below with over about 99% reliability.

| | Communication mode | | | | | |
|---|---|---|---|---|---|---|
| | Line of sight (LOS) | | | Non LOS | | |
| Distance between | Feet | Miles | Km | Feet | Miles | Km |
| Controller to/from | 63,360 | 12 | 20 | 16,368 | 3.1 | 10 |
| Gateway | | | | | | |
| Gateway to/from | 63,360 | 12 | 20 | 16,368 | 3.1 | 5 |
| Gateway | | | | | | |
| Gateway to/from | 13,200 | 2.5 | 4 | 6,336 | 1.2 | 2 |
| Sprinkler/Valve | | | | | | |
| Controller to/from PDA | 13,200 | 2.5 | 4 | 6,336 | 1.2 | 2 |
| Gateway to/from PDA | 13,200 | 2.5 | 4 | 6,336 | 1.2 | 2 |
| Sprinkler/Valve to/from | 6,336 | 1.2 | 2 | 3,168 | 0.6 | 1 |
| PDA | | | | | | |

Although the invention has been described with reference to certain specific embodiments, various modifications thereof will be apparent to those skilled in the art without departing from the spirit and scope of the invention as outlined in the claims appended hereto.

1. A wireless control system configured for operative association with a first controller for generating and processing information for controlling one or more devices, said wireless control system comprising:
a first transceiver operatively associated with the first controller and configured for operation in two or more modulation modes, wherein each modulation mode is configured to generate and receive radio frequency (RF) signals configured in a predetermined format for wireless transfer of the information; and
one or more second transceivers operatively associated with the first transceiver and configured for operation in the two or more modulation modes, wherein each of the second transceivers is operatively associated with one or more of the devices thereby enabling provision of the information for control of the one or more devices.

2. The wireless control system according to claim 1 further comprising one or more gateway transceivers, each gateway transceiver configured for operation in at least one of the two or more modulation modes and operatively associated with the first transceiver and one or more of the second transceivers or with two or more of the second transceivers for transferring the information therebetween.

3. The wireless control system according to claim 1 further comprising one or more device controllers, each device controller operatively connected with one of the second transceivers to form a control module for control of at least one of the one or more devices.

4. The wireless control system according to claim 3, wherein the control module is integrally formed.

5. The wireless control system according to claim 3, wherein each device controller is configured to shift at least one of the one or more devices into one or more predetermined operating conditions.

6. The wireless control system according to claim 3, wherein each device controller is configured to actuate and de-actuate at least one of the one or more devices.

7. The wireless control system according to claim 3, wherein one or more of the device controllers control one or more of the devices in response to one or more commands received via communications with the first controller.

8. The wireless control system according to claim 3, wherein one or more of the device controllers control one or more of the devices using one or more control programs.

9. The wireless control system according to claim 8, wherein the one or more control programs include firmware.

10. The wireless control system according to claim 8, wherein the one or more control programs include software.

11. The wireless control system according to claim 8, wherein each device controller includes a memory for storing at least one of the one or more programs.

12. The wireless control system according to claim 1 further comprising a fourth transceiver and a second controller, the fourth transceiver operatively connected with the second controller, wherein the second controller is configured to generate and process information for control of the one or more devices, the fourth transceiver configured for operation in the two or more modulation modes and operatively associated with the first transceiver, one or more of the second transceivers, or the first transceiver and one or more of the second transceivers.

13. The wireless control system according to claim 12, wherein the second controller is configured to control the first controller

14. The wireless control system according to claim 12, wherein the second controller is configured as a handheld device.

15. The wireless control system according to claim 1, wherein the first controller is configured as a handheld device.

16. The wireless control system according to claim 1, wherein each of the transceivers is operatively connected with one or more antennas using a predetermined interconnection system.

17. The wireless control system according to claim 16, wherein the predetermined interconnection system is configured as an integrally formed connection.

18. The wireless control system according to claim 16, wherein the predetermined interconnection system is capable of disassembly.

19. The wireless control system according to claim 16, wherein at least one of the antennas comprises a full wave directional antenna.

20. The wireless control system according to claim 16, wherein at least one of the antennas comprises a dual array antenna.

21. The wireless control system according to claim 16, wherein at least one of the antennas comprises a wire strip antenna.

22. The wireless control system according to claim 16, wherein at least one of the antennas comprises a micro strip antenna.

23. The wireless control system according to claim 3 further comprising one or more sensors for providing sensor signals.

24. The wireless control system according to claim 23, wherein the sensor signals include operational conditions of the device controllers.

25. The wireless control system according to claim 23, wherein the sensor signals include parameters relating to conditions external to the system.

26. The wireless control system according to claim 23, wherein one or more of the sensor signals are provided to one or more of the device controllers for control of the one or more devices.

27. The wireless control system according to claim 23, wherein one or more of the sensor signals are provided to the first controller for generating and processing the information.

28. A wireless irrigation control system configured for operative association with a first controller for generating and processing information for activating and deactivating one or more irrigation devices, said wireless irrigation control system comprising:
a first transceiver operatively associated with the first controller and configured for operation in two or more modulation modes, wherein each modulation mode is configured to generate and receive radio frequency (RF) signals configured in a predetermined format for wireless transfer of the information; and
one or more second transceivers operatively associated with the first transceiver and configured for operation in the two or more modulation modes, each of the second transceivers operatively associated with one or more of the irrigation devices thereby enabling provision of the information for activating and deactivating the one or more irrigation devices.

29. The wireless irrigation control system according to claim 28 further comprising one or more gateway transceivers, each gateway transceiver configured for operation in at least one of the two or more modulation modes and operatively associated with the first transceiver and one or more of the second transceivers or with two or more of the second transceivers for transferring the information therebetween.

30. The wireless irrigation control system according to claim 28 further comprising one or more irrigation device controllers, each irrigation device controller operatively connected with one of the second transceivers to form an irrigation control module for control of at least one of the one or more irrigation devices.

31. The wireless irrigation control system according to claim 30, wherein the irrigation control module is integrally formed.

32. The wireless irrigation control system according to claim 30, wherein one or more of the irrigation device controllers control one or more of the irrigation devices in response to one or more commands received via communications with the first controller.

33. The wireless irrigation control system according to claim 30, wherein one or more of the irrigation device controllers control one or more of the irrigation devices using one or more control programs.

34. The wireless irrigation control system according to claim 33, wherein the one or more control programs include firmware.

35. The wireless irrigation control system according to claim 33, wherein the one or more control programs include software.

36. The wireless irrigation control system according to claim 33, wherein each irrigation device controller includes a memory for storing at least one of the one or more programs.

37. The wireless irrigation control system according to claim 33 further comprising a fourth transceiver and a second controller, the fourth transceiver operatively connected with the second controller, wherein the second controller is configured to generate and process information for control of the one or more irrigation devices, the fourth transceiver configured for operation in the two or more modulation modes and operatively associated with the first transceiver, one or more of the second transceivers, or the first transceiver and one or more of the second transceivers.

38. The wireless irrigation control system according to claim 37, wherein the second controller is configured to control the first controller

39. The wireless irrigation control system according to claim 37, wherein the second controller comprises a handheld device.

40. The wireless irrigation control system according to claim 28, wherein the first controller comprises a handheld device.

41. The wireless irrigation control system according to claim 28, wherein each of the transceivers is operatively connected with one or more antennas using a predetermined interconnection system.

42. The wireless irrigation control system according to claim 41, wherein the predetermined interconnection system is configured as an integrally formed connection.

43. The wireless irrigation control system according to claim 41, wherein the predetermined interconnection system is capable of disassembly.

44. The wireless irrigation control system according to claim 41, wherein at least one of the antennas comprises a full wave directional antenna.

45. The wireless irrigation control system according to claim 41, wherein at least one of the antennas comprises a dual array antenna.

46. The wireless irrigation control system according to claim 41, wherein at least one of the antennas comprises a wire strip antenna.

47. The wireless irrigation control system according to claim 41, wherein at least one of the antennas comprises a micro strip antenna.

48. The wireless irrigation control system according to claim 30, further comprising one or more sensors for providing sensor signals.

49. The wireless irrigation control system according to claim 48, wherein the sensor signals include operational conditions of the irrigation device controllers.

50. The wireless irrigation control system according to claim 48, wherein the sensor signals include parameters relating to conditions external to the irrigation system.

51. The wireless irrigation control system according to claim 48, wherein one or more of the sensor signals are provided to one or more of the irrigation device controllers for control of the one or more irrigation devices.

52. The wireless irrigation control system according to claim 48, wherein one or more of the sensor signals are provided to the first controller for generating and processing the information.

53. The wireless irrigation control system according to claim 41, wherein the one or more antennas are adapted for attachment to the irrigation device.

54. The wireless irrigation control system according to claim 41, wherein the one or more antennas are integrally associated with one of the irrigation devices.

55. The wireless irrigation control system according to claim 41, wherein the irrigation devices include a sprinkler valve box.

56. The wireless irrigation control system according to claim 41, wherein the irrigation devices include a sprinkler rotor.

57. A wireless communication apparatus for forwarding information for control of a device to and from a wireless control system, said wireless communication apparatus comprising:
a transceiver configured for operation in two or more modulation modes, wherein each modulation mode is configured to generate and receive radio frequency (RF) signals configured in a predetermined format for wireless transfer of information; and
one or more antennas operatively coupled with the transceiver for emitting and receiving the RF signals.
